(19) United States
(12) Patent Application Publication
(10) Pub. No.: US 2024/0125493 A1
(43) Pub. Date: Apr. 18, 2024

(54) PCM STORAGE UNITS OR PANELS, METHODS OF USING THE SAME, AND AUTOMATED ULTRASONIC SEAM WELDER AND METHOD OF USING THE SAME

(71) Applicant: STASIS ENERGY GROUP, LLC, Minneapolis, MN (US)

(72) Inventors: Robert N. Morton, Pomona, CA (US); Matthew A. Short, Wilmington, OH (US)

(21) Appl. No.: 18/287,107

(22) PCT Filed: Feb. 4, 2022
(86) PCT No.: PCT/US2022/015219

§ 371 Date: Oct. 16, 2023

Related U.S. Application Data
(60) Provisional application No. 63/175,754, filed on Apr. 16, 2021.

(51) Int. Cl. F24F 5/00; B23K 20/10

(52) U.S. Cl. CPC F24F 5/0021; B23K 20/106

(57) ABSTRACT

According to some embodiments, a PCM storage unit comprises a first side and a second side, each side having a perimeter; a perimeter seal joining the first and second sides together at the perimeters of the first and second side, whereby the first and second sides are at least partly spaced apart from each other to define at least one PCM storage area between the first and second sides; and PCM contained in the least one PCM storage area; wherein the first and second sides are made of metal or metal alloy. The PCM storage unit can comprise the first and second sides that are hermetically sealed by the perimeter seal, or can comprises a PCM that is flammable. The PCM contained in the least one PCM storage area can have a Smoke Developed Index greater than 50 when burned.

### CLAIM OF PRIORITY AND CROSS-REFERENCE TO RELATED APPLICATION

The present application claims the benefit of priority to U.S. Provisional Application Ser. No. 63/175,754 filed Apr. 16, 2021, incorporated herein by reference in its entirety.

### FIELD OF THE DISCLOSURE

The present disclosure relates the use of phase change materials in buildings.

### BACKGROUND OF THE DISCLOSURE

Thermal energy storage systems may comprise organic and inorganic phase change materials (PCMs) in different temperature and chemical formulations and different macro-encapsulation packaging systems. PCM energy storage systems may be designed to transfer and store thermal energy as latent heat and to reduce the amount of energy used to heat and cool residential, commercial, industrial, and special purpose-built buildings. Energy savings is made when thermal energy is stored as latent energy and released by the PCM media as the PCM transitions, or changes phase, at pre-determined temperatures, between liquid and solid states, at specific and opportune periods, where the energy required to heat and cool building spaces is reduced by the introduction and utilization of PCM into the HVAC (heating, venting, and air conditioning) system or the building system itself. By storing or releasing latent thermal energy at key times and periods, the HVAC system operations are made more efficient as the PCM, acting as a thermal battery, reduces the amount of electricity or natural gas required to heat and cool than without PCM, as the total heat or cooling load is reduced by the addition of PCM thermal storage.

In a PCM thermal storage system, material phase changes are generally between a solid state and a liquid state. Such storages are usually maintained in the temperature range 0-100° C., thus being suitable for short-term energy storage when connected to heaters and coolers. When a PCM transitions from solid to a liquid state, heat in the environment may be used to melt the PCM, thereby reducing the heat in the environment and storing heat in the liquid PCM. Conversely, when a PCM transitions from liquid to a solid state, heat that had been stored in the liquid PCM is released into the surrounding environment; thus warming the surrounding environment. When a PCM transitions between liquid and solid states, energy is stored or released as latent energy, which storage is much greater than energy stored as sensible energy. Typical PCM media comprise water/ice, salt brines, inorganic salt hydrates, saturated hydrocarbons and fatty acids of high molecular weight. Some PCM storage units have the benefits of having phase transition temperatures that are specifically selected to freeze and melt at desired temperatures, as opposed to water which phase transitions at 0° C. A PCM storage unit may also have the benefit of not having any moving parts.

One drawback of PCM storage units is caused by their poor heat conductivity.

The latent heat of a PCM is fixed, e.g., at X joules/gram, for example. Once the capacity of latent energy for a PCM is reached, whether during freezing or melting, the latent capacity is spent, and any further energy stored is stored as sensible heat. Thus, once the maximum amount of latent heat has been stored, or the material is fully melted, the PCM cannot store any further latent heat and additional heat is sensible. Note—when storing latent heat, the amount of energy increases but the temperature of the PCM does not. Once the limit of latent heat storage (fully melted) is reached, then the temperature of the PCM begins to rise as more energy is applied to the PCM. Accordingly, the inability of a PCM storage unit to store additional heat and the resulting temperature rise of the PCM storage unit may constitute a major problem according to some situations. According to some situations, it may be desirable to fully transition the PCM between solid and liquid states to maximize the energy stored or released. The PCM operation is thus based on cyclic charges and discharges.

One of the advantages of some PCMs are their operation with small temperature differences. If the temperatures within a PCM storage unit and outside the PCM storage unit are the same, phase change does not take place.

PCMs are, by nature, thermal energy storage materials that transition between liquid and solid state that must be packaged or contained in order to be deployed commercially. The industry standard and most common packaging for PCM consists of macro-encapsulated, film-based packaging, where the PCM is inserted into flexible films that are heat sealed to create a self-contained, packaged system, usually referred to as a “mat” or “pouch”. The individual “pouches” vary in size from as little as about 1-inch×1-inch (2.54 cm×2.54 cm) up to about 12-inches×24-inches (30 cm×60 cm) or more and are commonly manufactured as part of a larger structure or “mat”. The films used are flexible by nature, as they are sold by film manufacturers in coils or rolls of up to several thousand feet (or hundreds of meters) in length. The flexible film may be the same or of different composition when comparing the top (one side) versus the bottom (other side) layer of film. The film itself may be single component but more common are multi-component films which are “built” by a film manufacturing company by laminating two or more layers of film together and sold for the express purpose of providing macro-encapsulation of various products. Multi-component films typically have individual layers for strength, tear strength, puncture resistance and vapor transmission, among other features. Each individual component layer of film is bonded to the next by adding a thin layer of adhesive between the film layers. Composition of each individual layer may be from differing materials, such as urethane, polyurethane, HDPE, aluminum, etc. which, when adhered together, form a composite layer of film.

It takes two layers of film to create a macro-encapsulated assembly or package or one layer of film per side of the package. A final, heat sealable layer of film is added to the inside layer of each film, and when making the packages the two faces of heat sealable materials meet each other. A heat seal bar is applied, driving high temperatures, combined with pressure, into the films and melting the heat sealable layers of film, which melt and flow together to create a sealed joint of the package. The machines used for this type of production are called form, fill and seal (FFS) machines in that the machines can perform all steps at the same time, provided the appropriate films are utilized in the manner described above. FFS machines may be vertically oriented or can be horizontally positioned and the bottom layer of film vacuum drawn to create a pod or pouch into which the PCM is placed. Such machines and techniques described above are commonly used for cosmetics, food and beverage products, in addition to PCM packaging.

A typical flexible mat or pouch of PCM manufactured using FFS machine technology may look similar to that shown in FIG. 5. The flexible mat may comprise heat sealable, flexible films melted together to create a pouch, sachet or package of PCM into which the PCM is inserted or injected prior to final pouch or sachet sealing to make individual pods. The flexible mat comprise a heat-sealed perimeter of the package, and may comprise intermediate heat seals that create individual pouches or sachets of PCM. The mat typically comprises a plurality of discrete or individual pouches or sachets so that the mat consists of numerous individual pouches of self-contained PCM as opposed to one uniform container of PCM.

A benefit of using FFS machines and heat sealable films to create macro-encapsulated PCM packages is that the production speed of the machines is reasonably fast and the cost of films reasonably low, so that the packaging costs are minimized. A drawback of the FFS process is that the heat sealable films are by nature very thin and therefore fail during fire events and are therefore unable to pass fire tests required to comply with building code standards. Most film-based products are inherently flammable, due to the combustible material characteristics of the film and/or the adhesives used to laminate multiple layers of film, and fail during fire testing due to perimeter seam failure, where two layers of films are joined, as the heat-sealed seams melt above about 340° F. (170° C.) and the temperatures in a building fire or fire test can easily exceed about 1,000° F. (537° C.). In some cases, it is possible to use fire-resistant films but these films are by nature designed to retard thermal energy transfer, which makes them fire-resistant, but in doing so makes the PCM encapsulate product suffer from even lower heat conductivity, negatively impacting the ability of the PCM to effectively store energy from the surrounding environment. Furthermore, many PCMs are flammable, and once the fire breaches the packaging, the PCM acts as fuel to the fire. For this reason, paraffin or bio-based PCMs combined with FFS, flexible, film packages are not used in construction or building applications where the most stringent fire ratings are required. It is possible to pass the most stringent fire testing with some inorganic PCM formulations using FFS technology but these types of PCMs are generally not considered commercial grade as they have lower latent heat storage capacities and suffer from short life spans. Other drawbacks of the FFS flexible mats are that they are less durable, non-structural, easily punctured and subject to leaking and the heat seals have been shown to fail and seep or leak over time.

Fire Rating of PCM Products

PCMs have been proven effective to store and release thermal energy but have only limited commercial applications in the building or HVAC industries due the fire ratings required by building codes for materials to be used in occupied buildings. The highest performing and most effective PCMs are organic compounds which are innately flammable and do not pass fire testing. Additives to reduce flammability degrade the PCM thermal performance and increase costs. Cost effective or thermally effective packaging systems, designed to contain the flammable PCM during fire testing, have not been capable of withstanding the rigors of the fire testing. Fire resistive or thermally inert packaging systems degrade the ability of the PCM to efficiently store and release thermal energy due to the lower heat transfer rates of the packaged assembly. The inability to gain ASTM E84 Class A rated fire testing results, necessary for compliance with most building and HVAC fire codes, has been a significant obstacle to widespread commercialization of PCM products in the building and HVAC industries.

Commercial buildings, including office buildings and schools, require Class A rated building materials, due to increased potential risk of life loss due to higher occupant concentration. When PCM is placed into an HVAC system plenum (where air is moved from one point to another by the air handling unit (AHU) and then conditioned and redistributed to other areas), U.S. building codes require that certain materials installed in a plenum or air-handling space have a Flame Spread Index (FSI) of 0-25 and a Smoke Developed Index (SDI) of 0-50 (25/50 rating) when tested in accordance with ASTM E84. A plenum can be the space inside the duct work (whether supply air or return air) or commonly, the plenum is an open return plenum, where there are no return ducts—the air returning to the AHU is simply moved through the space, without ducts, back to the AHU. An open plenum can exist in buildings with and without ceilings. This rating is given only to products that can are tested in accordance with the ASTM (American Standard Testing Materials) E84 Standard Test Method for Surface Burning Characteristics of Building Materials test. Equivalent test standards that meet the requirements of ASTM E84 are Underwriters Laboratory (UL) 723 and National Fire Protection Agency (NFPA) 255. Materials tested per ASTM E84 are classified based upon their performance. With Class A rating given to materials that have a Flame Spread Index (FSI) of less than 25 and a Smoke Developed Index (SDI) of less than 450. For products installed in plenum locations, it is necessary to have a Class A rating with less than 25 Flame Spread Index and a less than 50 Smoke Development Index. U.S. building codes require that certain materials installed in a plenum or air-handling space have a Flame Spread Index of 0-25 and a Smoke Developed Index of 0-50 (25/50 rating) when tested in accordance with ASTM E84.

ASTM E84 (often referred to as just “E84”) is the standard test method for assessing the surface burning characteristics of building material. The purpose of this test is to observe the flame spread along a sample of the material in order to determine the relative burning behavior of the material. Through the E84 test, both Flame Spread Index (FSI) and Smoke Developed Index (SDI) are reported for a given sample. FSI is the measurement for the speed at which flames progress across the interior surface of a building, while SDI measures the amount of smoke a sample emits as it burns.

Test results must be certified to have Flame Spread Index (FSI)<25, and Smoke Developed Index (SDI)<50 in order to pass the test and receive a Class A Plenum Rating. Certification is performed by one of several certified and approved ASTM testing labs around the country. Once a building product passes the E84 test, that building product also qualifies for the UL (Underwriters Laboratory) 273 and the NFPA (National fire Protection Association) 255 certifications.

### SUMMARY

According to some embodiments, a PCM storage unit comprises a first side and a second side, each side having a perimeter; a perimeter seal joining the first and second sides together at the perimeters of the first and second side, whereby the first and second sides are at least partly spaced apart from each other to define at least one PCM storage area between the first and second sides; and PCM contained in the least one PCM storage area; wherein the first and second sides are made of metal or metal alloy. According to some embodiments, the PCM storage unit comprises the first and second sides that are hermetically sealed by the perimeter seal. According to some embodiments, the PCM storage unit comprises PCM that is flammable. According to some embodiments, the PCM contained in the least one PCM storage area has a Smoke Developed Index >50 when burned. According to some embodiments, the PCM contained in the least one PCM storage area has a Smoke Developed Index >450 when burned. According to some embodiments, the PCM contained in the least one PCM storage area has a Flame Spread Index >10 when burned. According to some embodiments, the PCM contained in the least one PCM storage area has a Flame Spread Index >25 when burned. According to some embodiments, the PCM storage unit comprises the first and second sides made of aluminum or an aluminum alloy.

According to some embodiments, an ultrasonic welder comprises: an ultrasonic stack; a high-power ultrasonic transducer capable of operating between 100 and 6,000 Watts at frequencies between 10 and 60 kHz; a series of ultrasonic boosters; and a sonotrode.

According to some embodiments, an ultrasonic welder comprises: a series of acoustically isolated boosters coupled to a transducer, wherein the boosters are tuned to the resonant frequency of the transducer as a full wavelength system.

According to some embodiments, an ultrasonic welder comprises: a transducer generating vibrations at a resonant frequency; an acoustically isolated full wavelength booster coupled to the transducer; and a gear coupled to the booster at an end of a first quarter wavelength of the resonant frequency.

According to some embodiments, an ultrasonic welder comprises: a transducer generating vibrations at a resonant frequency; an acoustically isolated full wavelength booster coupled to the transducer; and an ultrasonic welding sonotrode positioned to introduce ultrasonic energy into target materials to be welded, wherein the sonotrode is coupled to a fourth anti-node position of the booster.

According to some embodiments, a sonotrode for use in an ultrasonic welder, the sonotrode comprising: a sonotrode body; and a welding tool having a sonotrode face having a knurl geometry, wherein the welding tool is detachably coupled to the sonotrode body, wherein the sonotrode face is configured to drive vibrations into a plurality of target materials to be welded together when the face is biased under load against a surface of one of the target materials. According to some embodiments, the sonotrode body comprises a sonotrode output end having sonotrode threads thereon; and wherein the welding tool has an inner annular surface defining an aperture in the welding tool, wherein the inner annular surface has tool threads thereon that are complementary to the sonotrode threads; wherein the welding tool and the sonotrode output end are sized to permit the welding tool to be detachably coupled the sonotrode by screwing the welding tool onto the sonotrode output end via the sonotrode threads and the tool threads.

According to some embodiments, an ultrasonic welder comprises a sonotrode comprising: a sonotrode body; and a welding tool having a sonotrode face having a knurl geometry, wherein the welding tool is detachably coupled to the sonotrode body, wherein the sonotrode face is configured to drive vibrations into a plurality of target materials to be welded together when the face is biased under load against a surface of one of the target materials. According to some embodiments, the sonotrode body comprises a sonotrode output end having sonotrode threads thereon; and wherein the welding tool has an inner annular surface defining an aperture in the welding tool, wherein the inner annular surface has tool threads thereon that are complementary to the sonotrode threads; wherein the welding tool and the sonotrode output end are sized to permit the welding tool to be detachably coupled the sonotrode by screwing the welding tool onto the sonotrode output end via the sonotrode threads and the tool threads

According to some embodiments, an ultrasonic welder comprises: a transducer generating vibration at a resonant frequency; a sonotrode coupled to the transducer; and an ultrasonic sonotrode support positioned adjacent the sonotrode; and a low friction bearing material positioned between the sonotrode and the sonotrode, wherein the low friction bearing material is positioned between a node and a second anti-node of the resonant frequency induced in the sonotrode. According to some embodiments, the low friction bearing material comprises a low friction elastomeric pad.

According to some embodiments, an ultrasonic welder comprises: a transducer generating vibration at a resonant frequency; a sonotrode coupled to the transducer; and an anvil positioned adjacent to an output end of the sonotrode, wherein the anvil has a cylindrical shaped and is rotationally mounted within an anvil bearing mount structure.

According to some embodiments, an ultrasonic welder comprises: a transducer generating vibration at a resonant frequency; a sonotrode coupled to the transducer; an anvil positioned adjacent to an output end of the sonotrode, wherein the anvil is coupled to an output end of an anvil bearing mount structure; and a load cell positioned within the anvil bearing mount structure, wherein the load cell is positioned adjacent the output end of the anvil bearing mount structure.

According to some embodiments, an ultrasonic welder comprises: a transducer generating vibration at a resonant frequency; a controller communicatively coupled the transducer; a sonotrode coupled to the transducer; an anvil positioned adjacent to an output end of the sonotrode, wherein the anvil is coupled to an output end of an anvil bearing mount structure; and an end-of-material photo-optic sensor positioned adjacent to the anvil, wherein the sensor generates an output signal that varies depending on whether material to be welded being fed between the sonotrode and the anvil is detected by the sensor or is not detected by the sensor, wherein output signal is communicatively coupled to the controller; wherein the controller automatically generates a signal instructing the transducer to stop operating in response to the output signal indicating that material to be welded is not detected by the end-of-material sensor.

The above summary is not intended to represent every embodiment or every aspect of the present disclosure. Rather, the foregoing summary merely provides an exemplification of some of the novel aspects and features set forth herein. The above features and advantages, and other features and advantages of the present disclosure, which are considered to be inventive singly or in any combination, will be readily apparent from the following detailed description of representative embodiments and modes for carrying out various embodiments of the present disclosure when taken in connection with the accompanying drawings and the appended claims.

### BRIEF DESCRIPTION OF THE DRAWINGS

FIG. 1 is a perspective view of a PCM storage unit according to some embodiments of the present disclosure.

FIG. 2 is a partial cross-sectional view of a PCM storage unit according to some embodiments of the present disclosure.

FIG. 3 is a plan view of a PCM storage unit according to some alternative embodiments of the present disclosure.

FIG. 4 is a plan view of a PCM storage unit according to some alternative embodiments of the present disclosure.

FIG. 5 is a perspective view of a PCM storage unit according to some alternative embodiments of the present disclosure.

FIG. 6A is a perspective view of a plurality of PCM storage units installed in a plenum according to some alternative embodiments of the present disclosure.

FIG. 6B is a partial cross-sectional view of a plurality of PCM storage units installed in a plenum according to some embodiments of the present disclosure.

FIG. 7 is a partial cross-sectional view of a PCM storage unit illustrating a tack-off point according to some embodiments.

FIG. 8 is a partial cross-sectional view of a PCM storage unit illustrating a fill port according to some embodiments of the present disclosure.

FIG. 9A is a partial cross-sectional view of a PCM storage unit illustrating an alternative version of a tack-off point according to some embodiments and FIG. 9B is a partial cross-sectional view of a PCM storage unit illustrating an alternative version of a tack-off point according to some embodiments.

FIG. 9C is a partial cross-sectional view of a PCM storage cell illustrating a fill port according to some alternate embodiments of the present disclosure.

FIGS. 10A-10L are partial cross-sectional views of PCM storage units according to various embodiments of the present disclosure.

FIG. 11A is side view of a plurality of PCM storage units installed in a horizontal manner in a plenum according to some embodiments of the present disclosure.

FIG. 11B is side view of a plurality of PCM storage units installed in a vertical manner in a plenum according to some embodiments of the present disclosure.

FIG. 11C is side view and FIG. 11D is a perspective view of a plurality of PCM storage units installed in a horizontal manner in a PCM plate box according to some embodiments of the present disclosure.

FIGS. 12A and 12B are a flowchart of illustrating a method of controlling an HVAC system utilizing PCM storage units or plates thermal storage integrated into the HVAC system according to some embodiments.

FIG. 12C is a graph illustrating how fluctuating PCM temperatures are monitored and normalized to assess the amount of thermal storage capacity available within the system so that the HVAC controller can manage compressor operations in an optimal and efficient manner according to some embodiments.

FIG. 13A is a perspective view and FIG. 13B is a cross-sectional view of a duct having one or more PCM storage units or plates mounted adjacent to one or more of the walls or sides of the duct.

FIG. 13C is a perspective view and FIG. 13D is a cross-sectional view of a duct having a round cross-section and having one or more PCM storage units or plates mounted therein.

FIG. 13E is side view and FIG. 13F is a perspective view of a plurality of PCM storage units installed in a vertical manner in a PCM plate box according to some embodiments of the present disclosure.

FIG. 13G illustrates some exemplary locations at which PCM plate boxes may be positioned in supply side ductwork of an HVAC or venting system having an air handling unit according to some embodiments.

FIG. 13H illustrates an exemplary location at which a PCM plate box may be positioned in a return side ductwork of an HVAC or venting system having an air handling unit according to some embodiments.

FIGS. 13I-13K illustrates other exemplary locations at which PCM plate boxes may be positioned in a supply side ductwork of an HVAC or venting system having an air handling unit according to some embodiments.

FIGS. 13L-13N illustrate the use of transition boxes to accommodate PCM plate boxes having a different size and/or shape than a duct system to which the PCM plate boxes are coupled.

FIG. 13O is a plan view and FIG. 13P is a side, sectional view of a PCM storage unit or plate having a plurality of thermocouples located within the PCM storage area and in contact with PCM media located within the PCM storage area.

FIG. 14A is a first end perspective view and FIG. 14B is a second end perspective view of an ultrasonic welder according to some embodiments. FIG. 14C is a side view, FIG. 14D is a side cross-sectional view, FIG. 14E is a first or front end view, and FIG. 14F is a cross-sectional first end view of the ultrasonic welder of FIG. 14A.

FIG. 15A is a cross-sectional view and FIG. 15B is a first end view of a sonotrode area of an ultrasonic welder according to some embodiments.

FIG. 16 is a reproduction of FIG. 3 of U.S. Pat. No. 8,082,966 B2 to Short and is a cross-sectional side view of an exemplary embodiment of an ultrasonic welding assembly.

FIG. 17A is a perspective view and FIG. 17B is a longitudinal cross-section view of a booster comprising a single half-wave vibration isolation booster according to some embodiments of the present disclosure.

FIG. 17C is a perspective view and FIG. 17D is a longitudinal cross-section view of a booster comprising two half-wave vibration isolation boosters according to some embodiments of the present disclosure.

FIG. 18 is a schematic drawing illustrating a welding system comprising a welder communicatively coupled to a controller and electrically coupled to an electronic ultrasonic generator or power supply according to some embodiments of the present disclosure.

FIG. 19A is a perspective view, FIGS. 19B and 19D are side views, FIG. 19C is a cross-sectional view taken along line 19C-19C in FIG. 19D, and FIG. 19E is an output or front end view of a sonotrode according to some embodiments of the present disclosure.

FIG. 20 is an enlarged view of a lower, output end of a welder according to some embodiments of the present disclosure.

FIG. 21 is a reproduction of FIG. 2 of U.S. Pat. No. 3,955,740 to Shoh which is a partial section view of a seam welding apparatus.

FIGS. 22-24 are reproductions of FIGS. 4-6 of U.S. Pat. No. 3,813,006 to Holze. More specifically FIG. 22 is a side view of a frontal portion of a resonator and welding tip; FIG. 23 is an exploded view disclosing the welding tip and its attachment to the resonator; and FIG. 24 is a plan or end view of the welding tip along line 24-24 in FIG. 23.

The present disclosure is susceptible to various modifications and alternative forms, and some representative embodiments have been shown by way of example in the drawings and will be described in detail herein. It should be understood, however, that the inventive aspects are not limited to the particular forms illustrated in the drawings. Rather, the disclosure is to cover all modifications, equivalents, combinations, and alternatives falling within the spirit and scope of the inventions as defined by the appended claims.

### DETAILED DESCRIPTION OF THE ILLUSTRATED EMBODIMENTS

The terminology “about” is meant to designate a possible variation of up to +10%. Terms of orientation such as upper, lower, top, bottom, left, or right are included in this disclosure to aid understanding of the disclosure such as in reference to one or more of the drawings but at are not limitations as it is understood that the orientation of objects and surfaces described herein may be altered and hence the relative orientation terms may likewise be altered.

According to some embodiments, PCM storage units are given a plate-like shape.

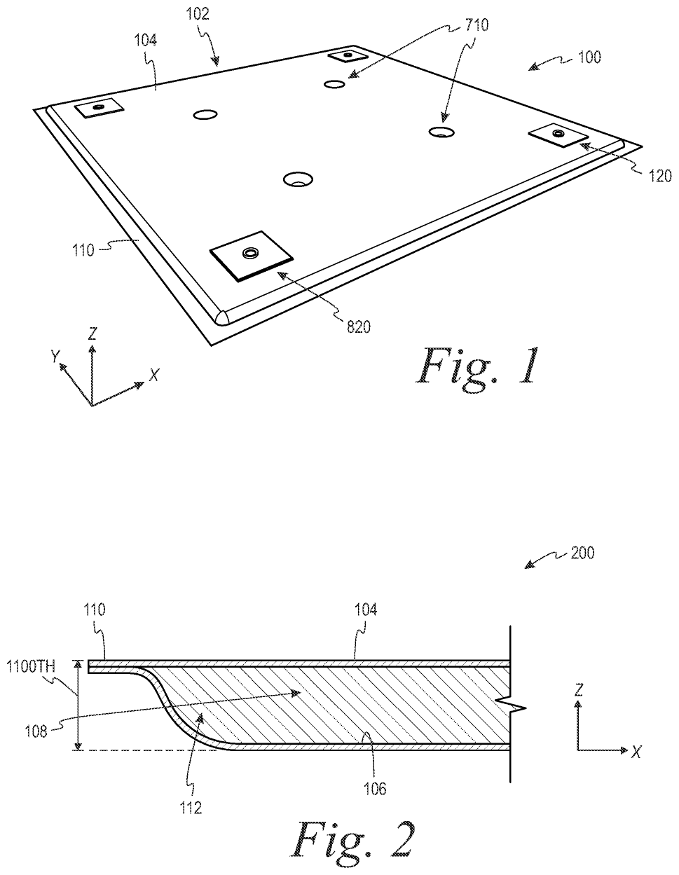

FIG. 1 is a perspective view of a PCM storage unit or plate or panel 100 according to some embodiments of the present disclosure. FIG. 2 is a partial cross-sectional view of a PCM storage unit 200 according to some embodiments of the present disclosure. The PCM storage unit 100 illustrated in FIG. 1 comprises a single PCM storage cell 102. According to some embodiments, the PCM storage units 100, 200 comprise a first side 104 and a second side 106 defining a PCM storage area 108 there between that serves as an area in which PCM 112 is contained. The first 104 and second 106 sides are sealed together at a storage unit edge or perimeter seam 110. The shapes of the first 104 and second 106 sides can vary. For example, as shown in FIG. 2, the first side 104 may be relatively flat and the second side 106 may be relatively flat over most of the side but curved or bent (above as illustrated in FIG. 2) toward the first side 104 near the seams 110. According to some embodiments, both the first 104 and second 106 sides may have a shape the same as or similar to that shown for the second side 106 shown in FIG. 2. According to some embodiments, the first side 104 and/or the second side 108 are each formed of a metal or metal alloy plate. The PCM storage unit or plate or panel 100 has a thickness 1100TH (in the z-direction as shown in FIGS. 1-2). The PCM storage unit or plate or panel 100 has a longitudinal direction (in the x-direction as shown in FIGS. 1-2) along which a length of the plate 100 may be defined and a transverse direction (in the y-direction as shown in FIGS. 1-2) along which a width of the plate 100 may be defined.

According to some embodiments, the first 104 and second 106 sides are made of sheets of metal or metal alloys. According to some embodiments, the first 104 and second 106 sides are hermetically sealed at the storage edge seams 110 thereby encapsulating the PCM 112 and inhibiting or preventing the PCM contained in the PCM storage area(s) 108 from leaking or escaping out.

According to some embodiments, a PCM storage unit comprises one or more PCM storage cells 102 wherein the one or more storage cells 102 are hermetically sealed within a metal enclosure.

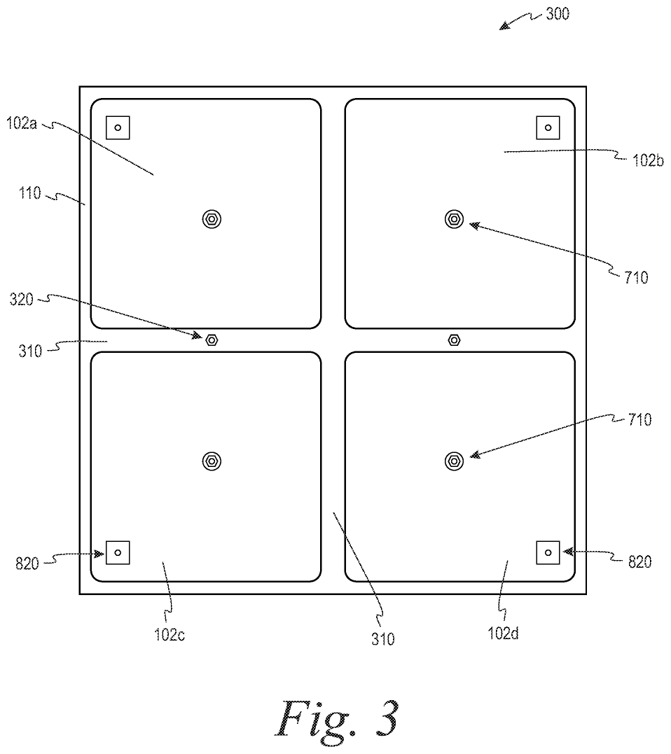

FIG. 3 is a plan view of a PCM storage unit 300 according to some alternative embodiments of the present disclosure comprising four PCM storage cells 102a, 102b, 102c, 102d. According to some such embodiments, the four PCM storage cells 102 are arranged in a 2×2 matrix.

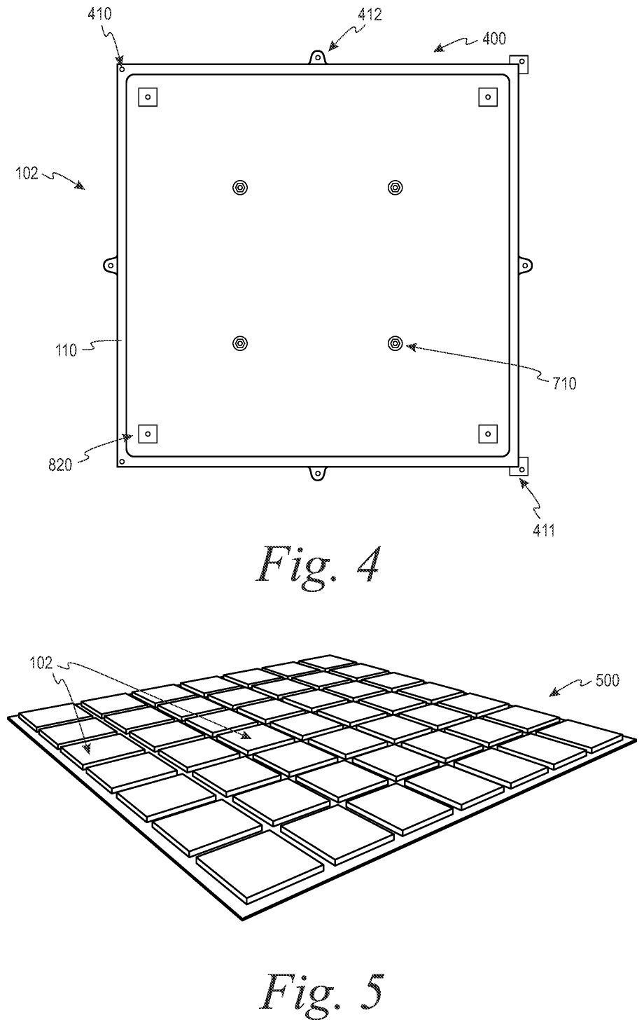

FIG. 4 is a plan view of a PCM storage unit 400 according to some alternative embodiments of the present disclosure comprising a single PCM storage cell 102.

FIG. 5 is a perspective view of a PCM storage unit according to some alternative embodiments of the present disclosure comprising forty-nine (49) PCM storage cells 102. According to some such embodiments, the four PCM storage cells 102 are arranged in a 7×7 matrix.

Note, the number of PCM storage cells 102 and their arrangement can vary according to various embodiments. For example, a plurality of cells 102 made by arranged to form a square or rectangular shaped storage unit.

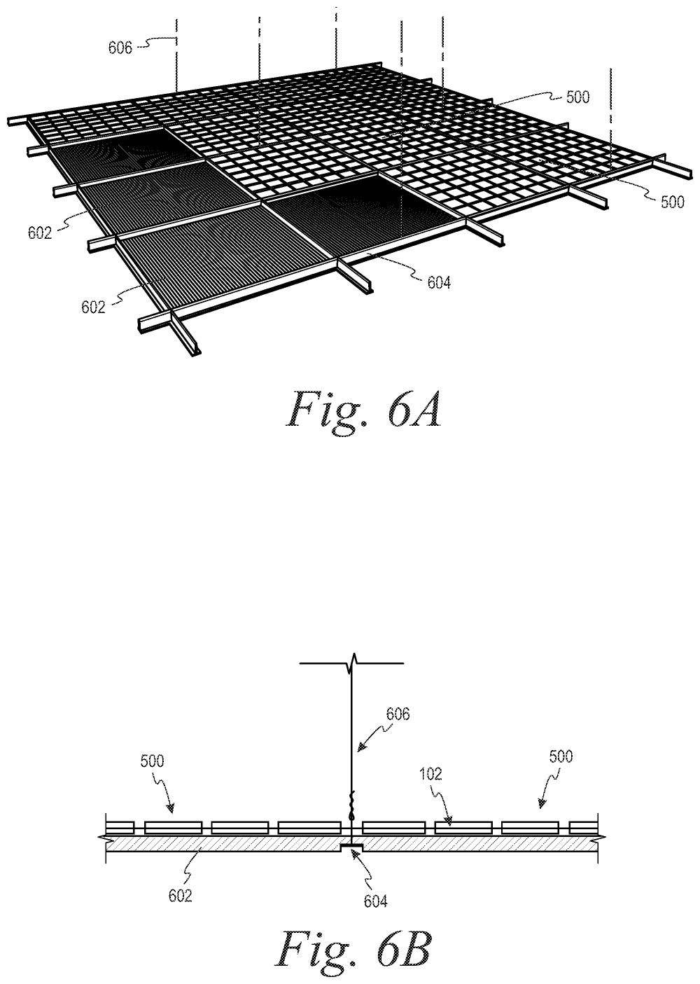

According to some embodiments, PCM storage units described herein such as units 100, 200, 300, 400, 500, 1000, 1100 are installed in the heating, ventilation and air conditioning (HVAC) system of a building. According to some such embodiments, the PCM storage units are installed into the HVAC systems return air plenum, where air, which has been circulated though the occupied space, is returned through the plenum to an air handling unit (AHU) for mechanical cooling or heating. In open return (no return ducting) air plenums above ceiling tiles, according to some embodiments, the PCM storage units are placed directly on top of the ceiling tiles, so that the bottom side of the PCM storage units are in contact with a top of the ceiling tile 602 (see FIGS. 6A. 6B) and a top of the PCM storage units are exposed to air flow in the plenum.

According to some such embodiments, relatively warm air, returning from the office or building space on its way to the air handler and condenser, passes over frozen or solid PCM residing in PCM storage units placed into the plenum. As a result, cooling energy savings and load shifting can be realized when heat, or thermal energy, from the returning air is stored in the PCM storage unit. Conversely, according to some such embodiments, relatively cool air, returning from the office or building space on its way to the air handler and condenser, passes over thawed or liquid PCM residing in PCM storage units placed into the plenum. As a result, heating savings can be realized when the liquefied or melted PCM is used to warm the returning air. According to some embodiments, one layer of PCM storage units are installed on top of ceiling tiles and may be evenly distributed over the tiles of a ceiling to maximize the amount of PCM mass installed in the plenum.

FIG. 6A is a perspective view of a plurality of PCM storage units 500 installed in a plenum according to some alternative embodiments of the present disclosure. FIG. 6B is a partial cross-sectional view of a plurality of PCM storage units 500 installed in a plenum according to some embodiments of the present disclosure.

As shown in FIG. 6A, according to some embodiments, a plurality of PCM storage units 500 are placed above ceiling tiles 602, and the PCM storage units 500 are in direct physical contact with tops of the ceiling tiles 602 and the top of the PCM storage units 500 are exposed to air flow within the plenum. A ceiling tile support system 604 such as a T-Bar grid is coupled via support wires 606 to a building support such as, for example, a bottom of a floor above the plenum or other building structure. The ceiling tile support system 604 supports the individual ceiling tiles 602 and the PCM storage units 500 resting thereon.

According to some embodiments, a goal of such an arrangement as illustrated in FIGS. 6A and 6B is to use the PCM to capture excess thermal energy from the moving return air. However, since the PCM storage units 500 are in direct contact with the ceiling tiles 602 optimal heat transfer to the PCM residing within the PCM storage units 500 is impeded by the insulative properties of the ceiling tiles 602, where conductive heat transfer occurs between the ceiling tile 602 and the PCM storage units 500, while the top of the PCM package is subject to convective heat transfer only.

While PCM storage units 500 are illustrated in FIGS. 6A and 6B, according to other embodiments, other PCM storage units described herein may be employed instead of or in addition to PCM storage units 500 such as PCM storage units 100, 200, 300, 400 and/or 1000. Ceiling tiles typically range from about 12-48 inches (30-122 cm) wide and about 12 to 48 (30-122 cm) long. PCM Panels range in width from about 1 inch (2.54 cm) to about 60 inches (152 cm) and lengths from about 1 inches (2.54 cm) or greater. According to some embodiments, the length of continuous perimeter seals is limited only by the limits of material handling and ability of fabricated assembly to be handled without folding or failing during manufacture, handling, installation or life of product. The PCM storage units or plates or panels described herein will be referred to as PCM storage units or plates or panels 1100 and can be any of the PCM storage units described herein such as, for example, PCM storage units 100, 200, 300, 400, 500 and/or 1000.

According to some embodiments, the PCM storage units or plates 1100 are metal-clad macro-encapsulated packaging that is manufactured using different machine processes than heat seals produced by FFS machines and may be formed as a rigid plate PCM panel. According to some embodiments, such a plate PCM panel 1100 is a macro-encapsulated metal case or package filled with PCM 112 that demonstrates improved thermal efficiency and heat transfer rates of the PCM alone and is a fire resistive, leak-proof package that can withstand the heat and open flames encountered during fire testing and pass with the highest possible rating required for commercial building and HVAC uses such as E84 testing and receive a Class A Plenum Rating.

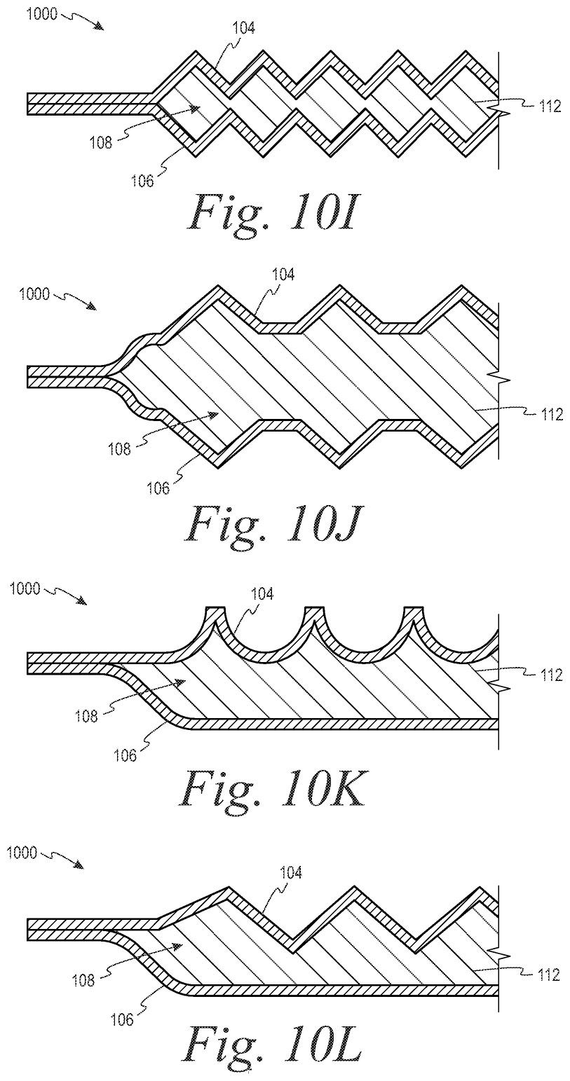

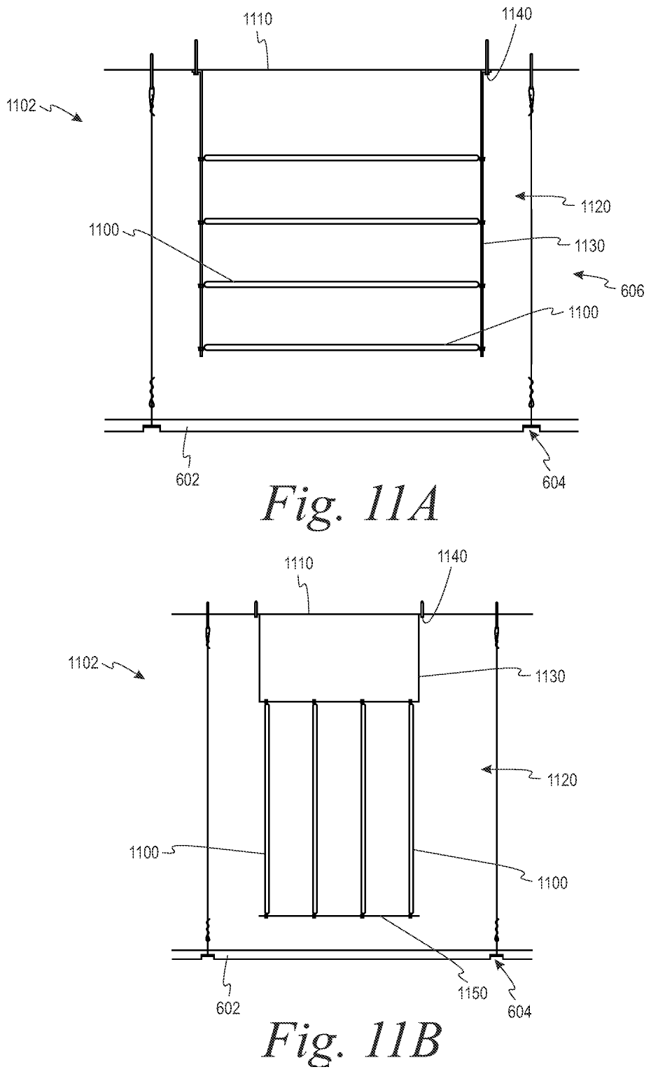

According to some embodiments, the PCM storage units or plates or panels 1100 are sized to fit an intended application and installation with a range of about 1 inch (2.54 cm) to about 60 inches (152 cm) width and about 1 inch (2.54 cm) to about 60 inches (152 cm) long. According to some embodiments, there is no functional limitation of the width or length of the package except for handling concerns as the manufacturing process can yield continuous infinite seams (or at least continuous seams up to hundreds of feet or meters). According to some embodiments, the height or thickness of the completed PCM storage units or plates 1100 may vary in depth from about 0.10 inches (0.2 cm) to about 6.0 inches (15 cm). The outer dimensions of the PCM storage units or plates 1100 may vary depending upon desired amount of PCM the PCM storage units or plates 1100 are designed to hold. According to some embodiments, the thickness of the metal pieces or sides 104, 106 to be joined to create the PCM storage units or plates 1100 can be any combination of thickness ranging from about 0.010 to about 0.250 inch (about 0.02 cm to about 0.6 cm). According to some embodiments, the composition of the metal for sides 104, 106 may include pure aluminum, 3000, 4000, 5000, 6000 and 7000 series aluminum alloy compounds, steel, copper, silver, platinum, gold and other high thermally conductive metals and alloys. According to some embodiments, due to the structural nature of the PCM storage units or plates 1100, an assembly of one or more PCM storage units or plates 1100 can be utilized that contains more PCM per square foot (or meter) than traditional flexible mat systems and therefore have a higher payload of PCM product per unit of measure. Additionally, according to some embodiments, stiffening ribs and surface texturing may be added to increase the rigidity and stiffness of each PCM storage unit or plate 1100 and to improve torsional stability over flat sheet metal cases. See, e.g., FIGS. 10A-10L.

According to some embodiments, a PCM storage unit or plate 1100 is a rigid metal plate panel, possessing efficient thermal energy transfer rates, hermetically sealed and specifically designed for fire resistance and containment of internal PCM pressures created during fire events, including fire testing such as E84 testing. According to some embodiments, the overall construction and design of a PCM storage unit or plate 1100 may be governed by the ability of the PCM storage unit or plate 1100 to withstand the pressures created during fire testing such as E84 testing without breach or failure. According to some embodiments, the design and manufacture of the PCM storage units or plates 1100 may factor in the use of materials that are compatible with PCM chemistry and therefore not-reactive or corrosive, and may be constructed using techniques and features to ensure performance for more than 20 years in-place. For example, according to some embodiments, an anti-corrosion barrier is applied to the inside face of one or both of the sides 104, 106 made of metal or alloy materials so as to resist the effects of long-term corrosion and degradation. Metals or metal alloys containing gold, silver, aluminum and copper are generally non-reactive to PCM chemistry and are employed in the PCM storage units or plates 1100 such as by making one or both of the sides 104, 106 from such materials according to some embodiments.

According to some embodiments, the sides 104, 106 are metal or metal alloys plates manufactured by creating a top (first) and a bottom (second) sheet, which are seamed around the perimeter of the PCM storage unit or plate 1100 to prevent the PCM 112 in the PCM storage area 108 from leaking out of the PCM storage unit or plate 1100. The top and bottom sheets may have the same shape or may have different shapes. According to some embodiments, the perimeter seam 110 may be at or near the top of the PCM storage unit or plate 1100 such as shown in FIG. 2, at some vertical mid-point of the PCM storage unit or plate 1100 as viewed in FIG. 2 or may be at or near the bottom of the PCM storage unit or plate 1100 as viewed in FIG. 2, depending upon design, application and engineering. According to some embodiments, the sides 104, 106 such as top and bottom plates are fabricated using laser cutting or shear cutting of larger metal sheets to form one or more than one of the sides 104, 106. The sides 104, 106 may then be formed by stamping using a custom manufacturing die applied to one or more sheets of metal. According to some embodiments, each side 104, 106 is made from a sheet of metal stamped using different dies. When joining the individual sides 104, 106, a seal 110 is formed that is hermetic and capable of withstanding significant internal pressures during a fire event or fire testing such as E84 testing, caused by expanding liquid-state PCM and air contained within the PCM storage area 108, without breaching or failing.

In some cases, the inside surfaces of the sides 104, 106 made of metal sheets may be coated with a sacrificial layer of aluminum alloy in whole or in part, which is designed to melt during joining of the individual metal pieces such as at the perimeter seam 110 and create the tie layer between the two opposing metal sheets of sides 104, 106. Either both or only one face of the metal sheets of the sides 104, 106 may be coated with such an aluminum alloy, sometimes referred to as a braze alloy.

In some cases, the interior surfaces of the metal sheets of sides 104, 106 will have a layer of material designed to be more compatible and/or corrosion resistive with the unique formulation of PCM being contained in the PCM storage area 108. According to some embodiments, such a material is applied to the inside faces of the metal sheets that will be used for sides 104, 106 before assembling the two sides together to form a PCM storage unit or plate 100, 1100. According to some embodiments, such a pre-assembly application of a more compatible and/or corrosion resistive material(s) to the inside faces of the metal sheets that will be used for sides 104, 106 before assembling the two sides together is employed when the PCM 112 to be contained within the PCM storage area 108 is an inorganic or salt-based PCM product.

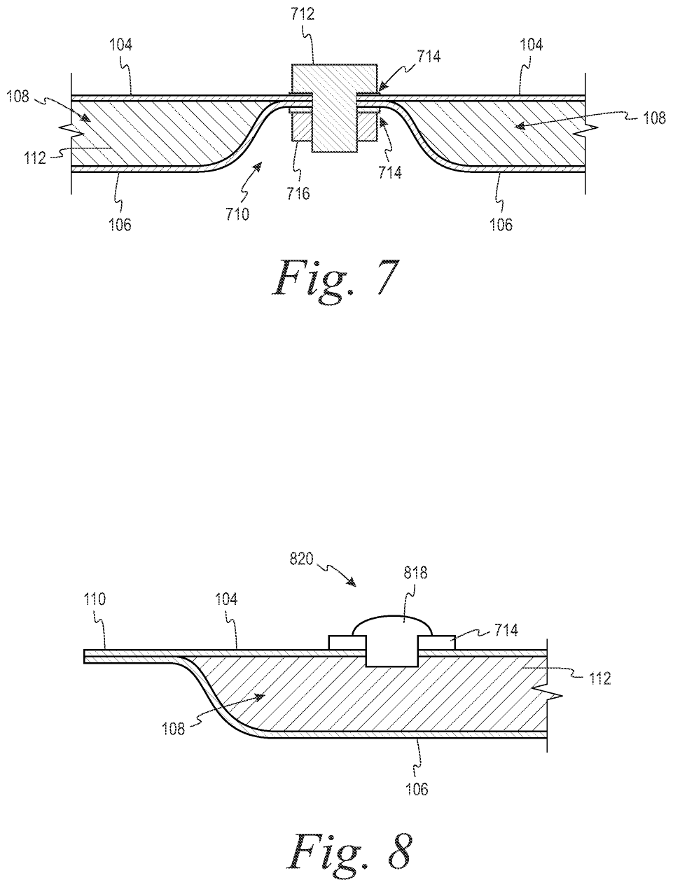

FIG. 7 is a partial cross-sectional view of PCM storage unit 100, 1100 illustrating a tack-off point 710 according to some embodiments. Tack-offs are designed to provide greater structural integrity and stiffness to an assembly and reduce sagging and bowing of assembled plates. Tack-offs can be manufactured by creating impressions to one or both plate faces. Tack-offs can be created by adding spacers or mounts inside the assembly designed to affix one face of the assembly to the other in a rigid connection. Exemplary locations of tack-off points 710 are also illustrated in FIGS. 1, 3, and 4. Turning to FIG. 7, according to some embodiments, a tack-off point 710 may have a thru-bolt 712 passing through opposing apertures in sides 104, 106 and may be employed to maintain the sides of the sides 104, 106 which may be metal or metal alloy plates in fixed relation to each other especially when the PCM storage unit 100, 1100 is under stress such as when the PCM storage unit 100, 1100 is exposed to heat such as in a fire or fire test and pressure builds within the PCM storage area 108 urging the two sides 104, 106 apart from each other. According to some embodiments, one or more washers 714 that may be employed to inhibit or prevent PCM 112 within the PCM storage area 108 seeping or leaking out of the PCM storage unit 100, 1100 via the apertures in the sides 104, 106 in the vicinity of the tack-off points 710. According to some embodiments, washers 714 are positioned on the opposing sides 104, 106 around the apertures therein with the thru-bolt 712 positioned within central apertures of the washers 714. According to some embodiments, the thru-bolt 712 has a threaded end and is held in place via a threaded nut 716. In some cases, self-sealing rivets or hammer rivets may be used in lieu of thru-bolts to affix opposing sides of the plates. In some cases, resistance spot welding or other welding methods may be employed to affix opposing faces of panels to each other. In some cases, ultrasonic weldments can be used.

FIG. 8 is a partial cross-sectional view of a PCM storage unit 100, 1100 illustrating a fill port 820 according to some embodiments of the present disclosure. Exemplary locations of fill ports points 820 are also illustrated in FIGS. 1, 3, and 4. According to some embodiments, a fill port 820 is an aperture in one of the sides 104, 106 through which PCM 112 may be deposited into the PCM storage area 108 after the sides 104, 106 have been assembled into a PCM storage unit 100, 1100. According to some embodiments, the fill port 820 is sealed using a fill port plug bolt 818 and a washer 714 positioned under the fill port plug bolt 818.

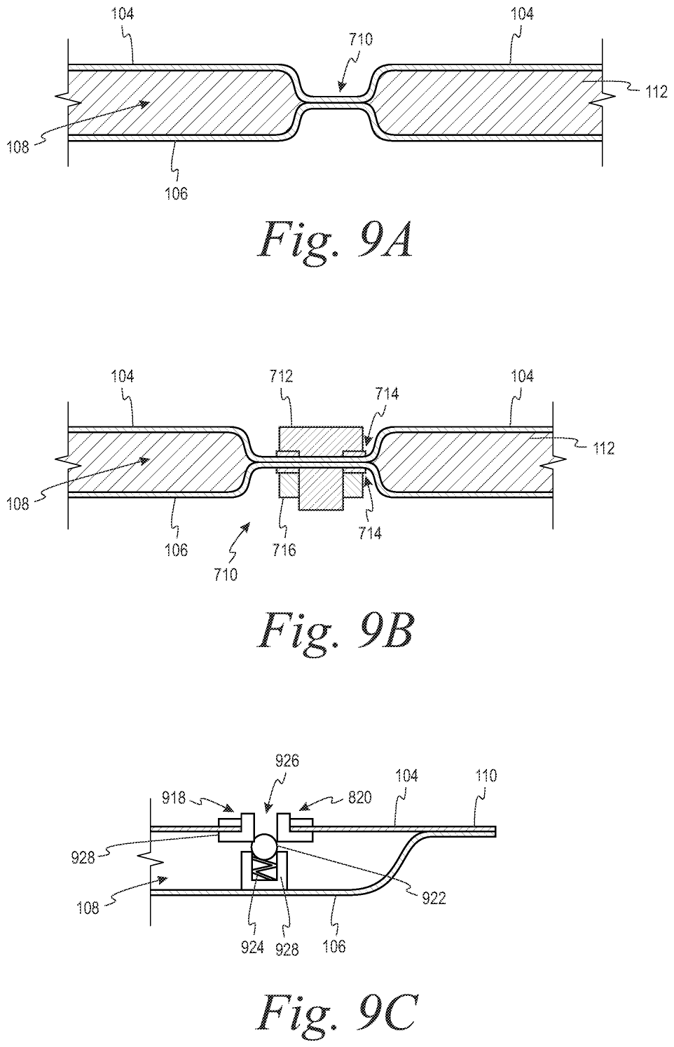

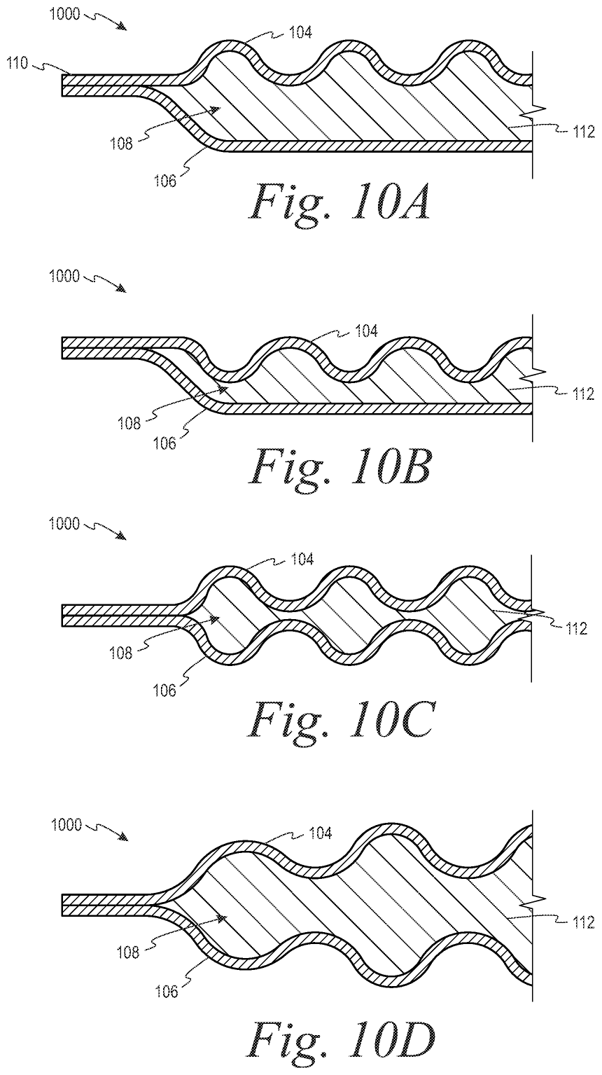

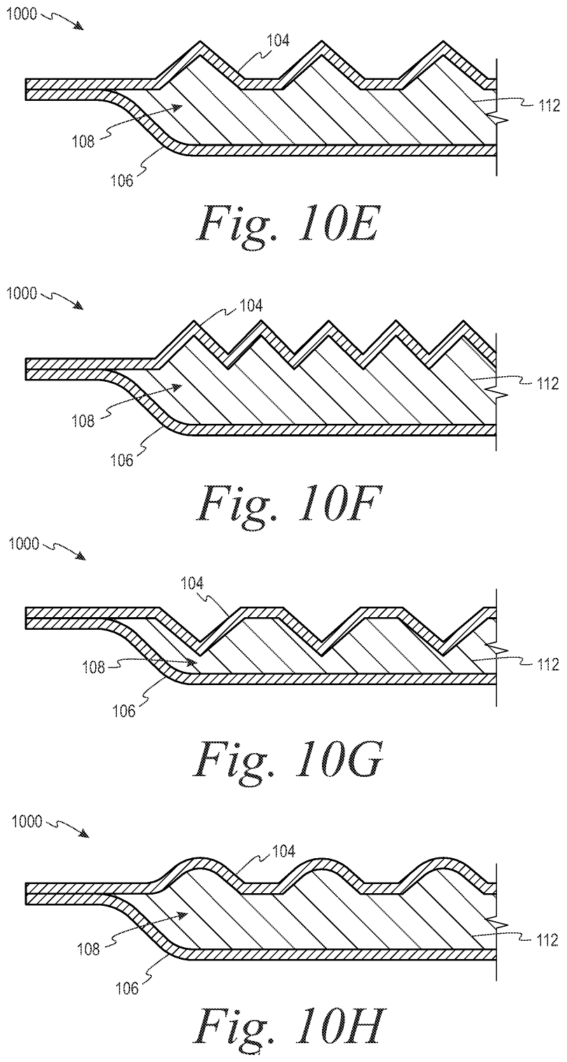

FIG. 9A is a partial cross-sectional view of PCM storage unit 100, 1100 illustrating an alternative version of a tack-off point 710 according to some embodiments and FIG. 9B is a partial cross-sectional view of PCM storage unit 100, 1100 illustrating an alternative version of a tack-off point 710 according to some embodiments. In FIG. 9B, thru-bolt 712, washers 714, and nut 716 are the same as previously described with reference to FIG. 7, however the tack-off point 710 is manufactured symmetrically as opposed to the asymmetrical tack-off previously illustrated in FIG. 7. That is, in FIGS. 9A and 9B, the sides 104, 106 are curved toward each other in a symmetrical manner. In FIG. 9A, thru-bolt 712, washers 714, and nut 716 have been omitted for clarity. According to some embodiments, a rivet may be employed in place of thru-bolts 712 and nuts 716 discussed above in connection with FIGS. 7 and 9B.

FIG. 9C is a partial cross-sectional view of a PCM storage unit 100, 1100 illustrating a fill port 820 according to some alternate embodiments of the present disclosure.

In the FIG. 9C, a fill port 820 and alternate fill port plug 918 are shown. As shown in FIG. 9C, fill port plug 918 is an integrated fill port plug assembly which is installed at least partially within the PCM storage area 108. In some cases, this integrated fill port assembly can be mounted out-board of PCM storage area 108. According to some embodiments, the fill port plug 918 comprises a plug 922 such as a ball or bearing biased by a biasing member 924 such as a spring toward one of the first 104 or second sides 106 so as to block or seal a fill aperture 926 in one of the sides 104, 106. According to some embodiments, the fill port plug 918 comprises a housing 928 for the maintaining the relative positions of the bearing 922, biasing member 924 and the aperture 926.

FIGS. 9A-9C illustrate alternative embodiments to those illustrated in FIGS. 7-8; however, the embodiments of FIGS. 9A-9C serve the same purposes as those described in conjunction with FIGS. 7-8 although specific materials or methods may vary slightly.

In FIG. 1, depressions or deformations in side 104 are illustrated in the area of tack-off points 710. According to some embodiments, one or more of sides 104, 106 have surface features which may serve as backup support material, if required, to mount or install fill ports 820. According to some embodiments, the fill ports 820 may be used to fill the PCM storage unit 100, 1100 with PCM 112 and/or to exhaust air from within PCM storage unit 100, 1100 during the PCM filling operation.

As discussed above, according to some embodiments, elements in addition to the upper and lower (first and second) sheets of metal or metal alloy forming sides 104, 106 may be joined to the assembled sides 104, 106. For example, such additional elements may include, for example, fill ports 820, air exhaust ports, fill tubes, and/or pressure relief valves. Such additional elements may be, for example, welded, glued, or chemically bonded to the sides 104, 106 such as metal or metal alloy sides, and can be found on the top, bottom and/or sides of the sides 104, 106.

Fill ports 820 and exhaust ports may be formed-drilled into the faces of the metal panels serving as sides 104, 106, may be chemically bonded to one or more of the metal or metal alloy sides 104, 106, may be welded using various welding techniques, may be mechanically attached using welded nuts and/or washers with the metal or metal alloy sides 104, 106 sandwiched between nuts and/or washers, and/or may be made during stamping of the individual metal or metal alloy sides 104, 106. In some cases, a fill mechanism is mounted flat to a metal or metal alloy side 104, 106, mounted at an angle, and/or mounted on top of a feature either attached or stamped into a metal or metal alloy side 104, 106 for the purpose of raising the fill mechanism to allow for faster filling of the panel. In some cases, fill ports 820 may be integrated assemblies, installed on top of or between the sides 104, 106, which consist of a float ball to allow only one-way movement of the PCM 112 into the PCM storage area 108 as a PCM storage unit 100, 1100 is being filled with PCM 112 but to not allow egress or exhaust of PCM 112 from the PCM storage area 108, once filled. Fill ports 820 and exhaust ports may be threaded or un-threaded, with threads on the inside or the outside of fill appurtenances, both with and without a cap to prevent leaking. In some cases, one or more of the metal or metal alloy sheets forming sides 104, 106 may include a feature which creates an additional gap between the bottom of a fill port 820 and the opposing side 104, 106 either above or below as viewed in FIG. 1, 8, or 9C to allow and promote faster filling of the panel such as stand-off tabs or supports to ensure a void between a bottom of a fill port and the inside face of an opposing panel or side, to allow for free flow of PCM during filling of panels.

In some cases, a PCM storage unit 100, 1100 does not have a fill port 820 and the metal or metal alloy sides 104, 106 encapsulate pre-formed pouches of PCM which are inserted into the metal or metal alloy sides 104, 106 before perimeter sealing of the container. For example, one or more pouches of PCM created using a form, fill and seal (FFS) machine and/or method described above may be encapsulated by sides 104, 106 of a PCM storage unit 100, 1100.

### Method of PCM Plate Manufacturing: Perimeter Sealing of Plates

According to some embodiments, methods of joining or seaming the two metal or metal alloy sides 104, 106 and attaching fill and exhaust ports not integral to the stamped parts, may include ultrasonic, direct and indirect resistance welding with and without braze sacrificial aluminum alloy to join metal parts. According to some embodiments, laser welding, vacuum brazing, diffusion bonding, electron beam welding, braze, seam and resistance welding can be used to join metal or metal alloy sides 104, 106. According to some embodiments, mechanical sealing methods can be used, including pressing and stamping, bending and seaming both with and without sealant layers or gaskets pressed within the folds of selected metal. In some cases, mechanical and chemical seals may be combined or used separately to glue, liquid weld or seal upper and lower parts together to make a leak proof seal around the perimeter of the package.

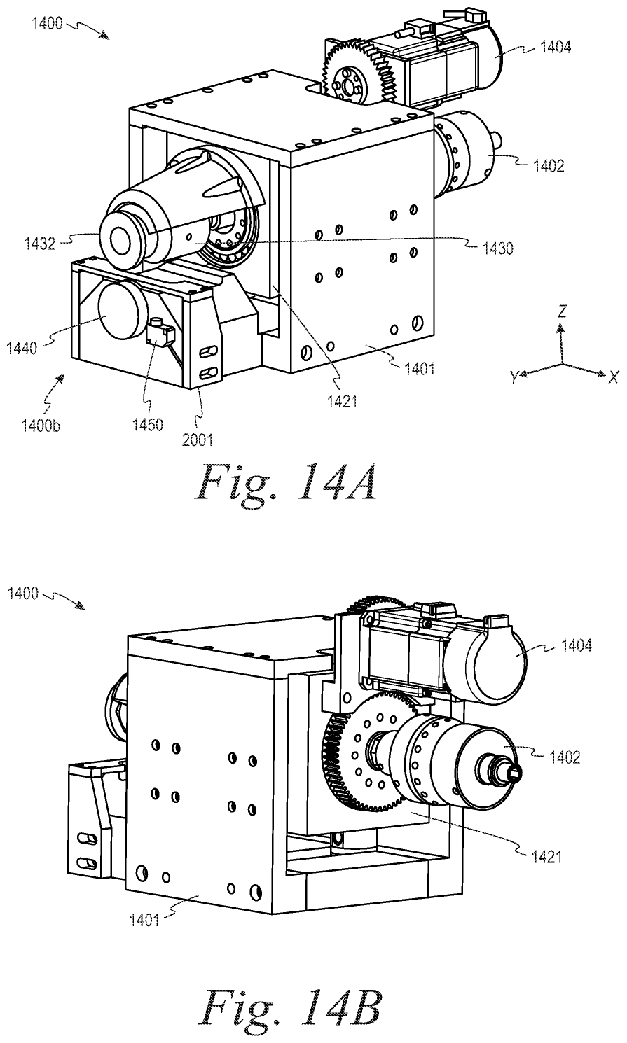

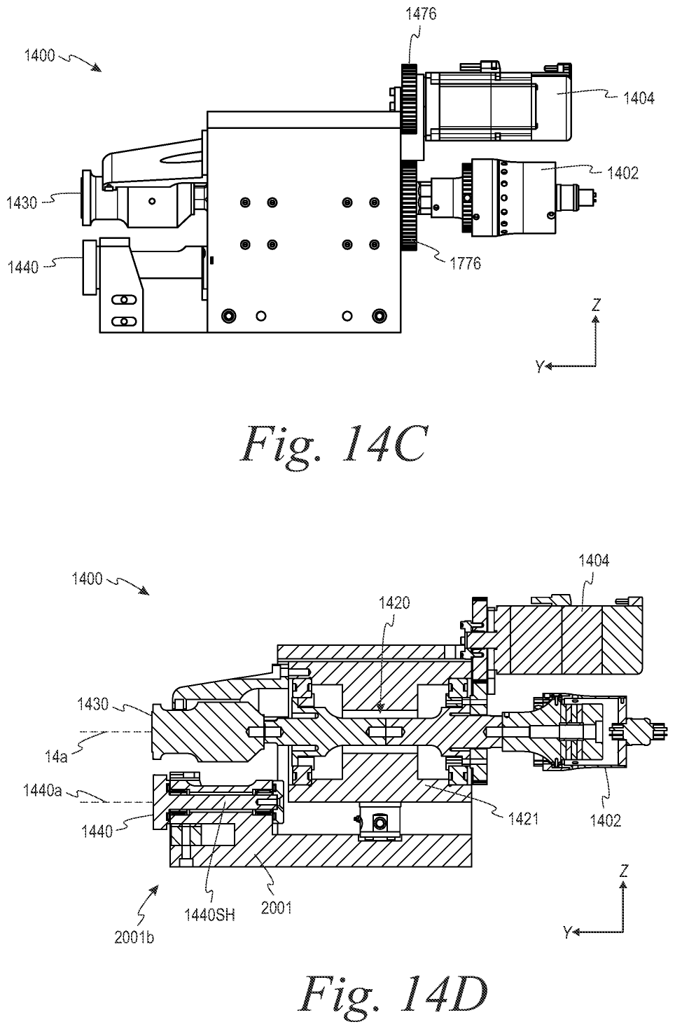

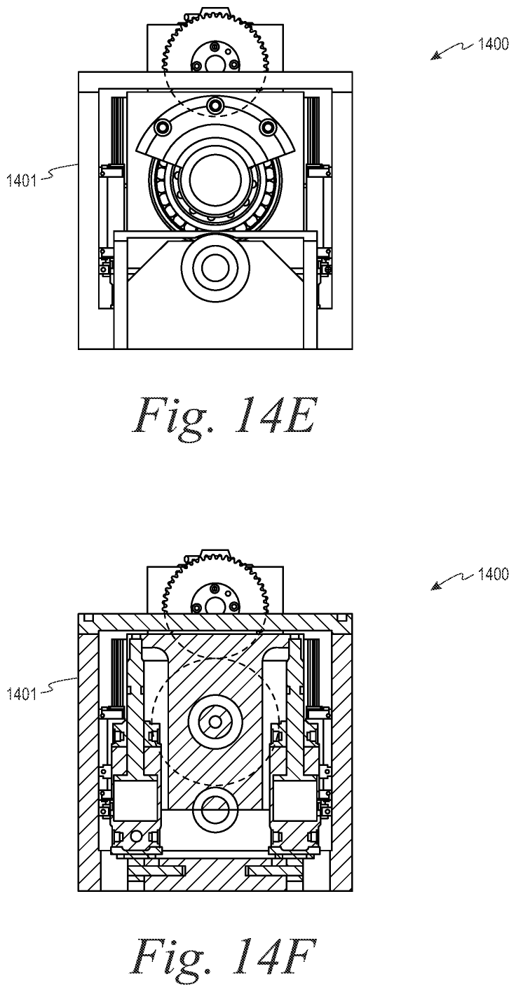

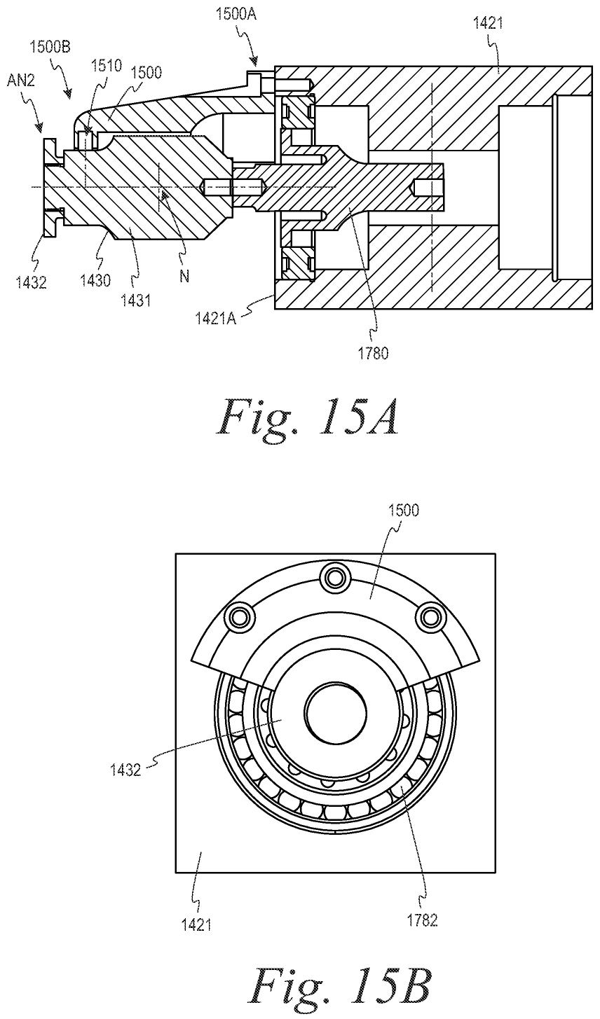

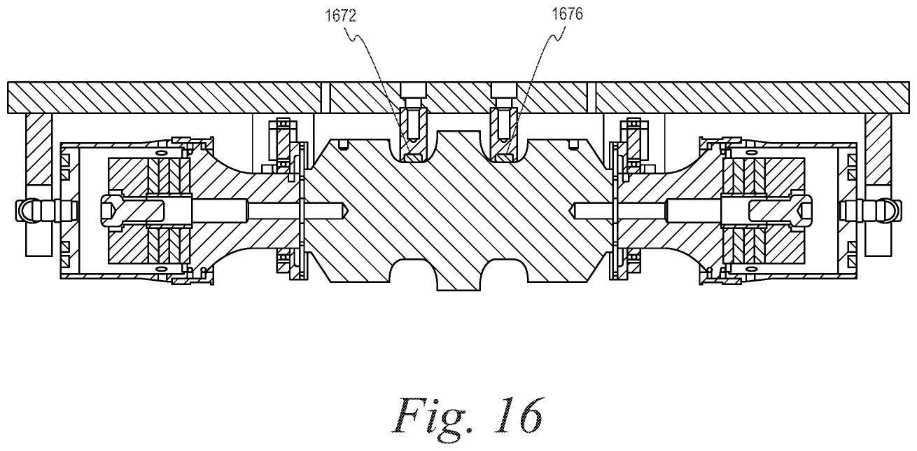

According to some embodiments, ultrasonic welding such as described below in conjunction with FIGS. 14-15 and 17-20 is employed to produce a fully hermetic, non-porous, continuous perimeter seal or seam 110 around the metal side plates 104, 106 that is reliable and consistent and results in a rigid plate PCM panel or PCM storage unit 100, 1100 with metal faces that is leak-proof and resistive to loss of liquid PCM and internal expansion of related gasses which are created during fire testing such as E84 testing or fire events. Plates manufactured using ultrasonic welding can be shaped in multiple configurations, including square, rectangular, oval, round and combinations of each.

### Benefits of PCM Plates

PCM storage units or panels 100, 1100 made using sides 104, 106 of aluminum metal or metal alloys such as aluminum alloys have been found to meet or exceed building fire code safety requirements for PCM products placed into HVAC systems, including ASTM E84, UL 723 and NFPA 255 certifications. Such PCM panels 100, 1100 are more durable, stronger, are stiffer and less likely to fail during installation or during the expected life of the product, do not require use of a mat or flexible film based macro-encapsulation, and/or are self-supporting plates or panels. Such PCM panels 100, 1100 made using sides 104, 106 of aluminum or aluminum alloys are more thermally reactive than most other macro-encapsulation systems and therefore transfer thermal energy more efficiently and yield more energy savings, and are cost effective assemblies, given the very high thermal conductivity of aluminum and aluminum alloys combined with relative low cost of production and higher PCM payload per square foot (or meter) of the panels 100, 1100. PCM storage units or panels 100, 1100 made using sides 104, 106 of aluminum metal or metal alloys can prevent or inhibit PCM leaking, breaching, and/or seeping out of the units or panels.

### Additional PCM Plate Features and Benefits

Depending upon the size of the completed panel 100, 1100 and intended installation location, there may be one or more features added to the panels to make them leak-proof, more thermally reactive, faster transitioning, stronger, easier to handle, less or more costly and capable of integration into an active network of smart products and control systems. Additional benefits of plate PCM panels include enhanced air flow around and through multiple plates. Reduction of drag or air flow around and/or through PCM plates is desirable when PCM plates are installed in the supply or return ducting of HVAC systems.

These features may be stand-alone, in that they are applied to only one of the two sides 104, 106, or they may be integrated into the overall manufacturing and seaming of the panel so that features on each of the two sides 104, 106 may be bolted or otherwise joined together using various joining technologies.

Non-perimeter areas of the panel 100, 1100 may contain depressions, impressions, ribs, grooves, striations, or deformations to one or both sides of the plate sides 104, 106 which are added for increased strength and heat transfer characteristics. Non-perimeter connections may be accompanied by deformations or impressions in the sides 104, 106 to allow opposing sides 104, 106 to contact each other as they are bolted or otherwise attached to each other. FIGS. 10A-10L are partial cross-sectional views of PCM storage units 1100 according to various embodiments of the present disclosure illustrating various exemplary profiles of plate sides 104, 106. FIGS. 10A-10L illustrate various fin profiles may could be used to improve the mechanical strength properties of a PCM storage unit 1100 as well as increase heat transfer properties such as rate of heat transfer and surface area. According to some embodiments, fins are employed to increase the heat transfer and air flow properties on the panels 1100 and can increase overall performance of thermal storage system. Fin profile details can be variable depending on needs and/or profiles can be added onto upper 104, lower 106 or possibly upper 104 and lower 106 sides of a PCM storage unit 1100. Design profiles can be symmetrical or asymmetrical depending on plate 1100 orientation. Surface texturing may be added to the panels 1100 for to increase the structural strength and/or properties of the panels 1100. Surface texturing may increase rigidity and/or strength of panels 1100 for various different reasons, such as for increased rigidity and/or strength during shipping and/or for installation stability.

According to some embodiments, PCM storage units or panels 100, 1100 may comprise heat sink fins, commonly found in automobile radiators, which may be bonded to the panels 100, 1100 to increase the amount of surface area exposed to the moving air in the HVAC system.

According to some embodiments, depressions, impressions, or deformations to one or both sides of the plate sides 104, 106 can be used to create separate compartments or PCM storage areas 108 within a PCM storage unit or panel 100, 1100, to make discrete certain sections or otherwise sub-compartmentalize the PCM 112 within the PCM storage unit or panel 100, 1100. According to some embodiments, the use of PCM storage units or panels, 100, 1100 having separate, discrete, PCM storage areas 108 that are not in fluid communication with each other reduces the amount of PCM allowed to freely flow within a PCM storage unit or panel, 100, 1100, which may in turn facilitate fire testing success and fire certifications, in that less PCM 112 is subject to release and combustion when a portion of a PCM storage unit or panel, 100, 1100 fails or breaches.

FIG. 3 illustrates an example of a PCM storage unit or panel 300 having four compartments or cells 102a, 102b, 102c, 102d, each having a separate PCM storage area 108 which is not in fluid communication with the storage areas 108 in the other cells. While in FIG. 3, four discrete compartments are shown, a PCM storage unit 1100 may have fewer or more than four discrete compartments and the construction illustrated and described with reference to FIG. 3 applies to panels 1100 having different numbers of multiple compartments. A perimeter seal 110 is made about the perimeter of the sides 104, 106 which may be made of metal or metal alloy. Intermediate seams 310 divide the PCM storage unit or panel 300 into the four compartments 102a, 102b, 102c, 102d. Individual fill ports 820 are illustrated, in this case one fill port 820 per compartment, although according to some embodiments, more or no fill ports 820 may be associated with each compartment 102a-102d. Separate tack-offs 710 in each of the individual compartments 102a-102d are included according to some embodiments. According to some embodiments, supplemental support fasteners 320 may be included in the panel 300 and may be located along the intermediate seams 310 for providing means for supporting or additionally supporting the panel 300 when installed in a building, if needed.

In some cases, physical texturing of the metal or metal alloy surfaces of one or more of the sides 104, 106 may be added, to improve upon package strength, stiffness, torsional rigidity and, in some cases, increase surface area and improve convective heat transfer rates and performance improvement, as well as ease of handling. See, e.g., FIGS. 10A-10L. Texturing may include stippling, stamping, forming, and/or etching to decrease the smoothness of the metal or metal alloy panels 1100. In some cases, metal or metal alloy fins may be added to one or both sides 104, 106, whether completely covering the whole face of a panel 1100, or just in certain areas of the panel faces.

In some cases, and where desirable, paint or other finish treatment may be applied to exterior sides of one or both sides 104, 106 of the metal or metal alloy PCM storage unit or panel 1100, where the type and color of the exterior treatment is selected to enhance emissivity of the macro-encapsulated PCM storage unit or panel 1100. Black, low gloss or matte paint being an example of a final coating that can be applied to the PCM storage unit or panel 1100 to increase the radiative properties of the PCM storage unit or panel 1100 and may dramatically increase emissivity of the PCM storage unit or panel 1100.

Metal or metal alloy PCM storage units or panels 1100 can be designed and manufactured to have one or more brackets or tabs or related features that allow the PCM storage units or panels 1100 to be installed as a complete assembly consisting of multiple PCM storage units or panels 1100 in a stacked orientation, whether stacked vertically or horizontally or at some other orientation, and where the PCM storage units or panels 1100 are separated by sufficient air space to ensure optimal convective heat transfer between the air in a plenum or vent and the PCM storage units or panels 1100. The brackets or tabs can be integral to the PCM storage units or panels 1100 or can be manufactured independently, but may be designed as part of a system to create a rack or stack of PCM storage units or panels 1100 and ensure that multiple PCM storage units or panels 1100 can be installed where air can travel through the stack of PCM storage units or panels 1100 without significant pressure drop or loss of air volume, measured in volume unit per second, e.g., cubic feet or cubic meter per second.

FIG. 4 illustrates some examples of tabs or brackets manufactured as part of a PCM storage unit or panel 400, 1100 production process that allow the PCM panels to be bundled into an assembly of PCM panels and installed in a building according to some embodiments. An opening or aperture 410 is illustrated thru which a support rod or wire can be installed to support the panel and to make a multiple-panel assembly that can be either hung or supported from below. In this case, the support opening is located as part of the perimeter seam 110. Alternatively, or in addition to using apertures 410, a support member 411 may be located outside of the perimeter seam 110 and at the corner of the panel 400. The support member 411 may be fabricated integrally with the panel 400 and/or may be mechanically coupled thereto. Alternatively, or additionally to apertures 410 and/or support members 411, one or more support tabs 412 may be mounted along the side of the panel 400, 1100 and outside of the perimeter seam 110.

Depending upon the specific location where the panels 1100 are to be used, according to some embodiments, spacing between adjacent panels 1100 can be from about 0.10 inch (0.25 cm) to about 72 inches (183 cm), depending upon the engineered thermal application, desired energy storage, related cost savings, and/or maximum air flow pressure drop allowed for the application.

The panels 1100 may have features that allow the use of integrated cables or wires to be inserted into the tabs and used to create a hanging rack of PCM panels 1100. Such racks may be supported from a roof or floor framing above the plenum. Alternatively, the PCM panels 1100 may not have special features manufactured as integral to the macro-encapsulation of the PCM and may be inserted into racks or grid system where the individual PCM panels 1100 are held and desired spacing is maintained.

According to other embodiments, PCM storage units described herein are suspended above and spaced from the top of the ceiling tiles 602, so as to induce convective heat transfer for both sides of the PCM storage units, which according to some embodiments provides a better and faster heat transfer method of installation, resulting in more thermal energy being stored and released by the PCM. An example of suspending PCM in packages above ceiling tiles is described in more detail in U.S. Pat. No. 10,634,371 B2 incorporated herein by reference in its entirety.

According to some embodiments, metal or metal alloys PCM storage units or plates 1100 may be installed anywhere in a building where thermal energy savings may be obtained, including in the building envelope or within the building envelope. A building envelope is the structural framing and insulative barrier that separates the conditioned interior from the ambient outdoor. According to some embodiments, metal or metal alloys PCM storage units or plates 1100 may be installed in the building envelope, such as behind drywall or under roof decking (envelope applications). According to some embodiments, metal or metal alloys PCM storage units or plates 1100 may be installed inside the envelope, like above ceiling tiles or into the supply or return plenums of buildings. According to some embodiments, metal or metal alloys PCM storage units or plates 1100 are designed to work integrally with HVAC systems and are installed in the plenums of HVAC systems of commercial, residential, and/or purpose-built buildings. The plenums may be open or ducted and may be supply or return plenums and may be only for mechanically conditioned air or may be supplemented by use of fresh, outdoor ambient air.

For open return plenum above a ceiling, PCM storage units or plates 1100 may be installed directly on top of the ceiling tiles 602 and are supported by either the ceiling tile 602 or the T-Bar ceiling tile support system 604 framing the ceiling tile system, or by the drywall ceiling itself. This method allows one layer of PCM storage units or plates to be installed as illustrated, for example, in FIGS. 6A and 6B.

Alternatively, or additionally, PCM storage units or plates 1100 can be installed in open return plenums by using a grid or rack system that allows more than one storage unit or plate to be installed over a ceiling tile 602. The grid or rack system can be supported from below or from the framing above, and the PCM storage units or plates are placed to increase the amount of thermal mass of PCM 112 while maintaining enough spacing between plates to ensure effective energy transfer and phase transition.

Alternatively, or additionally PCM storage units or plates can also be installed in open return plenums by using wires or cables or nets attached to the PCM storage units or plates 1100 for support and the multiple storage unit or plate assembly is then supported from the underside of the roof or floor framing above the ceiling tiles or drywall ceiling.

Installing multiple PCM storage units or plates 1100 in the same vertical space increases the thermal energy storage capacity in the vertical space above any given ceiling tile 602. According to some embodiments, it also increases the thermal energy transfer from the plenum air into the PCM storage units or plates, as the storage units or plates are installed in the warmest portion of the moving return plenum air which provides the greatest benefit for cooling air to be supplied by an HVAC system.

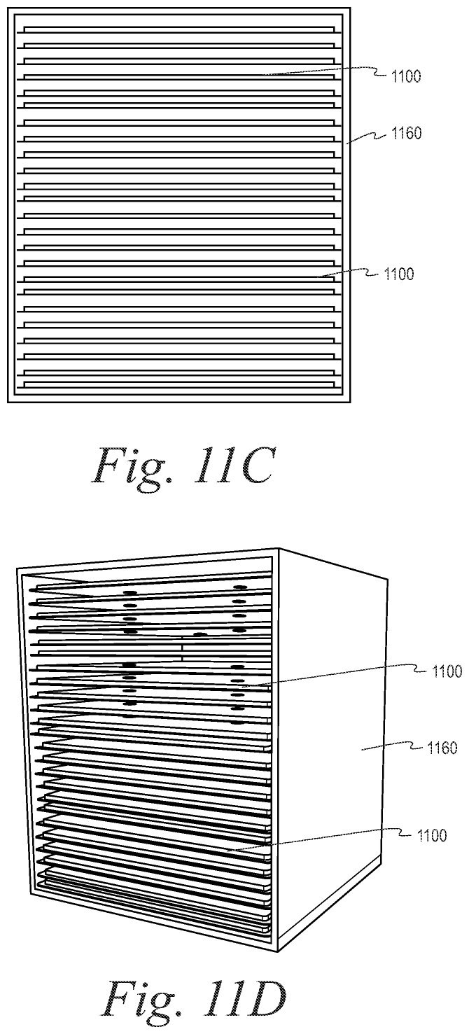

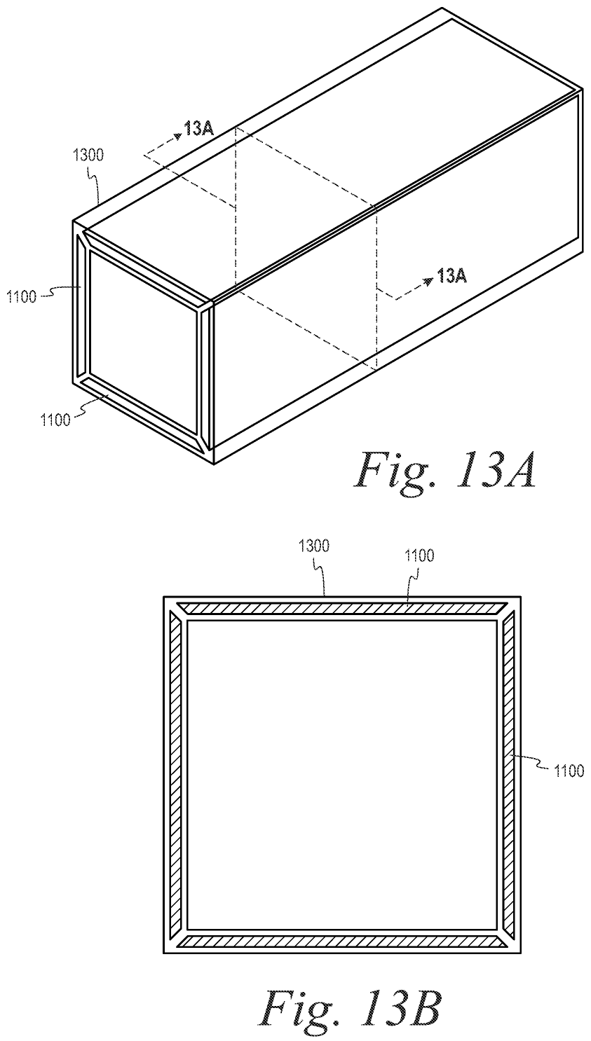

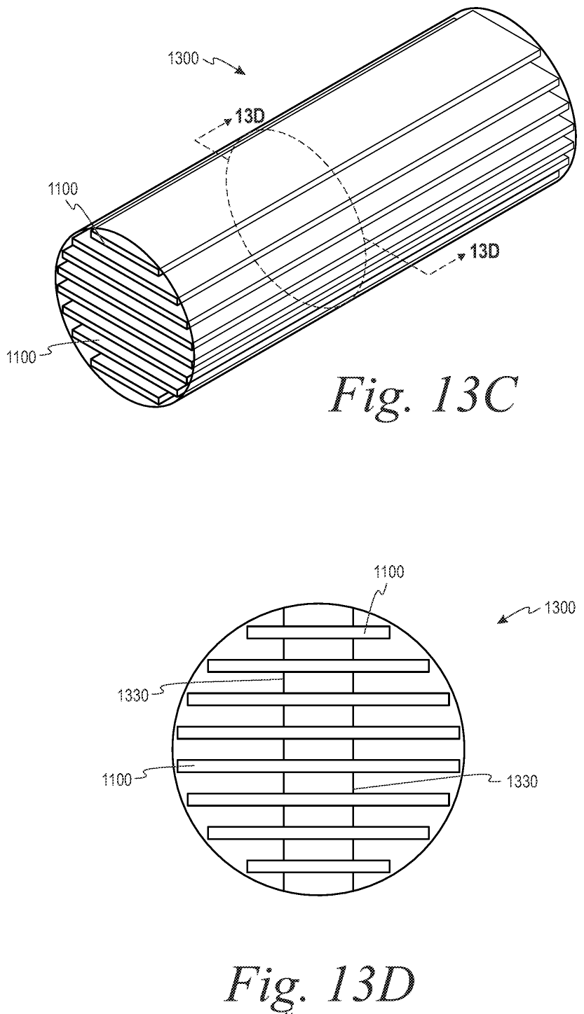

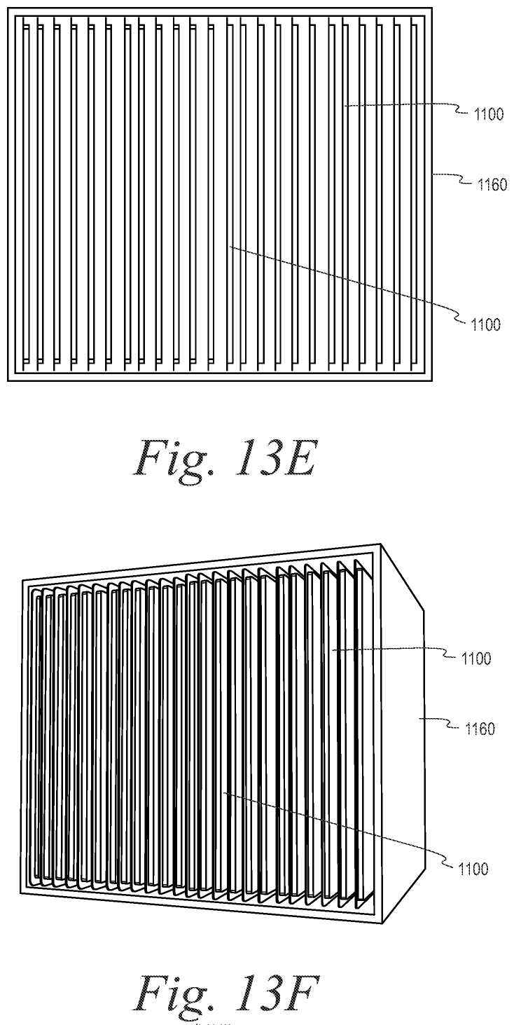

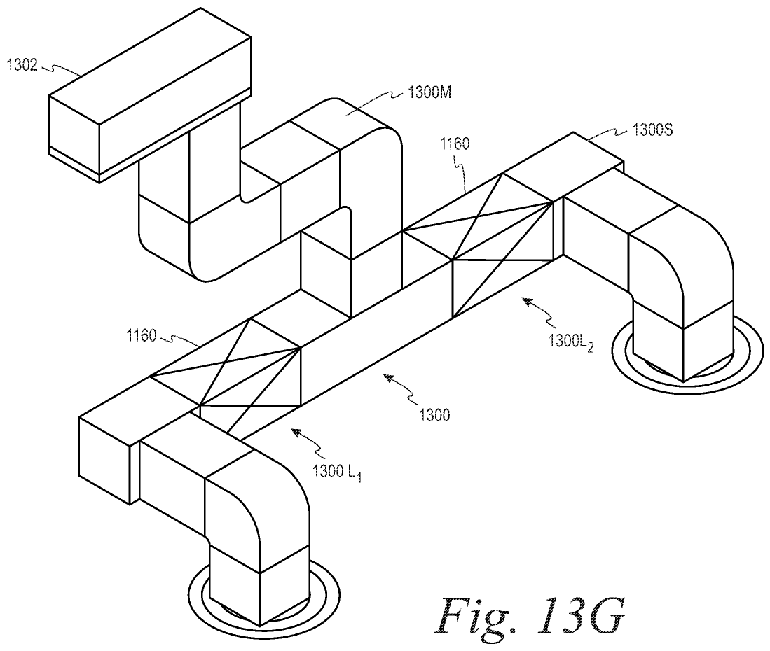

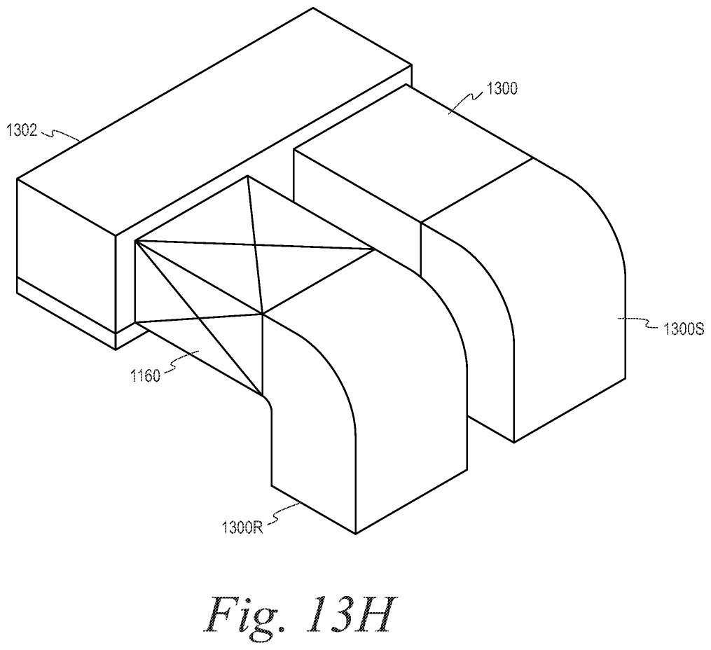

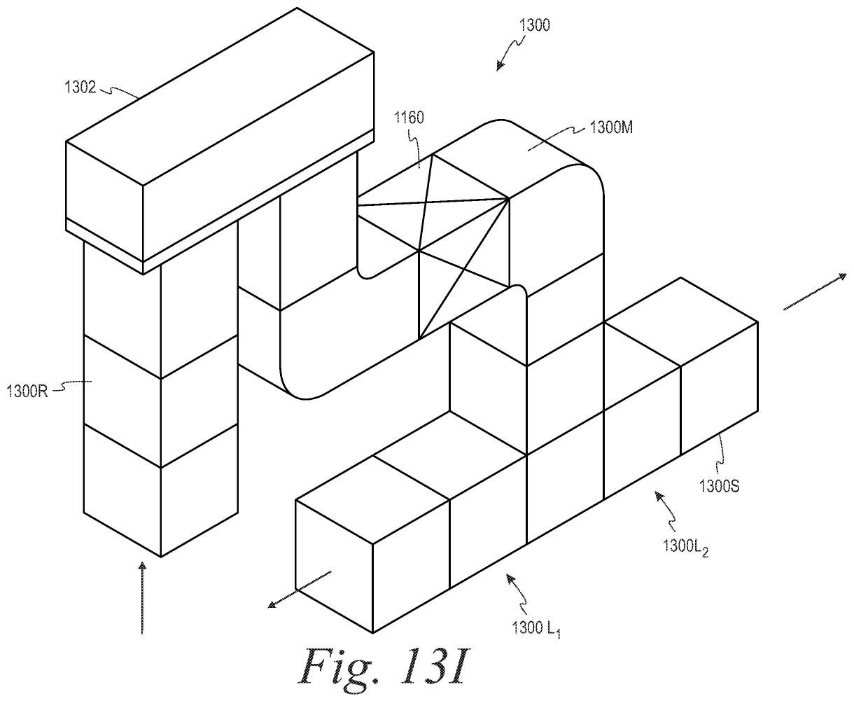

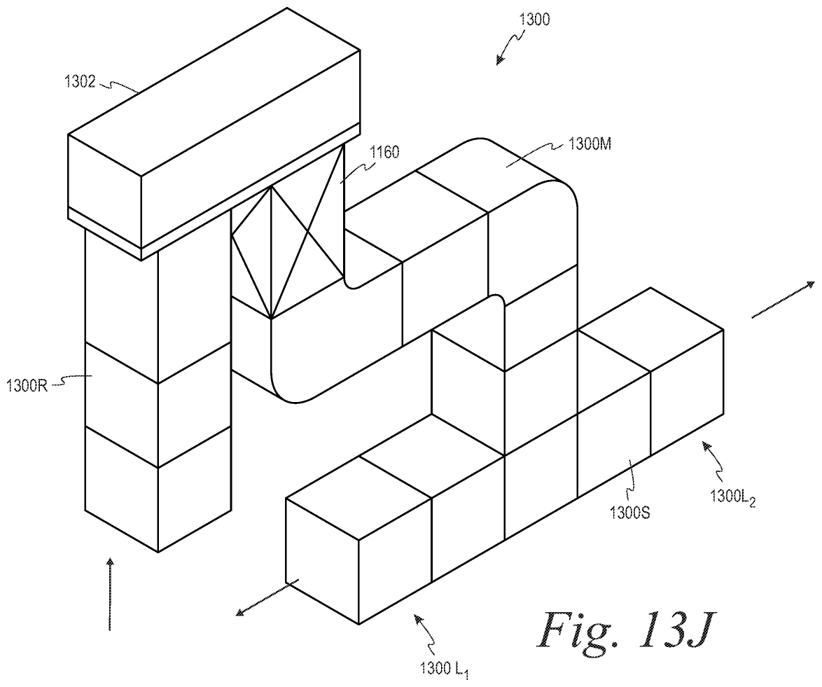

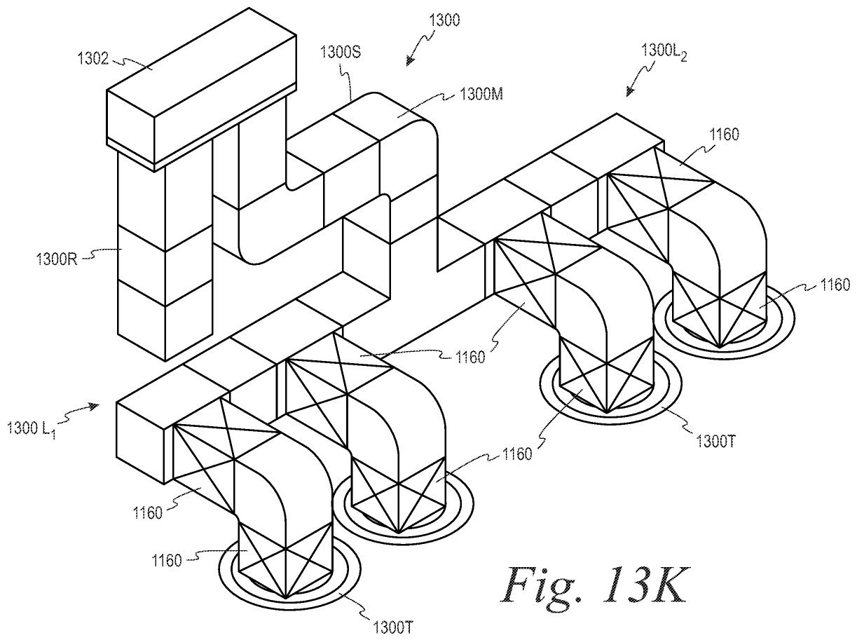

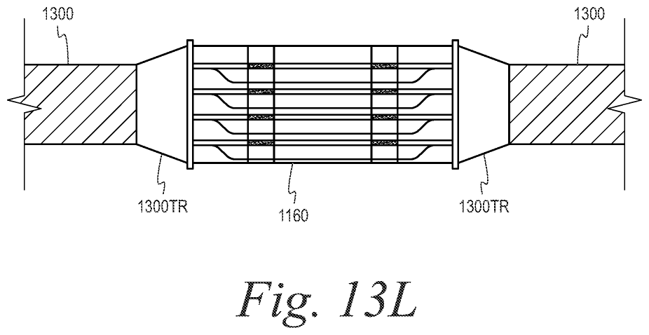

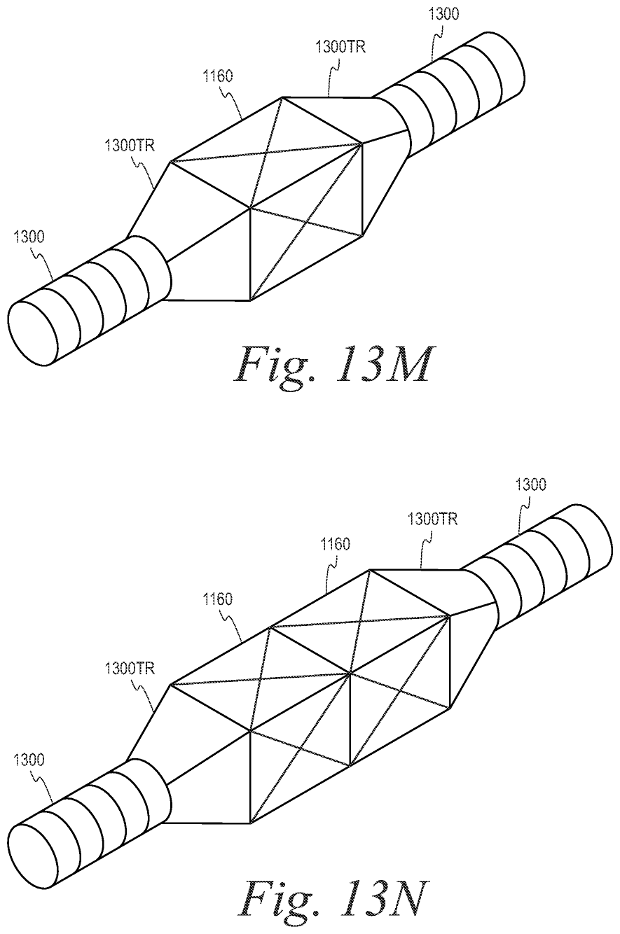

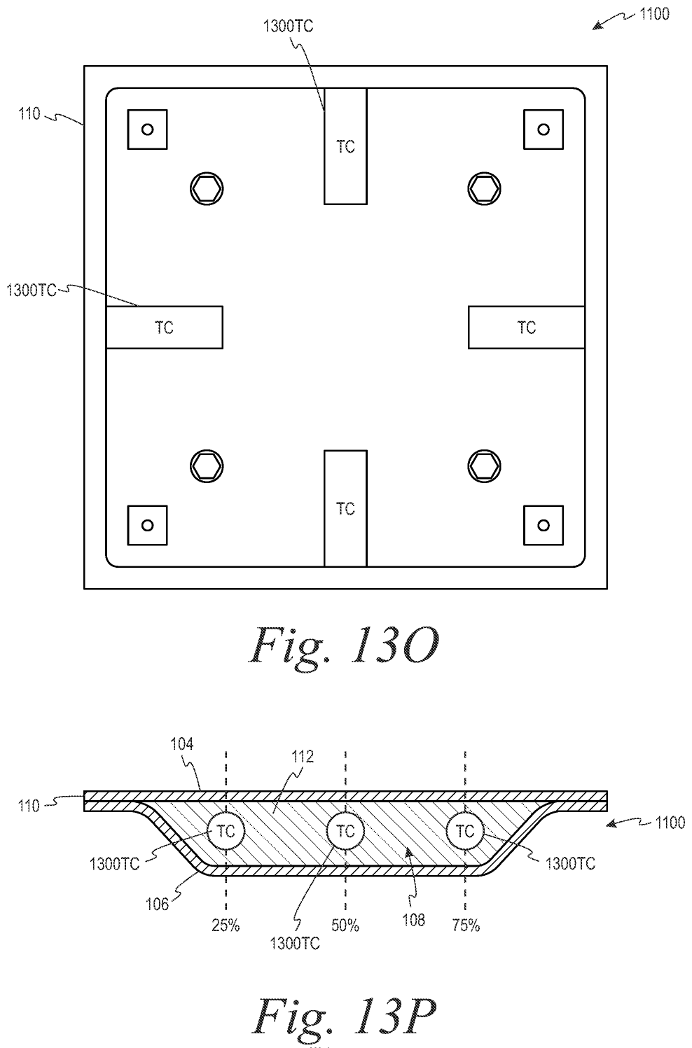

FIG. 11A is side view of a plurality of PCM storage units 1100 installed in a horizontal manner in a plenum 1102 according to some embodiments of the present disclosure. FIG. 11B is side view of a plurality of PCM storage units 1100 installed in a vertical manner in a plenum 1102 according to some embodiments of the present disclosure. FIG. 11C is side view and FIG. 11D is a perspective view of a plurality of PCM storage units 1100 installed in a horizontal manner in a PCM plate box 1160 according to some embodiments of the present disclosure. FIG. 13E is side view and FIG. 13F is a perspective view of a plurality of PCM storage units 1100 installed in a vertical manner in a PCM plate box 1160 according to some embodiments of the present disclosure.

As mentioned above, the PCM storage units or plates 1100 can be any of the PCM storage units described herein such as, for example, PCM storage units 100, 200, 300, 400, 500 and/or 1000.

As shown in FIG. 11A, according to some embodiments, multiple PCM storage units or plates 1100 are bundled together to create a PCM assembly 1120 of PCM storage units or plates 1100 using wires or cables 1130 to fix in-place the multi-plate assembly 1120 which is then installed into the plenum 1102 of the HVAC system. A ceiling tile system comprising the ceiling tiles 602 and the ceiling tile support system 604 may or may not define part of the open plenum 1102. The PCM storage units or plates 1100 are suspended in the air flow of the plenum 1102. According to some embodiments, support members 1130 are used to suspend the PCM storage units or plates 1100 from the structural framing 1110 of the building above the plenum 1102 such as via attachment hardware 1140 such as fasteners, such as self-drilling fasteners, or bolts, whether installed into roof framing or installed into support members specifically installed, such as hat channels, other structural support members, purlins or studs, to support hanging PCM assemblies. According to some embodiments, the PCM assembly 1120 is hung from and/or connected to the structural framing 1110 above and one or more PCM storage units or plates 1100 are installed within the PCM assembly 1120.

In FIG. 11B, multiple PCM storage units or plates 1100 are bundled together and installed in the plenum 1102 but are suspended vertically. According to some such embodiments, the elements are the same as a horizontally suspended plate assembly 1120 but with the addition of elements 1150 which serves to stabilize the hanging plates. These elements include rods, pins, straps, brackets, tabs and other supports which facilitate the installation and support of the PCM panels.

According to some embodiments, it is desirable to concentrate the installation of PCM storage units or plates 1100 on racks supported from below or hanging from the structure 1110 above in a concentrated deployment, where a plurality of PCM storage units or plates 1100 are concentrated around return air grills, or points at which air from occupied space. Occupied space is human occupied area with typical internal loads such as lights, computers, electrical appurtenances such as copiers, printers, coffee makers, refrigerators, microwaves, that generate internal heat which must be dispelled by the HVAC system is served into the plenum. At or near, e.g., within about 10 feet (3 m) or within about 20 feet (6 m) from the center of a return grill, the temperature of the plenum air entering the plenum is the warmest and the air velocity is greatest, so the PCM storage units or plates 1100 installed in a concentrated orientation surrounding the return grills are subject to the most favorable conditions for capturing and releasing thermal energy. Installation in this manner may yield greater energy savings and demand charge reductions.

The quantity of PCM storage units or plates 1100, their exact location relative to the return grills, the spacing of the plates within the rack or grids and/or the phase transition temperature of the PCM 112 selected may be an engineering decision based upon specific building variables, such as plenum temperature, air velocity, plenum size, air flow and capacity of the air handling equipment integral to the HVAC system. Deployment of PCM storage units or plates 1100 concentrated in specific areas offering the greatest potential for thermal energy management can be particularly advantageous. FIGS. 13A-13N illustrate various locations at which PCM storage units or plates 1100, PCM assemblies 1120, and/or PCM plate boxes 1160 may be position in an HVAC or venting system.

FIG. 13A is a perspective view and FIG. 13B is a cross-sectional view of a duct 1300 having one or more PCM storage units or plates 1100 mounted adjacent to one or more of the walls or sides of the duct 1300. According to some embodiments, PCM plates 1100 are incorporated between sheet metal layers of metal hard ducting 1300 for an HVAC system for new and/or retrofit applications. For example, the PCM plates 1100 shown in FIGS. 13A-13B are fire rated aluminum plates (e.g., plates 1100 that are Class A Plenum Rated) filled with PCM material and may be added into existing ductwork and/or be employed in new construction.

FIG. 13C is a perspective view and FIG. 13D is a cross-sectional view of a duct 1300 having a round cross-section and having one or more PCM storage units or plates 1100 mounted therein. In the embodiment shown in FIGS. 13C-13D PCM storage units or plates 1100 are mounted within the duct 1300 such that the lengths and widths of the plates 1100 are generally parallel to each other and a direction of air flow through the duct 1300. According to some embodiments, wires or cables or rigid structures 1330 are employed to maintain the orientation of the plates 1100 within the duct 1300 and relative to each other.

With respect to FIGS. 13A-13D, these figures illustrate different designs of incorporating PCM plates 1100 into, for example, existing rigid metal ducting either within the walls of the sheet metal or in a rack system. According to some embodiments, incorporating TESS enclosure 1160 into composite ducts allows for different areas of installation in different retrofit applications as well as new construction and/or into existing or new metal ducting 1300, new or retrofit. Composite duct is a combination of different types of ducting such as flexible ducting, sheet metal ducting, or fiberglass ducting incorporating the PCM. According to some embodiments, PCM plates 1100 can be of uniform size, or have unique sizes, can be installed on inside of all exterior faces or just one or more of the interior faces, vertically or horizontally, same or dissimilar sizes, etc. Furthermore. The PCM plates 1100 may be installed into new and/or existing ducts 1300 which may be sheet metal or flex duct or combination of both

FIG. 13G illustrates some exemplary locations at which PCM plate boxes 1160 may be positioned in supply side 1300S ductwork 1300 of an HVAC or venting system having an air handling unit 1302 according to some embodiments such as positioning PCM plate boxes 1160 in the localized supply lines after the main supply plenum 1300M splits into two smaller lines 1300L₁, 1300L₂.

FIG. 13H illustrates an exemplary location at which a PCM plate box 1160 may be positioned in a return side 1300R ductwork 1300 of an HVAC or venting system having an air handling unit 1302 according to some embodiments such as positioning a PCM plate box 1160 in a side plenum of an HVAC unit on the outside of the building envelope, such as on a roof of a building.

FIGS. 13I-13K illustrates other exemplary locations at which PCM plate boxes 1160 may be positioned in a supply side 1300S ductwork 1300 of an HVAC or venting system having an air handling unit 1302 according to some embodiments. For example, in FIG. 13I a PCM plate box 1160 is positioned in a main supply line 1300M of the AHU/RTU 1302 before being split off into two smaller lines 1300L₁, 1300L₂. In FIG. 13J a PCM plate box 1160 is positioned in a main supply line 1300M adjacent a AHU/RTU 1302 before being split off into two smaller lines 1300L₁, 1300L₂. According to some embodiments, the PCM plate box 1160 is placed in lieu of the supply plenum acting as ductwork as well as thermal storage. In FIG. 13K, PCM plate boxes 1160 are positioned in two smaller lines 1300L₁, 1300L₂ after being split off from the main supply line 1300M with the PCM plate boxes 1160 being located near the supply grilles 1300T of an HVAC system. According to some embodiments, FIGS. 13I-13K illustrate different designs of positioning PCM plate boxes 1160 in the HVAC system/ductwork of a rooftop unit (RTU). According to some embodiments, PCM plates 1100 and/or PCM plate boxes 1160 can be installed wherever supply or return ducting exists, and can be installed in any combination of areas within a ducting system, and not just pre-determined and specific locations. According to some embodiments, PCM plates 1100 and/or PCM plate boxes 1160 can be retrofitted into existing ductwork or installed with an integrated enclosure within the supply or return ducting. According to some embodiments, PCM plate boxes 1160 are not limited to one single location, e.g. supply plenum, and their location(s) can be varied depending on applications. Such flexibility allows for new possibilities for retrofit applications and less limitations on installations (plenum space needed).

FIGS. 13L-13N illustrate the use of transition boxes 1300TR to accommodate PCM plate boxes 1160 having a different size and/or shape than a duct system 1300 to which the PCM plate boxes 1160 are coupled. FIG. 13M illustrates an example of an embodiment including a single box 1160 of PCM plates 1100 whereas FIG. 13N illustrates an example of an embodiment including multiple boxes 1160 of PCM plates 1100 are coupled to each other to increase the PCM payload.

According to some embodiments, for ducted supply or return plenums, the PCM storage units or plates 1100 are installed within the ducts 1300. The PCM storage units or plates 1100 may be installed directly into the existing ductwork 1300 (see, e.g., FIGS. 13A-13D) or may be installed as part of a new supply duct system where the PCM storage units or plates 1100 are placed within the ducting before the section of the duct is installed and/or coupled to other ductwork in which no PCM storage units or plates 1100 are located. In some embodiments, the PCM storage units or plates 1100 may be installed inside the new or existing ductwork, adjacent to the inside walls of the ducting 1300, in such a way that the inside faces of the ducting are lined with PCM plates or flexible packaged PCM. See, e.g., FIGS. 13A-13B. The PCM may be attached to the inside of flexible ducting or the inside of sheet metal ducting. The PCM packages installed in the ducting are designed to store and release thermal energy inherent in the supply air or return air stream and impact energy consumption of the HVAC system. In some cases, the PCM storage units or plates 1100 may be installed as an integrated assembly, where the PCM storage units or plates 1100 are installed in a prefabricated enclosure, such as a metal box, e.g., PCM plate box 1160, which assembly, when installed, is designed to act as a composite duct system incorporating directed supply or return air flow combined with PCM thermal storage such as shown in FIGS. 11C-11F. The integrated assembly may be insulated or can be uninsulated. PCM plates may be integrated into existing or new square or round sheet metal ducting. The plates may either be incorporated into the sheet metals walls of the ducting or inserted with a separate rack system for mounting purposes. The plates may also be placed in either a vertical or horizontal orientation in the ductwork depending on the shape. The PCM plate size may be uniform or uniquely sized in the ductwork depending on the dimensions of the sheet metal. See FIGS. 13A-13D.

According to some embodiments, in some ducted supply 1300S or return 1300R systems, the PCM storage units or plates 1100 are first concentrated into a single PCM plate box or vessel such as PCM plate boxes 1160 that can hold multiple PCM storage units or plates 1100, and the supply 1300S or return 1300R ducting system is routed into the PCM plate box and then out of the box, effectively installed by splicing the box of PCM plates into the supply or return duct system, and routing the supply or return air through an enclosure filled with PCM plates. According to some embodiments, the PCM plate box may be located anywhere between the AHU 1302 and the duct terminus 1300T of the HVAC system. According to some embodiments, the PCM plate box 1160 may be installed into the new or pre-existing supply plenum directly coming off the HVAC unit either in a vertical or horizontal orientation such as shown in the FIGS. 13H and 13J. In some cases, the PCM plate box 1160 may be located in the main supply trunk downstream from the supply plenum such as shown in FIG. 13I. According to some embodiments, the PCM plate box 1160 may be located in the local supply HVAC lines once the system has diverted from the main supply plenum coming off of the HVAC unit such as shown in FIG. 13G. In some cases, the PCM plate boxes 1160 may be located at the terminal end of the HVAC ducting near the supply grilles for the conditioned space. This includes and is not limited to any combination of areas in the ducting system of the aforementioned locations. See FIGS. 13G-13K.

According to some embodiments, a purpose using PCM plates 1100 such as in a PCM plate box 1160 or PCM assembly 1120 of concentrated PCM, when installed in the return air plenum of an HVAC system providing air conditioning is to remove some portion of thermal energy from the return air and store it in the PCM plates. Removing thermal energy from the return air reduces the temperature of the air as the air returns to the air handling unit where it is conditioned by the compressor and condenser to provide cool air to the conditioned space. Reducing the temperature of the return air results in an energy use savings as less energy is required to cool the return air before it is returned to the conditioned space as supply air. Such a system of reducing return air temperature by storing thermal energy in this PCM plate box of concentrated PCM can be used in ducted return plenums, where the PCM plate box 1160 is installed in the return ducting 1300R, or can be used in an open return plenum by installing the PCM plate box 1160 directly to the return air port at the air handling unit 1302 (and/or using PCM assembly(ies) 1120 near the return air port). PCM transition temperatures for this return air application range from about 21° C. to about 27° C. (about 70° F. to about 80° F.), depending upon the thermal characteristics and desired temperatures of the conditioned space.

According to some embodiments, a purpose of PCM plates 1100 such as a PCM plate box(es) 1160 of concentrated PCM, when installed in the supply air ducting 1300S of an HVAC system providing air conditioning, or PCM assembly(ies) 1120 is to create a reservoir of on-demand cooling capability from the frozen PCM which can be utilized when needed, by turning off the air conditioner condenser and compressor and using fans only to distribute PCM cooling. The PCM is the PCM plates 1100 such as in a PCM assembly(ies) 1120 and/or a PCM plate box(es) 1160 of concentrated PCM, installed in the supply air ducting 1300S of the HVAC system, transitions to solid state during air conditioning operations during the day. Supply air temperature, emanating from the HVAC system when in cooling mode, may range from about 50° F. (10° C.) to about 60° F. (15° C.). When this cold air passes PCM plate(s) 1100 such as through the PCM plate box of concentrated PCM and/or or PCM assembly 1120, it solidifies or freezes the PCM 112, provided the transition temperature of the PCM is higher than the supply air temperature. For cooling, such as via the use PCM plate box of concentrated PCM applications designed for HVAC cooling use or PCM assembly(ies) 1120, the PCM transition temperatures may be selected to range from about 16° C. to about 21° C. (about 61° F. to about 70° F.). When the PCM plates 1100 become solid or mostly solid, they can be used to provide cooling to a conditioned space by disabling completely or partially the normal operations of the HVAC compressor and using the frozen PCM plates to cool the supply air. In such cases, the HVAC indoor fan may be used to circulate air within the HVAC system and the PCM plate box of concentrated PCM and/or PCM assembly 1120 satisfies the cooling requirements of the HVAC system by reducing the temperature of the supply air as it passes the PCM plates 1100 such as by passing through the PCM plate enclosure 1160 and/or PCM assembly 1120. The effect is the same as or similar to blowing warm air over water ice and the air is cooled as it passes over the water ice. This system of using PCM plates 1100 such as in a PCM plate box(es) of concentrated PCM 1160 or PCM assembly 1120 to cool the supply air can be employed passively or it can be actively deployed by automated controls, such as a smart thermostat or a building HVAC controller. A benefit of such systems is reducing the overall cost of energy required to cool a space.

Shifting of energy use from more expensive to less expensive periods is commonly called load shifting, and load shifting techniques can be used to solidify the PCM plates when energy costs are less and then deploy the stored cooling potential during the more expensive periods of the day, with little or no compressor operations, resulting in cooling cost savings. During normal daily cooling operations, the PCM plates are solidified using lower cost energy. For example, energy may be less expensive during the morning, early afternoon and/or nighttime periods and energy may be most costly during late afternoon and/or early evening. When the cost of energy increases, the compressor operations may be either reduced or completely eliminated by an automated control system, and an indoor fan such as an HVAC system fan may be used to circulate air through the PCM plate enclosures 1160 and/or plates 1100, thereby providing cooling to the conditioned space.

Shifting the energy use from expensive periods to less expensive periods has several benefits. There is a financial savings benefit for the ratepayer due to cost savings derived from consuming energy for air conditioning buildings when the energy is less expensive. There is a benefit to the utility company when electricity demand is shifted from late-day, peak periods, when demand for electricity can exceed supply, to lower demand, off-peak periods. There are socioeconomic benefits due to load shifting air conditioning use from peak to off-peak periods, as energy use during off-peak periods result in lower emissions of greenhouse gases.

Overall energy consumption for air conditioning can be reduced, in some cases, when the PCM plates are solidified or frozen at night by using the fan to circulate outside, cooler ambient air through the HVAC system. In this example, an economizer unit, attached to the HVAC system, can use the cooler nighttime air to freeze the PCM plates, resulting in a low-cost solidification of the PCM, as no compressor operations are required. According to some embodiments, an economizer unit can either be add-on or original OEM unit that is used to supplement cooling and ventilation. According to some embodiments, economizers have controllers that can detect outside temperature and humidity to determine whether it can use outside air for cooling instead of the mechanical compressor. Energy savings, both consumption and costs, are achieved as the PCM plates 1100 such as within the concentrated enclosure 1160 are solidified using fan power to circulate air and no compressor operations.

PCM plate(s) 1100 such as in a PCM plate box 1160 or PCM assembly 1120 of concentrated PCM, such as when installed in the supply air ducting 1300S of an HVAC system providing heating, can create a reservoir of on-demand heating capability from the melted PCM which can be utilized when needed, by turning off the heating elements of an HVAC furnace or heat pump and using fans only to distribute PCM heating. The PCM plate box 1160 or PCM assembly 1120 of concentrated PCM, such as installed in the supply air ducting 1300S of the HVAC system, transitions to liquid state during heating operations during the day. Supply air temperature, emanating from the HVAC system when in heating mode, may range from about 110° F. to about 150° F. (about 43° C. to about 65° C.). When such hot air passes by PCM plates 1100 such as through a PCM plate box 1160 or PCM assembly 1120 of concentrated PCM, it liquefies or melts the PCM 112, provided the transition temperature of the PCM is lower than the supply air temperature. For PCM plate box 1160 or PCM assembly 1120 of concentrated PCM applications designed for HVAC heating use, the PCM may be selected to have transition temperatures ranging from about 28° C. to about 40° C. (about 82° F. to about 104° F.). When the PCM 112 in plates 1100 become liquid or mostly liquid, the plates 1100 can be used to provide heating to a conditioned space, by disabling completely or partially the normal operations of the HVAC heating functions. In this case, the HVAC indoor fan may be used to circulate air within the HVAC system and the PCM plate(s) 1100 such as in PCM plate box(es) 1160 or PCM assembly 1120 of concentrated PCM satisfies the heating requirements of the HVAC system by increasing the temperature of the supply air as it passes past the PCM plate(s) 1100 such as through a PCM plate enclosure 1160 or PCM assembly 1120. Such a system of using the PCM plate(s) 1100 such as in PCM plate box(es) 1160 or PCM assembly 1120 of concentrated PCM to warm the supply air can be employed passively or it can be actively deployed by automated controls, such as a smart thermostat or a building HVAC controller.

According to some embodiments, the amount of PCM installed in a PCM plate box 1160 or PCM assembly 1120 is determined by calculation of the energy requirements of the specific building space intended for PCM assisted cooling or heating. Using energy balance equations, the HVAC system heating or cooling capacity is offset by the thermal storage capacity based upon the quantity of PCM plates 1100 deployed and the resultant thermal mass capacity of the assembly. The rate of PCM plates cooling and heating may be determined by the control strategy employed by the automated HVAC controls.

According to some embodiments, the enclosure 1160 housing the PCM plates 1100 can be comprise many forms, such as 14ga to 32ga sheet metal. According to some embodiments, the materials used to create the enclosure are fire resistive, non-flammable and able to meet ASTM Class A fire standards. The enclosure 1160 can be designed as a single unit to house all of the required PCM plates or can be designed in a modular fashion where modules are connected in series (see e.g., FIG. 13N) and act as an integrated assembly. In many cases, a central, larger, concentrated box of PCM storage units or plates 1100 is installed in the supply 1300S and/or return 1300R ducts adjacent to the bottom of the packaged HVAC system, typically just below the air handling unit 1302 and roof framing. See, e.g., FIGS. 13H, 13J. The dimension of the large, central box 1160 may be determined by the number of PCM plates required to provide the desired total amount of thermal storage. Given that PCM plates sizes can vary the concentrated box size can also vary. Hence the size of the concentrated box is determined by the number of individual PCM plates and their unique PCM payload. In cases where access is limited or it would be difficult to install a large, centralized PCM plate enclosure 1160, smaller and decentralized boxes 1160 of PCM storage units or plates 1100 may be installed in a downsized box(es). See e.g., FIGS. 13G, 13K. In some cases, the PCM enclosure 1160 housing the PCM plates 1100 may be installed at the terminus end of the supply or return ducting adjacent to the supply or return grills or diffusers 1300T. See e.g., FIG. 13K. According to some embodiments, the PCM plate box 1160 is installed into the supply air or return air ducting just before exiting the duct system through the supply grills 1300T or after entering the return ducting after passing thorough the return grills 1300T. In either case, the number of PCM storage units or plates 1100 required may be calculated based upon the heating or cooling requirements of the specific room or space being modified. In this case, the duct sizes are much smaller than found near the air handling unit, so smaller enclosures may be used which house smaller PCM plates. In some cases, a combination of one or more large, centralized, PCM plate enclosures 1160 is combined with one or more terminus end PCM plate enclosures 1160.

PCM boxes 1160 can be installed at any point in the supply duct system, whether at the start of the supply ducts near the air handling unit, at the end of the supply ducts where they terminate at room diffusers, or anywhere in between, and can be installed in any combination of these locations.

The PCM plate enclosure 1160 may be sized to contain the number of PCM plates 1100 necessary to provide the amount of thermal storage desired. It may be advantageous to match the size of the enclosure, as closely as possible, to the size of the supply or return duct into which it is attached. Enclosure apertures can range from about 36 inch by about 36 inch to about 6 inch by about 6 inch (from about 91 cm by about 91 cm to about 15 cm by about 15 cm). Consequently, PCM plates, installed into the PCM enclosure, may be sized and manufactured in widths to accommodate the duct aperture, from about 36 inches by about 36 inches down to about 6 inches by about 6 inches wide (from about 91 cm by about 91 cm down to about 15 cm by about 15 cm). Lengths of the PCM plates 1100 may be determined by the overall length of the PCM enclosure, and can be modular, installed in series, or single length as required by the installation specifications.

PCM enclosure boxes 1160 may be sized to match the size of supply or return ducts into which the PCM box 1160 is to be installed, to promote uniform air flow through the ducting, and to avoid air flow disruption within the ducting or the PCM plate enclosure 1160, which disruptions can negatively impact the HVAC system performance. Supply and return ducts, which attach to the PCM plate enclosure 1160, can be rigid and formed of metal and can be square, rectangular or round. In some cases, supply and return ducts are semi-rigid, called flex-ducting, and have round apertures.

In many cases where ducting is attached to PCM plate enclosure, it is desirable to align PCM plate enclosure size and aperture with adjacent ducting, whether supply or return. Aligning duct size to PCM plate enclosure size promotes better air flow, reduces air disruptions and turbulence and ensures more equal air distribution within the PCM plate enclosure, which leads to more efficient and increases thermal energy transfer rates within the system. In cases where the PCM plate enclosure does not match the supply or return ducts, it may be desirable to install a transition box 1300TR, fabricated out of sheet metal, which is designed to allow for equalization of air flow as the air moves from the ducting into the PCM plate enclosure. See e.g., FIGS. 13L-13N. This transition box 1300TR can be designed as an air expansion chamber, where the air coming from the duct can expand and air flow can be normalized before it enters the PCM plate enclosure. In some cases, air flow vanes or air flow diverters can be installed in the transition boxes 1300TR to promote normalized, balanced, air flow into the PCM plate enclosure.

PCM plate enclosures can be designed to mate to sheet metal or flex ducting and can be used for supply air or return air applications. The PCM plate enclosures can be prefabricated and shipped fully or partially assembled or can be field assembled. The PCM plate enclosures can be installed with the PCM plates already installed inside the enclosures or can be installed first and then the PCM plates can be placed in the PCM plate enclosure. PCM plate enclosures can be designed to support the PCM plates with integral support brackets within the enclosure or can be designed to receive a fully or partially assembled, self-supporting rack of PCM plates. PCM plate enclosures can be sized and installed as a single unit or can be sized and installed in a modular fashion, such as where adjacent enclosures are installed in series. PCM plate enclosures can be designed to receive the PCM plates from the open ends of the enclosures or the PCM plate enclosure can be designed with removable access panels, whether top, bottom or either side, to gain access to install the PCM plates.

PCM plate enclosures, whether singular or installed in series, can be single chambered or dual chambered. In a single chamber system air passing through a duct is forced into the PCM plate enclosure, so that all of the air travelling through the ducts, at all times when the air is moving within the ducts, passes through the PCM plate enclosure. The PCM plates, in this case, can contain higher temperature PCM for use in heating applications or colder temperature PCM for use in cooling applications. In some cases, it is desirable to use a dual chamber PCM plate enclosure (or separate PCM plate enclosures), in which, e.g., a side by side PCM plate enclosure is installed and where air moving through a duct can be diverted by use of an automated damper controlled by the HVAC controller outfitted with custom PCM logic, to divert the air in the ducts to either a first chamber filled with lower temperature PCM plates for cooling applications, or diverted into an adjacent (and/or second) chamber filled with warmer PCM plates for heating applications. In some cases, it is desirable to use a dual chambered PCM plate enclosure (or separate PCM plate enclosures) where either higher temperature PCM plates or lower temperature PCM plates are installed and the automated damper is used to bypass the moving air within the duct around the PCM plate enclosure (or a selected one of the PCM plate enclosures). Such arrangements and methods are useful in climates where spring and fall weather patterns may require the HVAC system to provide heating in the morning, cooling in the afternoon and sometimes heating again in the evening. Determination of single chamber design, dual chamber with an automated bypass with or without alternate temperature PCM plates may be made based upon evaluation of site specific weather patterns, occupancy type and a cost-benefit analysis of the system based upon utility rate schedules.

According to some embodiments, PCM storage units or plates 1100 described herein having aluminum sides 104, 106 having ultrasonically welded perimeter seams have been tested and passed the ASTM E 84 fire test with less than 50 SDI and less than 25 FSI.

According to some embodiments, PCM storage units or plates 1100 comprise macro encapsulated PCM packaged within metal sheets, to form a rigid metal plate filled with PCM 112, which is capable of passing commercial building and HVAC code required ASTM E 84 Class A plenum rated testing, and National Fire Protection (NFPA) 255 and Underwriters laboratory (UL) 273 tests. According to some embodiments, the metal packaging and various additional features of the metal packaging of the PCM enhance the function or performance of the PCM storage units or plates 1100. According to some embodiments, PCM storage units or plates 100 measuring 22 inch (56 cm) by 22 inch (56 cm) and comprising macro encapsulated PCM 112 packaged within aluminum sheets, to form a rigid metal plate filled with PCM 112, have passed fire testing (ASTM E 84 Class A plenum rated testing).

According to some embodiments, methods of installing metal PCM storage units or plates 1100 as described, whether the PCM storage units or plates 1100 are installed as exposed plates in various fashions or whether the PCM storage units or plates 1100 are combined into a system or assembly incorporating multiple PCM storage units or plates 1100 which, once installed into a building or HVAC system, and combined with an HVAC controller or smart thermostat containing algorithms which optimize thermal energy storage and release, and/or limit or eliminate HVAC compressor operations during certain periods of the day when energy is more or less expensive, act as an integrated, active and adaptive thermal energy storage system, like a smart thermal battery, installed into the HVAC system which reduces energy consumption, lowers peak electrical demand, shifts demand from peak to off-peak time periods and/or lowers energy costs in buildings.

According to some embodiments, PCM storage units or plates 1100 comprise manufactured metal or metal alloy plates which are cut or stamped to a configuration and shape suitable for use as thermal PCM storage units or plates 1100. According to some embodiments, the plates are joined together around the plate perimeter and in some cases within the perimeter by advanced ultrasonic welding, such as by using a high frequency and high power ultrasonic welder described below.

According to some embodiments, the PCM storage unit or plate 1100 has a thermocouple or multiple thermocouples 1300TC associated therewith such as being embedded into or coupled to an ultrasonic seam 110 of the PCM storage unit or plate 1100 so that the thermocouple 1300TC resides inside of the PCM storage area 108 and is in contact with the PCM thermal media 112 located with the PCM storage area 108. These thermocouples 1300TC may be embedded in a configuration as shown in FIGS. 13O-13P or can be embedded in any position along the weld seam as well. The orientation of the thermocouples may be adjusted depending on the air flow path in PCM storage box to address the directionality of temperature measurement. FIG. 13O is a plan view and FIG. 13P is a side, sectional view of a PCM storage unit or plate 1100 having a plurality of thermocouples 1300TC located within the PCM storage area 108 and in contact with PCM media 112 located within the PCM storage area 108. FIGS. 130 and 13P show the different potential placement locations of thermocouples 1300TC in a PCM panel 1100 in order to monitor the temperature of the PCM material 112 for system monitoring. Thermocouples 1300TC can be placed as shown or can be placed in configurations not shown. According to some embodiments, thermocouples 1300TC can be embedded directly into a panel 1100 with ultrasonic welding while creating an airtight seal in the panel 1100. According to some embodiments, monitoring temperature is an important part of deploying PCM technology effectively and creating/deploying a more effective thaw logic. According to some embodiments, a thermocouple 1300TC is positioned and sealed within the PCM storage area 108 such that the PCM 112 also located within the PCM storage area 108 cannot leak or seep out of the PCM storage unit or plate 1100. According to some embodiments, a thermocouple 1300TC is embedded into or coupled to an ultrasonic seam 110 of a PCM storage unit or plate 1100 and thereby held fixedly in place to or within the PCM storage unit or plate 1100 and/or within the PCM storage area 108, and according to some such embodiments, failure of containment of the PCM by the PCM storage unit or plate 1100 is reduced relative to a less permanent installation of a thermocouple within the PCM storage area 108. A benefit of an embedded thermocouple 1300TC within the PCM plate is that actual real-time temperature monitoring of the PCM thermal storage material can be accomplished such as via a controller communicatively coupled to the thermocouple(s), as opposed to using an approximation, estimate or proxy for determining PCM temperature according to some embodiments. The ability to accurately determine the temperature of the PCM media 112 such as via a controller communicatively coupled to the thermocouple(s) 1300TC allows for more precise energy storage calculations, helpful to optimizing the thermal storage capabilities of the system such as via the controller.

According to some embodiments, a PCM storage unit or plate 1100 may possess one or more stiffening ribs and/or surface texturing on one or both sides of the PCM storage unit or plate 1100 that increase the usability of the PCM plate, such as by increasing the rigidity of the panel, reducing the bowing of the PCM storage unit or plate 1100 under loading of fluidic PCM media inside of the PCM storage unit or plate 1100, and/or by increasing the resistance of the PCM storage unit or plate 1100 to torsional flexing and/or bending and/or by increasing the overall stiffness of the PCM storage unit or plate 1100 such as those made of metal or a metal alloy which enable a thinner and lighter metal thickness (ranging, for example, from about 0.010 to about 0.035 inches (about 0.2 mm to about 0.9 mm) to be used to form the metal package. See, e.g., FIGS. 10A-10L. According to some embodiments, the stiffening ribs and surface texturing can be formed or stamped into one or more of the metal sides 104, 106 and may be positioned to align with the air flow direction or may be perpendicular to the air flow direction of air passing over a PCM storage unit or plate 1100. According to some embodiments, ribs and surface texturing also increase the exposed surface area of a PCM storage unit or plate 1100 which increases or facilitates heat transfer between the fluid air flow and the PCM 112 located with the PCM storage unit or plate 1100. See, e.g., FIGS. 10A-10L.

According to some embodiments, a PCM storage unit or plate 1100 can be installed anywhere in a building or HVAC system where thermal energy management is desirable. According to some embodiments, the PCM storage units or plates 1100 can be installed as part of a building thermal management strategy to reduce energy consumption and can be installed wherever flexible PCM mats may be installed: above ceiling tiles, either directly placed or installed above tiles using a rack or grid support system, to the inside of or outside of or within walls, roofs, floors and/or demising and partition walls.

According to some embodiments, PCM storage units or plates 1100 can be used individually or in combination of multiple plates which are exposed to the flow of the heat transfer fluid, whether installed as exposed plates or installed in a box or enclosure consisting of multiple plates, where plates in the enclosure are exposed to the flow of the heat transfer fluid, including air.

The PCM storage units or plates 1100 can also be installed within boxes or containers or assemblies of concentrated PCM products, which design acts as a thermal energy storage system or thermal battery, and may be installed in the supply and/or return air ducts of an HVAC system, and/or used wherever a thermal energy storage system is desired in an application where thermal transfer fluid, including air, can pass by the plates 1100 such as through a box of PCM plates. The boxes or enclosures, e.g., boxes 1160, can be single unit construction or can be modular where more than one box filled with PCM plates is installed adjacent to and connected to another box filled with PCM plates, and so on, to increase the amount of PCM plates and thermal storage available to the HVAC system. See, e.g., FIGS. 13L-13N.

According to some embodiments, the PCM storage units or plates 1100 can be installed in boxes or enclosures which are installed in the supply air ducting, between the air handling unit (AHU) and compressor system but before the supply grills, which occur at the end of the supply air ducting.

According to some embodiments, the PCM storage units or plates 1100 can be installed directly into the supply air or return air ducting with or without a box or enclosure. The PCM storage units or plates 1100 can be installed adjacent to or perpendicular to the ducting or can be installed integral to the duct material itself, where the ducting is comprised of a combination of PCM plates surrounded by supporting mesh and insulation to act as a PCM enhanced duct. The PCM storage units may be integrated with a rack mounting system to integrate into existing ductwork. See, e.g., FIGS. 13A-13B.

In some installations, the PCM plates 1100 can be installed directly into the air handling unit supply plenum which serves to direct the supply air from the HVAC unit to the supply ducts. In such cases, the PCM panels 1100 may be pre-installed in the sheet metal supply plenums. See, e.g., FIGS. 13H and 13J.

According to some embodiments, the PCM storage units or plates 1100 can be installed in an active or controlled system air flow emanating from the AHU or from outside, ambient air, whether induced passively or by use of a powered vent or economizer, whether such installation is made of individual and exposed PCM storage units or plates 1100 or whether the installation is comprised of a box or enclosure of multiple PCM storage units or plates 1100 contained within.

According to some embodiments, the PCM boxes or enclosures filled with PCM storage units or plates 1100 are installed in the supply ducting between the AHU and the duct terminus. According to some embodiments, a system for thermal energy storage and management in an HVAC system comprises PCM storage units or plates 1100, contained in a box or enclosure, and an HVAC controller or smart thermostat. According to some embodiments, the HVAC controller utilizes algorithms and/or logic that actively charges and discharges the PCM storage units or plates 1100 (forces phase transition from liquid to solid or solid to liquid of PCM 112 within the PCM storage units or plates 1100) such as according to a schedule and/or in a manner that reduces building energy consumption and/or reduces peak demand during utility defined peak demand periods. According to some embodiments, energy consumption is reduced and/or energy load is shifted to nighttime use or off-peak periods when the HVAC system is combined with use of an economizer mounted to the HVAC system. According to some embodiments, use of outside ambient air, when sufficiently cold enough to discharge the melted PCM, which is introduced into the HVAC system, can result in significant energy savings, as the PCM is made frozen or partially frozen using free, outside cool air, as opposed to mechanically air-conditioned air. According to some embodiments, logic and/or algorithms that control PCM storage unit or plate 1100 phase transitions, when combined with or integrated within an HVAC controller or smart thermostat, facilitates the PCM storage units or plates 1100 ability to act as a system, integral with the HVAC system, to increase efficiency, reduce demand, shift consumption from peak to off-peak periods, optimize energy load management and/or reduce costs of operations. According to some embodiments, logic or control algorithms that control PCM phase transitions are programmed into the controllers and include compressor run-time limiting features, that shorten the duty-cycle or run-time of the air conditioning compressor, so that the total amount of compressor run-time is reduced according to the logic.

According to some embodiments, an HVAC controller acts as an automated building management system in addition to managing HVAC functions. According to some embodiments, the HVAC controller can also monitor and manage lighting, fire sprinkler systems and alarms. According to some embodiments, the HVAC controller may be in direct and constant communication such as via cellular modem to cloud-based data storage and access portal functions. According to some embodiments, the HVAC controller may act wirelessly with its own IP address.

According to some embodiments, the HVAC controller or smart thermostat utilizes algorithms and/or logic to charge and discharge the PCM 112 within the PCM storage units or plates 1100 and is designed to optimize the latent energy stored in and the latent energy released by the PCM storage units or plates 1100, so as to more or most efficiently reduce use and/or cost for energy consumption and/or reduce peak demand use during specific periods of operations, whether such periods are daily, weekly, monthly, seasonal or annually defined. According to some embodiments, the HVAC controller or smart thermostat monitors the temperature of the outdoor air and within the HVAC system; monitors the temperature of the supply air, return air, and/or mixed air temperature, whether in heating or cooling mode; and/or monitors the temperature of a conditioned room at the location of the thermostat, and also monitors the energy pulses and/or amperage of the fan and/or compressor.

According to some embodiments, the algorithms and/or logic to utilize PCM thermal storage in combination with conventional HVAC operations can be de-coupled from the HVAC controller and installed directly on another third party platform or building management or controller system or smart thermostat.

According to some embodiments, a controller such as an HVAC controller employs the algorithms and/or logic described herein to monitor the temperature of the PCM, measured within the PCM plate(s) such as via thermocouples communicatively coupled to, e.g., an HVAC controller, and use the temperature(s) to monitor the rate of solidification or liquification and calculate the amount of stored latent energy during phase transitions. According to some embodiments, a controller employing logic and/or algorithms also monitors the rate of change in melting or freezing of the PCM media 112. Additionally, according to some embodiments, a controller such as an HVAC controller communicatively coupled to a compressor and/or heat pump and/or heater such as a gas heater employs the algorithms and/or logic employing a compressor limiting function to limit the maximum run time of the HVAC compressor, when in cooling mode, or limit the maximum run time of the heat pump or gas heater when in heating mode, so as to optimize run times to as little as necessary to maintain occupant room temperature setpoints, while using the thermal storage capacity of the PCM storage units or plates 1100 to manage supply air temperatures. According to some embodiments, a controller using, e.g., algorithms and/or logic, may also limit and manage the compressor run time during peak demand periods, which are time periods during the day when a utility company assesses demand-related charges, based upon the maximum demand recorded in a given time period, e.g., in any 15-minute period, or other utility-company defined period, during the peak demand period, in addition to data reflective of costs incurred for energy consumed at peak energy consumption rates. According to some embodiments, the operation of the controller using e.g., algorithms and/or logic, can be tailored or adjusted to manage any peak demand period, not just the most commonly used 15-minute period. According to some embodiments, a controller using, e.g., algorithms and/or logic. may also be configured to manage multiple HVAC units, to optimize the operations of more than one HVAC unit for the minimum combined demand from multiple HVAC units use in any given time period, e.g., any given 15-minute period. According to some embodiments, benefits from algorithms and/or logic combined with an HVAC controller or certain smart thermostats can yield more than 30% peak demand reduction and/or shift more than 30% of peak period energy use to off-peak periods, resulting in lower energy costs and/or a reduction in greenhouse gas emissions, and in some cases lower energy consumption.

According to some embodiments, the PCM plate box 1160 may be paired with a controller that uses time-based compressor delays or compressor run-time restrictions, to limit energy usage during a utility provider's peak usage periods. The controller may limit HVAC compressor usage on a time delay during utility defined interval periods which may be either 15 minutes or another predefined time depending on the utility company. The controller may be monitoring temperatures in the PCM plate box 1160 or PCM plates 1100 to determine state of charge in the thermal storage. The controller may also be monitoring supply and/or return and/or ambient temperatures for monitoring compressor usage and runtimes as well as health status of the HVAC unit. The controller may be coupled to the HVAC unit in a way that controls compressor and/or heat pump and/or gas heater and/or fan and/or economizer functionality. The controller may use a power meter to monitor the energy consumption and demand in any given time.

The controller may assess when to deploy time-based compressor delays for demand reduction during peak periods. The controller may utilize monitored PCM 112 or HVAC temperatures to determine time of delay for the compressor to optimally deploy thermal energy/latent storage and maintain room temperatures. The controller may also look at temperature differences at the inlet and outlet of the PCM plate box to determine state of charge in the box 1160. The temperature rate of change between the inlet and outlet of the box may also be used to measure the rate of phase change in the PCM. The state of charge of the thermal storage system 1160 can be used to determine optimal deployment of the stored thermal energy and to extend duration of system operations during peak demand periods. The state of charge determination can also be used to determine if additional charging of the system is required to improve performance during peak period operations. The state of charge can also be used to determine the rate of thermal storage depletion during peak demand periods, resulting in increased duration of system operations during peak demand periods or in some cases a faster rate of thermal storage if desired, which results in an increased reduction of demand measured during peak demand periods, albeit for a shorter period of time duration. The controller may be configured to utilize non-peak power rates to optimize thermal energy storage charge and deployment. In some cases, the ambient temperature may be used to determine the specific algorithms that will be used for assessing time-based compressor delays needed.

The controller may also deploy time-based compressor delays in the absence of PCM thermal storage. These time-based compressor delays may be deployed during utility provider's peak usage periods to reduce demand, kW, with diminished performance in comparison with PCM thermal storage systems, but resulting in a reduction of peak demand recorded during the peak demand periods.

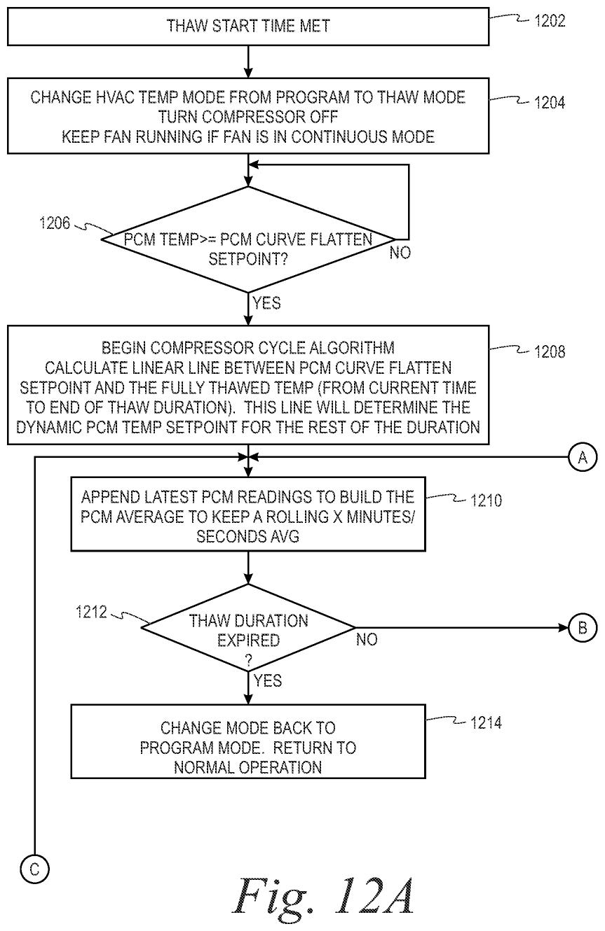

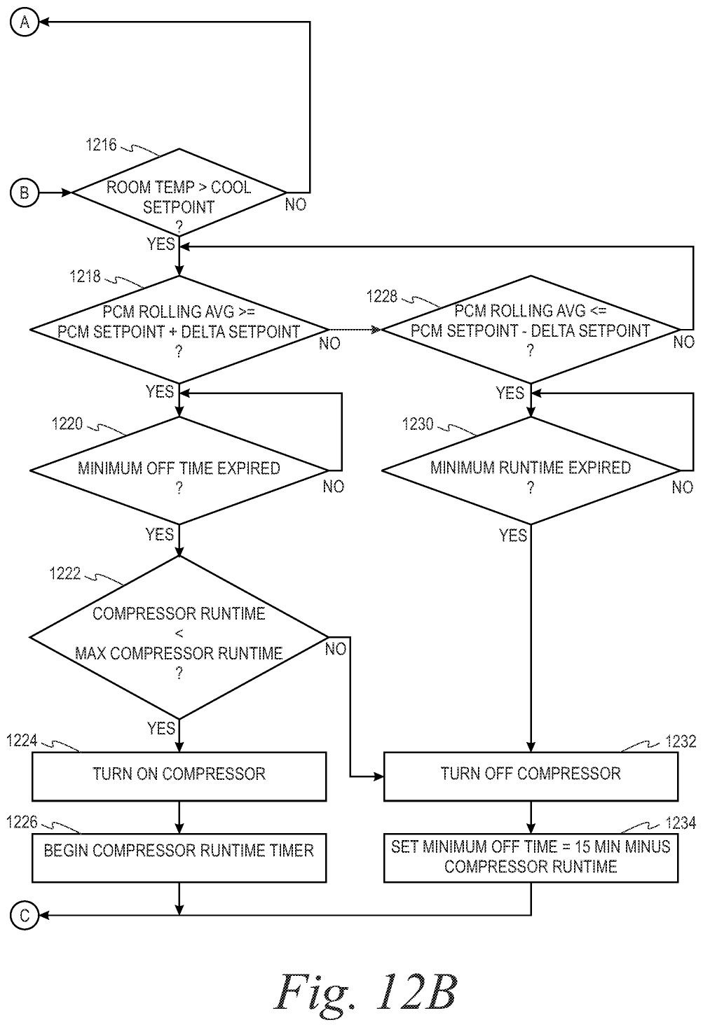

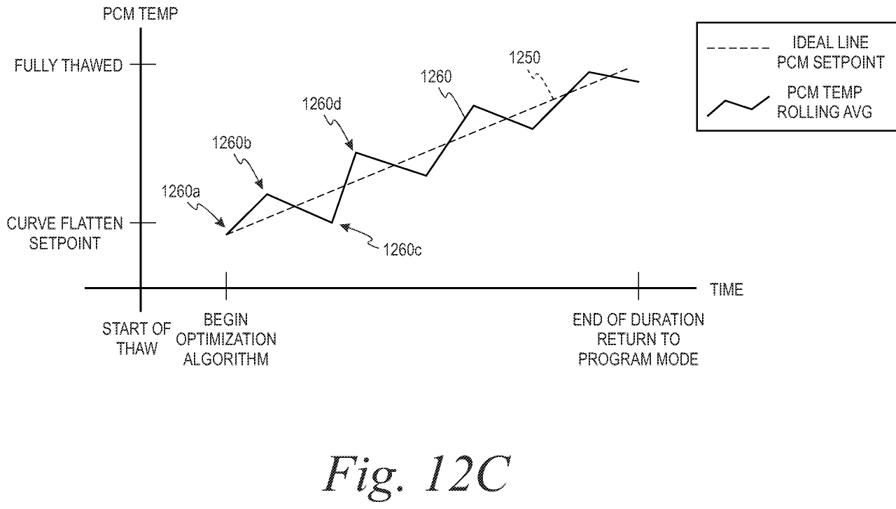

FIGS. 12A and 12B are a flowchart of illustrating a method of controlling an HVAC system utilizing PCM storage units or plates 1100 thermal storage integrated into the HVAC system according to some embodiments.

FIG. 12C is a graph illustrating a rolling average temperature 1260 of PCM 112 utilized in an HVAC system comprising a controller containing algorithms and/or logic to monitor PCM temperature such as during peak demand period(s) when the compressor run times are limited according to some embodiments. According to some embodiments, the controller is communicatively coupled to a compressor and controls the operation of the compressor. Cycling the compressor on and off, while maintaining acceptable factory specified compressor run times, so as not to damage the HVAC unit, produce a jigsaw temperature profile where the PCM temperature is lowered during compressor operation and rises during compressor limiting. The ideal PCM setpoint line 1250 is demonstrative of the algorithms and/or logic to normalize the rate of PCM temperature increase by performing a rolling average of the PCM temperature.

With reference to FIGS. 12A and 12B, at step 1202, it is determined a thaw start time is met. According to some embodiments, the HVAC controller has a plurality of operating modes comprising a program mode and a thaw mode. Once it is determined the thaw start time has been met at step 1202, at step 1204 the operating mode of the HVAC controller is changed from PROGRAM mode to THAW mode and the controller generates an instruction to cause a compressor of the HVAC system to turn off. According to some embodiments, the HVAC system comprises a fan and the HVAC controller has at least one FAN mode, namely, a continuous mode. If the FAN mode has been set to the continuous mode, the FAN mode is left unchanged in the continuous mode.

Then at step 1206, the controller determines if the temperature of the PCM in one or more PCM storage units or plates 1100 (or any average temperature of a plurality of plates 1100) is greater than or equal to a PCM Curve Flatten Setpoint. The PCM Curve Flatten Setpoint is the temperature at the start of PCM phase transition. If the answer at step 1206 is NO, the program loops backs to step 1206 to continue to monitor the temperature of the PCM in one or more PCM storage units or plates 1100 until the answer becomes YES.

When the answer at step 1206 is YES, at step 1208 a Begin Compressor Cycle Algorithm is executed in which a liner line between the PCM Curve Flatten Setpoint and the Fully Thawed Temp (from the current time to the end of the Thaw Duration) is calculated. The PCM Curve Flatten Setpoint is the temperature at the start of the PCM phase transition, where the material transitions from solid state to liquid state or liquid state to solid state. The thermal energy stored during this transition is termed latent heat, as opposed to sensible heat. The Fully Thawed Temp is the temperature when the PCM is fully transitioned from solid to liquid state, and thermal storage is no longer latent storage but sensible storage. According to some embodiments, the calculated line determines the dynamic PCM Temperature Setpoint for the remainder of a given duration. This process allows a controller to adjust the compressor run times and operations relative to a rolling average of PCM temperature as opposed to instantaneous temperature readings, which do not reflect the actual thermal storage state of the PCM inside the PCM plates. The PCM temperature, as instantaneously measured, will vary according to use of compressor. When the compressor is running and producing chilled air, the PCM temperature will fall, and when the compressor is limited or off, the PCM temperature will rise. A controller or an algorithm employed by a controller smooths the PCM curve to a linear relationship.

At step 1210, the latest temperature of the PCM in one or more PCM storage units or plates 1100 is used update a PCM Average Temperature which reflects a rolling average temperature of the one or more PCM storage units or plates 1100 over a certain time frame, e.g., 15 minutes or 900 seconds.

At step 1212, it is determined whether the Thaw Duration has expired. If so, at step 1214, the controller changes the operating mode of the HVAC controller from THAW mode to PROGRAM mode and returns the HVAC controller to it normal operation. PCM Thaw mode is the period designated by the controller that the PCM thermal storage system will be active and compressor limiting algorithms and logic are employed. PCM Thaw mode is the period of controller operations where the HVAC controller leaves normal HVAC programming logic and deploys algorithms and/or logic specifically designed to deploy PCM thermal storage and limit compressor run times.

If at step 1212 it is determined the Thaw Duration has not expired, the process moves to step 1216 and it is determined if the Room Temperature (as determined by a thermostat communicatively coupled to the HVAC system and the HVAC controller) is greater than a Cool Setpoint. The Cool Setpoint is the allowable room temperature allowed during the PCM Thaw period. If the answer is NO, the process loops back to step 1210.

If the answer at step 1216 is YES, the process moves to step 1218 where it is determined if the PCM Average Temperature is greater than or equal to the PCM Setpoint plus a Delta Setpoint. If the answer at step 1218 is YES, at step 1220 it is determined whether a minimum compressor OFF time has expired. Compressor minimum off times may be dictated by the HVAC manufacturer to prevent improper cycling of the compressor unit where insufficient off time can cause damage to the unit. The process loops backs to step 1220 until the answer is YES. When the answer at step 1220 becomes YES, the process moves to step 1222 where it is determined if the compressor run time is less than a Maximum Compressor runtime value. The Maximum Compressor Run Time may be a user definable maximum time that the compressor can operate during any 15-minute period during a peak demand period. If the answer at step 1222 is YES, the controller generates a signal to turn the compressor on at step 1224 and a Compressor Runtime Timer is restarted at step 1226 and the process loops back to step 1210.

If the answer at step 1222 is NO, the controller generates a signal to turn the compressor off at step 1232 and a Minimum Compressor OFF timer is set to a certain fixed time period, such as 15 minutes, less the current value of the Compressor Runtime Timer and the process loops back to step 1210.

If the answer at step 1218 is NO, at step 1228, it is determined if the PCM Average Temperature is less than or equal to the PCM Setpoint less the Delta Setpoint value. If the answer at step 1228 is NO, the process loops back to step 1218.

If the answer at step 1228 is YES, at step 1230, it is determined if a Minimum Runtime has expired. If the answer at step 1230 is NO, the process loops back to step 1230.

If the answer at step 1230 is YES, the controller generates a signal to turn the compressor off at step 1232 and a Minimum Compressor OFF timer is set to a certain fixed time period, such as 15 minutes, less the current value of the Compressor Runtime Timer and the process loops back to step 1210.

A similar arrangement may be used when an HVAC system is employed to heat a space. For example, a heater comes on in the morning when it is cold and melts the PCM and the melted PCM is then used to warm the space during the day.

According to some embodiments, the HVAC controller or smart thermostat can perform a daily, weekly, monthly, seasonal and/or annual temperature and run-time schedule without regard to weather changes, where the PCM Thaw operations are dependent upon preset and user-defined inputs like time of day and seasonality of rate schedule changes, or it can be adaptive and sensitive to predicted weather patterns and alter temperature and run-time schedules to moderate the charging and discharging of the latent energy contained within the PCM plates, by using weather predictions, e.g., cloud-based weather predictions, to alter daily operations strategies to optimize HVAC system performance. By using forecasted weather, a controller may employ logic to adjust the amount of pre-cooling or discharging of the PCM plates, using conditioned or ambient air, and then adjust the minimum run times and frequency of the run times of the compressor during peak demand periods to reduce energy consumption and peak demand, such as by using linear regression models to optimize pre-cooling and PCM-thaw behavior. An example of this logic is when the forecasted temperatures for the next day are greater than the temperature recorded today, and the controller algorithms recognize that more thermal storage will be required to meet the anticipated temperature response. The controller responds by enforcing an extended pre-cool period during the end of the off-peak period to ensure that the PCM thermal storage material is fully solidified and at the same time reduce the temperature in the occupied space by a calculated amount, for example 2° F. (1° C.), so that the maximum payload of thermal storage can be delivered and the occupied space if pre-cooled to be more resistive to heat gains during PCM Thaw. Alternatively, if a weather prediction, e.g., via a cloud-based weather prediction, for next day is for lower temperatures than measured today, then the controller, e.g., via algorithms and/or logic, can shorten the pre-cool period and reduce the minimum compressor run times as the thermal load will be less and therefore less thermal storage is required during PCM Thaw.

Advanced techniques to optimize controller and smart thermostat performance during PCM Thaw operations include artificial intelligence in the logic and using machine learning algorithms to make the logic more adaptive and responsive to changing weather patterns.

Alternate algorithms and logic can be used to operate the PCM thermal storage system in similar manner. In these cases, modifications to the controller algorithms and/or logic are made to enhance and optimize performance of the thermal storage system. Reasons for using alternate algorithms and/or logic include optimizing peak demand reduction and shifting of energy consumption to off-peak periods in certain buildings with unique internal thermal loads. Buildings have dynamic thermal variables and according to some embodiments, it is advantageous to have additional, alternate algorithms and/or logic to optimize thermal storage performance.

Alternate algorithm and strategy 1 may be used for scenarios where the combined internal thermal loads and outdoor ambient loads are relatively stable and consistent according to some embodiments.

### Strategy 1

Between 00:00 and 06:00 T_{cool} is set to 35° C. (95° F.) and Tₕₑₐₜ is set to 10° C. (50° F.). The fan is set to auto.
At 06:00 T_{cool} is set to 23.3° C. (74° F.). Tₕₑₐₜ remains at 10° C. The fan is set to continuous.
At 15:30 the compressor is activated until T_{pcm} reaches 11° C. (52° F.). The compressor is not activated if the aggregate compressor runtime between 12:00 and 15:00 was less than 5 minutes.
At 16:00 the compressor is deactivated. It remains deactivated until Tᵣₒₒₘ reaches 24.4° C. (76° F.) at which point it can activate for at most 3 minutes out of every 15 minutes. If Tᵣₒₒₘ passes 25.6° C. (78° F.), then the compressor can be activated for at most 5 minutes out of every 15 minutes. In all cases, the compressor is activated based on room temperature. If room temperature falls back under 25.6° C. (78° F.), the compressor would return to running 3 minute intervals. If the room temperature falls back under 24.4° C. (76° F.), the compressor would deactivate. NOTE: the above describes a 2-tiered strategy (setpoint 1 initiates 3-minute runtimes, setpoint 2 initiated 5-minute runtimes). According to some embodiments, additional tiers may be employed.
At 18:00 T_{cool} is set to 35° C. (95° F.) and the fan is set to auto.

Alternate algorithm and logic strategy 2 is another sequence of commands and operations for use in buildings that may have variable internal or ambient loads or otherwise do not perform as optimally as expected with the base algorithms and logic according to some embodiments.

### Strategy 2

Between 00:00 and 06:00, T_{cool} is set to 35° C. (95° F.) and Tₕₑₐₜ is set to 10° C. (50° F.). The fan is set to auto.
At 06:00 T_{cool} is set to 23.3° C. (74° F.). Tₕₑₐₜ remains at 10° C. (50° F.). The fan is set to continuous.
At 15:00 the controller determines the allowable number of 3-min compressor runtimes that will be deployed between 16:00 and 18:00 based on the following algorithm:

nRuns=0.08333*aggRun12to15−5.
where aggRun12to15 is the aggregate compressor runtime between 12:00 and 15:00 in minutes.
At 15:30, T_{cool} is set to 22.8° C. (73° F.).
At 16:00, 3-minute compressor runtimes are deployed once every 15 minutes until the allowable number of runs has been exhausted. If Tᵣₒₒₘ exceeds 24.4° C. (76° F.) (T_{allow}), then the controller determines how far into the thaw period it is and computes an additional allowed run time as a percentage of the original allowed run time as follows:
If T_{allow} is exceeded within the first ¼ of the demand window (i.e., by 16:30), allow an additional 66% of the original allowable compressor runtime.
If T_{allow} is exceeded within the second ¼ of the window, allow an additional 33% of the original allowable compressor runtime.
If T_{allow} is exceeded within the third ¼ of the window, allow an additional 16% of the original allowable compressor runtime.
If T_{allow} is exceeded within the final ¼ of the window, allow an additional 8% of the original allowable compressor runtime.
The newly allowable time is allotted in 3-minute periods, one per 15-minute interval from the next available period out to the final period (which begins at 17:45) or until no more 3-minute periods are available. Once all remaining periods have been allotted a 3-minute run then any remaining time is divided equally among the remaining periods. Note that the compressor will always run for at least 3 minutes.
Ex1: the compressor ran for a total of 1.5 h between 12:00 and 15:00. Therefore 3 3-minute runtimes (9 run-minutes total) are allowed. At 16:32 room temperature goes over the allowable limit. The time is 26% of the way through the thaw period so the controller will allow an additional 33% of the original run time: one additional 3-minute run time, which the controller deploys in the next available time slot (16:45).
Ex2: the compressor ran for a total of 2.3 h between 12:00 and 15:00. Therefore 7 3-minute runtimes (21 run-minutes total) are allowed. At 16:25 room temperature goes over the allowable limit. The time is less than 25% of the way through the thaw period so the controller will allow an additional 66% of the original run time: five additional 3-minute run times. The only slot that does not have a 3-minute runtime already is the last one so the controller gives it one, leaving 12 more run-minutes to allocate. The time is in the second slot presently so the controller divides the 12 run-minutes equally between slots 3 and 8, adding 2 to each. The controller will run the compressor for 5 minutes of every 15 minutes between 16:30 and 18:00.
At 18:00 T_{cool} is set to 35° C. (95° F.) and the fan is set to auto.

### Automated Ultrasonic Seam Welder for Advanced Manufacturing

According to some embodiments, the present disclosure relates to an ultrasonic welder and method for using the same. For example, according to some embodiments, the present disclosure relates to the use of high-power ultrasound combined with advanced tooling designs and state of the art sensors for the creation of an automated device and method producing continuous ultrasonic seam welds within metal alloys having real-time process feedback and control.

Ultrasonic welding is an industrial process involving high-frequency ultrasonic vibrations that are locally applied to workpieces held together under pressure to create a solid-state weld. Ultrasonic welding has applications in the electrical/electronic, automotive, aerospace, appliance, and medical industries and is commonly used for plastics and especially for joining dissimilar materials. Ultrasonic welding of thermoplastics results in local melting of the plastic due to absorption of vibration energy. The vibrations are introduced across the joint to be welded. In metals, according to some embodiments, ultrasonic welding occurs from high-pressure dispersion of surface oxides and local motion of the materials. Although there is heating, it is not enough to melt the base materials, according to some embodiments. Vibrations are introduced along the joint being welded.

FIG. 14A is a first end perspective view and FIG. 14B is a second end perspective view of an ultrasonic welder 1400 according to some embodiments. FIG. 14C is a side view, FIG. 14D is a side cross-sectional view, FIG. 14E is a first or front end view, and FIG. 14F is a cross-sectional first end view of the ultrasonic welder 1400 of FIG. 14A.

According to some embodiments, the welder 1400 comprises a converter or piezoelectric transducer 1402, a motor 1404, a booster 1420, a sonotrode or horn 1430, and a nest or anvil 1440. The booster 1420 is housed within a transmission line housing 1421. The transducer 1402, motor 1404, booster 1420, sonotrode 1430, anvil 1440, and transmission line housing 1421 are coupled to a welder housing or enclosure case 1401. According to some embodiments, an ultrasonic stack or transmission line comprises the transducer 1402, the booster 1420, and the sonotrode 1430 and these components are rotationally coupled to the transmission line housing 1421 about longitudinal rotational axis 14a (see FIG. 14D). The motor 1404 is configured to rotational drive the stack about the longitudinal rotational axis 14a such as via a motor gear 1476 which engages and drives a stack or first gear 1776. As illustrated in FIG. 15A, the sonotrode 1430 comprises a welding tip or tool 1432.

According to some embodiments, the transducer 1402 is a high-power ultrasonic transducer capable of operating between 100 and 6,000 Watts at frequencies between 10 and 60 kHz.

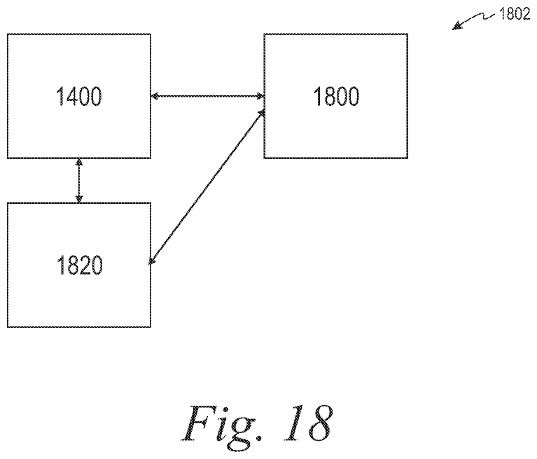

FIG. 18 is a schematic drawing illustrating a welding system 1802 comprising the welder 1400 communicatively coupled to a controller 1800 and electrically coupled to an electronic ultrasonic generator or power supply 1820 according to some embodiments of the present disclosure. According to some embodiments, the power supply 1820 delivers a high-power AC signal having a frequency matching the resonance frequency of the stack of welder 1400 and is communicatively coupled to the controller 1800. According to some embodiments, the controller 1800 generates one or more signals to control the operation of the piezoelectric transducer 1402 for the delivery of the ultrasonic energy, the motor 1404, the power supply 1820, and/or the movement of the press such as by controlling pneumatic valve for controlling the opening/closing of the press such as controlling the welder actuation such as a pneumatic, hydraulic, or electro-mechanical actuation device for applying moderate clamping forces between the targeted materials during the dynamic welding process.

Ultrasonic welding systems typically include the following components: (i) a press to apply pressure to the two parts to be assembled under pressure; (ii) a nest or anvil where the parts are placed for allowing high frequency vibration to be directed to the interfaces of the parts; (iii) an ultrasonic stack or transmission line that includes a converter or piezoelectric transducer for converting the electrical signal into a mechanical vibration, an optional booster for modifying the amplitude of the vibration (it is also used in standard systems to clamp the stack in the press), and a sonotrode or horn for applying the mechanical vibration to the parts to be welded (note: all three components of the stack are specifically tuned to resonate at the same exact ultrasonic frequency which is typically 20, 30, 35 or 40 kHz); (iv) an electronic ultrasonic generator or power supply delivering a high power AC signal with frequency matching the resonance frequency of the stack; and (v) a controller for controlling the movement of the press and the delivery of the ultrasonic energy. According to some embodiments of the present disclosure an ultrasonic welding system is provided with these components (i)-(v) that utilizes the welder 1400 described herein.

In an exemplary system, a power supply such as power supply 1820 provides high-frequency electrical power to the piezoelectric-based transducer 1402, creating a high-frequency mechanical vibration at the end of the transducer 1402. This vibration is transmitted through the booster section 1420, which may be designed to amplify the vibration, and is then transmitted to the sonotrode 1430, which transmits the vibrations to the workpieces. The workpieces, usually two thin sheets of metal in a simple lap joint, are firmly clamped between the sonotrode 1430 and the anvil 1440. The top workpiece is gripped against the moving sonotrode 1430 by a knurled pattern on the sonotrode surface. Likewise, the bottom workpiece is gripped against the anvil 1440 by a knurled pattern on the anvil 1440. The ultrasonic vibrations of the sonotrode 1430, which are parallel to the workpiece surfaces, create the relative friction-like motion between the interface of the workpieces, causing the deformation, shearing, and flattening of surface asperities. Welding system components, commonly referred to as a transmission line or “stack” are typically housed in an enclosure case 1401 that grips the welding assembly at critical locations (most commonly the node or nodal point) so as to not dampen the ultrasonic vibrations, and to provide a means of applying a force to the materials interface by bringing the sonotrode 1430 into contact with the workpieces and applying the static force, prior to going into resonance.

Prior welders employed a rigid anvil and employ a static force to firmly clamp workpieces to be welded together. According to some embodiments, the anvil 1440 of the present disclosure is freewheeling and is rotationally coupled to the welder housing or enclosure case 1401 such that the anvil 1440 is permitted to rotate about an anvil rotational axis 1440a that is parallel to the longitudinal rotational axis 14a about which the sonotrode 1430 rotates. When workpieces to be welded together are positioned between the sonotrode 1430 and anvil 1440, the sonotrode 1430 is biased toward the anvil 1440 by a strong force. As the sonotrode 1430 is rotationally driven, the workpieces pinched between the sonotrode 1430 and anvil 1440 are moved in direction generally perpendicular to the longitudinal rotational axis 14a such as in the negative x-direction illustrated in FIG. 14A. The motion in the negative x-direction of the workpiece that is pressed against the anvil 1440 may cause the anvil 1440 two rotate about the anvil rotational axis 1440a such as by frictional engagement between the workpiece that is pressed against the anvil 1440 and the anvil 1440.

A number of parameters can affect the welding process, such as ultrasonic frequency, vibration amplitude, static force, power, energy, time, materials, part geometry, and tooling. With regard to tooling, which includes the sonotrode 1430, the welding tip 1432, and the anvil 1440, these components support the parts to be welded and transmit ultrasonic energy and static force. The welding tip 1432 is usually machined as an integral part of a solid sonotrode 1430. The sonotrode 1430 is exposed to ultrasonic vibration and resonates in frequency as “contraction” and “expansion” x times per second, with x being the frequency. The amplitude is typically a few micrometers (about 3 to 130 μm). The shape of the sonotrode (round, square, with teeth, profiled, etc.), depends on the quantity of vibratory energy and a physical constraint for a specific application. According to various embodiments, sonotrode 1430 may be made of titanium, aluminum or steel including alloys of aluminum or titanium. For an ultrasonic welding application, the sonotrode 1430 provides energy directly to the welding contact area, with little diffraction. This is particularly helpful when wave propagation could damage surrounding components.

According to some embodiments, the ultrasonic welder 1400 described herein has unique advancements that make it a “first of its kind” including the increased power of the welder 1400 and the ability to ultrasonically weld greater thicknesses of metal or metal alloys and the ability to produce longer continuous welds.

According to some embodiments, high power ultrasonic seam welding is provided that foundationally expands on ultrasonic metal welding whereby the resident transmission line is rotated in a continuous manner for producing welds of significant length. Due to physics-based limitations of stress generation, uniform amplitude distribution, mode coupling, and capable power, conventional spot-welding applications are typically limited to weld widths less than six inches. According to some embodiments, ultrasonic seam welding, however, can be attained through the employment of a cylindrical sonotrode 1430 traversing along a seam of two target materials for producing a solid-state weld at lengths from a fraction of an inch or cm to hundreds of continuous feet or meters. The present disclosure identifies multiple ultrasonic design features combined with advanced feedback mechanisms for improving an automated welding device that, according to some embodiments, is employed for the encapsulation of goods.

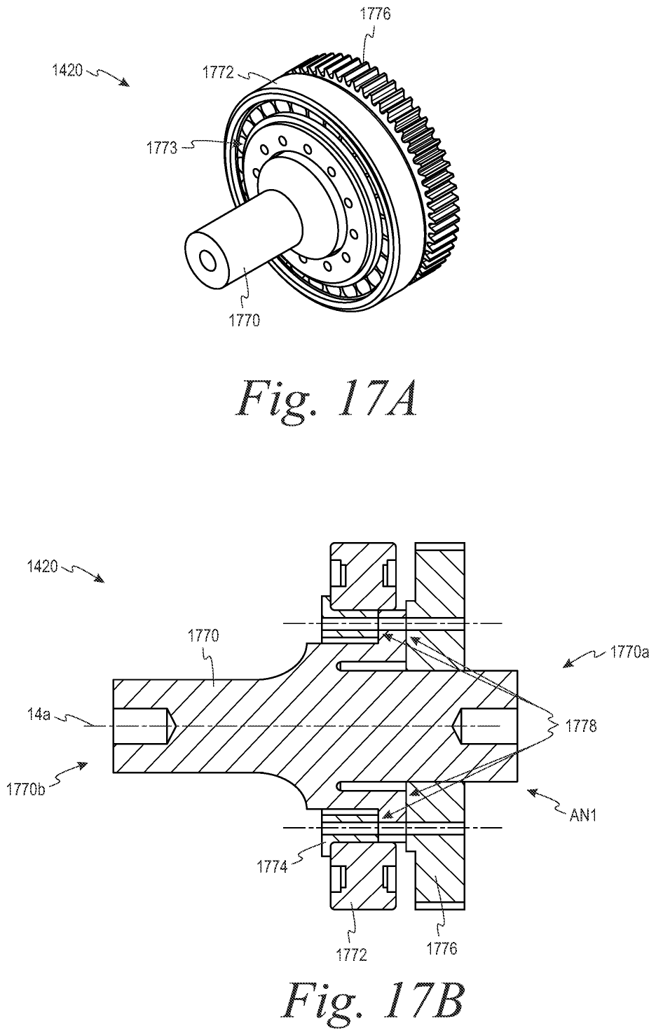

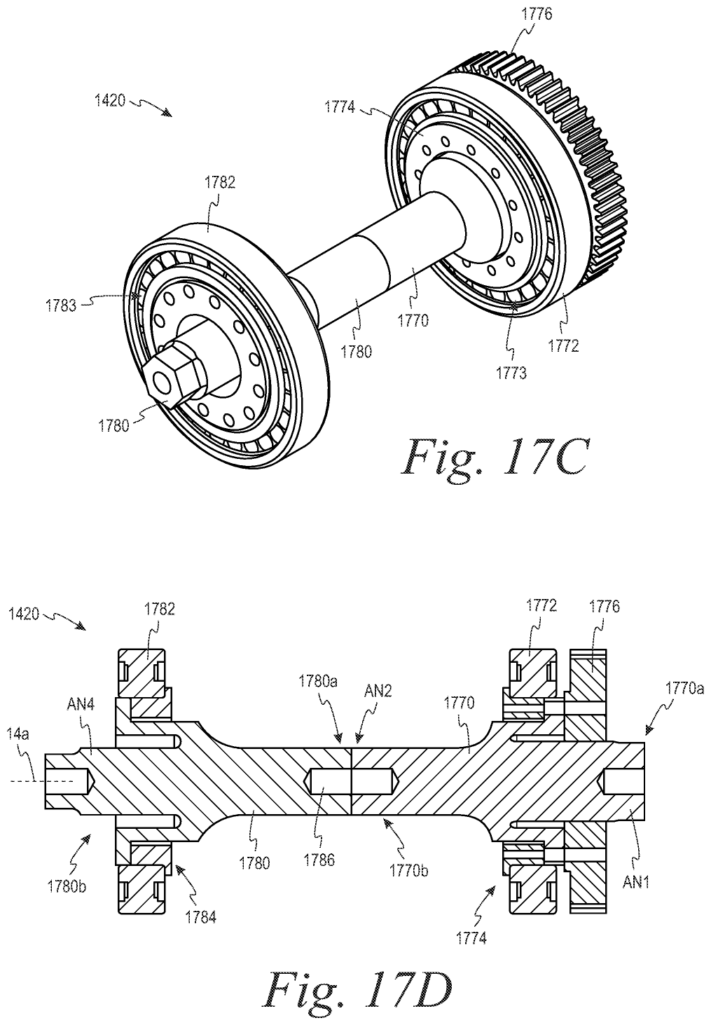

FIG. 17A is a perspective view and FIG. 17B is a longitudinal cross-section view of a booster 1420 comprising a single half-wave vibration isolation booster 1770 according to some embodiments of the present disclosure. According to some embodiments, booster 1420 comprises a first vibration isolation booster 1770 wherein the first booster 1770 is positioned about a longitudinal rotational axis 14a. The first booster 1770 is mounted within a first heavy-duty roller bearing assembly 1772 via a first inner or internal compression ring 1774. The bearing assembly comprises a plurality of bearings 1773. A stack or first gear 1776 is fixedly coupled to the first bearing 1774. When driven, the first gear 1776 rotates about longitudinal rotational axis 14a and in turn drives the first bearing assembly 1772, first inner compression ring 1774 and the first isolation booster 1770 into rotational movement about rotational axis 14a. The first isolation booster 1770 has a respective first longitudinal end 1770a and a second longitudinal end 1770b. The first isolation booster 1770 is coupled at first end 1770a to the ultrasonic transducer 1402 at a first anti-node AN1. According to some embodiments, the first isolation booster 1770 comprises vibration isolated mount flanges 1778 against which the first inner or internal compression ring 1774 and the gear 1776 abut.

While the use of vibration isolated boosters may not be new in applications subjected to axial loading conditions, according to some embodiments of the present disclosure, vibration isolated boosters described herein are subjected to transverse loading requiring substantially more rigidity to prevent deflection between the node and vibration isolated mount face.

According to some embodiments, the ultrasonic transmission line of welder 1400 utilizes a commercially available off-the-shelf (COTS) transducer 1402 such as a Dukane 5-kw, Branson 3.5-kw, Sonics 2.2 kw, or/or Telsonic 1.5 kw transducer to produce intense vibrations at a defined frequency.

According to some embodiments, and referring again to FIGS. 17A and 17B, a custom vibration isolating booster 1420 comprising a single half-wave vibration isolation booster 1770 is coupled to the end of the transducer 1402 at an anti-node (anti-node), e.g, first AN1 or second AN2 anit-node (position of maximum longitudinal displacement/amplitude). Anti-nodes are the points of maximum displacement longitudinally, and a node is a point having no displacement longitudinally, but radially. According to some embodiments, the purpose of the custom designed booster 1420 is twofold: (1) to provide an attachment surface that does not vibrate or have longitudinal or radial motion induced by the ultrasonic transducer 1402 and (2) to provide an attachment method facilitating continuous rotary motion. The vibration isolated booster 1420 is housed within one or more heavy-duty roller bearing assemblies 1772 for transferring weld force. The booster 1420 is affixed to the roller bearing assemblies 1772 with one or more internal compression rings 1774 that provides mounting provisions for gear 1776. The internal compression rings 1774, 1784 and gear 1776 apply compressive force against the vibration isolated booster mount face. It is this assembly that facilitates rotary motion using a motor such as motor 1404 for precise weld control. This is a novel design in that a rotary transmission line is supported within bearings being directly driven by a motor, whereby the ultrasonic vibrations, rotary motion, and/or weld force do not interact. The interaction is based on the applied static force, then going into resonance, which can thereby affect power draw. According to embodiments of the present disclosure, the design decouples the welding forces (dynamic) from the stack, thereby reducing required forces for welding the target materials.

The standard practice used in industry utilizes diaphragm springs or booster mount shells to mount the booster assembly. An elastomeric belt is then used to drive rotary motion. The belt drive arrangement is often suitable for light-duty applications. Here, the weld force, amplitude, and speeds are all substantial, requiring forces in excess of about 250-lbf, amplitudes over about 70 μm, and velocities in excess of about 15-IPM. Moreover, according to some embodiments, it may be critical to control the amount of ultrasonic energy for a given area, necessitating precise motion control. According to some embodiments, the geared interface between the stack and the motor 1404 provides such precise control between a portion of the welding tip 1432 of the sonotrode 1430 and a workpiece. According to some embodiments, the booster 1420 which is designed to accept a rotary drive mechanism enables the motor 1404 to apply torque to the transmission line or stack while the stack is in resonance. According to some embodiments, the booster 1420 which is designed to accept a rotary drive mechanism enables the motor 1404 to apply torque to the transmission line or stack while the stack is in resonance while substantial weld force is applied to the workpieces and the stack resonates with substantial amplitude and the stack is rotated at a substantial speed.

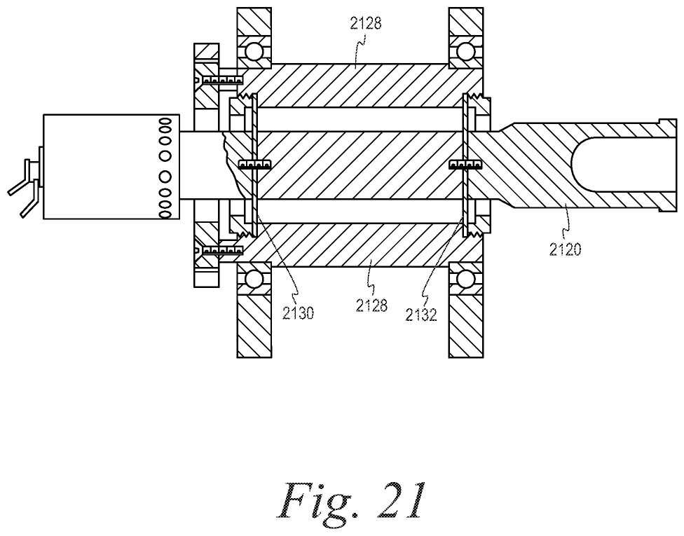

FIG. 21 is a reproduction of FIG. 2 of U.S. Pat. No. 3,955,740 to Shoh which is a partial section view of a seam welding apparatus. Shoh teaches a method of using tuned diaphragms 2130 and 2132 rigidly affixed to a cylindrical housing 2128. It is important to note that the diaphragms 2130 and 2132 must be tuned as they are intended to vibrate along with the tooling being attached at the anti-node. Being that the diaphragms 2130 and 2132 physically vibrate, energy is dissipated throughout the structure potentially leading to bearing skate, heat generation, and/or high-cycle fatigue failure. Proper tuning of the diaphragms 2130 and 2132 relies on the diaphragms 2130 and 2132 having a thin cross-sectional thickness. Therefore, it is impractical to be able to apply substantial loads to the welding face using the apparatus of Shoh without deflection of horn 2120. Those accustomed to using polar shell arrangements in practice can attest to challenges with delivering consistent ultrasonic energy, under substantial load conditions, while trying to maintain a constant rotational velocity and force. Conversely, according to some embodiments, the welder 1400 is able to deliver consistent ultrasonic energy to the workpieces, under substantial load conditions, while maintaining a constant rotational velocity and static/dynamic forces.

FIG. 17C is a perspective view and FIG. 17D is a longitudinal cross-section view of a booster 1420 comprising two half-wave vibration isolation boosters 1770, 1780 according to some embodiments of the present disclosure. According to some embodiments, booster 1420 comprises a first vibration isolation booster 1770 coupled to second vibration isolation booster 1780 wherein the first and second isolation boosters 1770, 1780 are positioned about a longitudinal rotational axis 14a. The first and second isolations boosters 1770, 1780 are mounted within respective first and second heavy-duty roller bearing assemblies 1772, 1782 via first and second inner compression rings 1774, 1784. The bearing assemblies 1772, 1782 each comprise a plurality of bearings 1773, 1783. A stack or first gear 1776 is fixedly coupled to the first bearing 1774. When driven, the first gear 1776 rotates about longitudinal rotational axis 14a and in turn drives the first and second bearing assemblies 1772, 1782, first and second inner or internal compression rings 1774, 1784, and first and second isolation boosters 1770, 1780 into rotational movement about rotational axis 14a. Each of the first and second isolation boosters 1770, 1780 have a respective first longitudinal end 1770a, 1780a and a second longitudinal end 1770b, 1780b. The first isolation booster 1770 is coupled at first end 1770a to the ultrasonic transducer 1402 at a first anti-node AN1. The second booster 1780 is coupled at second end 1780b to a sonotrode such as sonotrode 1430 at a fourth anti-node AN4.

Referring to FIGS. 17C and 17D, according to some embodiments, a second half-wave vibration isolation booster 1780 is joined to the second anti-node AN2 of a first booster 1770 producing a full wavelength booster assembly. According to some embodiments, joining the second vibration isolation booster 1780 to the first isolation booster 1770 is accomplished with a central setscrew 1786. The second booster 1780 is assembled in an opposing manner to the first booster 1770 to extend support features as far out as possible mitigating deflection issues. This is accomplished by integrating vibration isolation shells around the 1st and 4th nodal points which produces support at the extremes of the transmission line. According to some embodiments, the second longitudinal end or output end 1780b of the second vibration isolation booster 1780 has a smaller diameter than the first and/or second and third anti-node to produce an increase in physical displacement. The reduction in diameter at output end 1780b of second booster 1780 contributes to amplifying the resonance amplitude or gain in the welder 1400. Traditional designs employ traditional half-wave units not having an output end having a reduced diameter. While full wave units have been used in practical applications, these boosters have had the same diameter at the first AN1 and fourth AN4 anti-node. The vibration isolation boosters 1770 and 1780 can be assembled in numerous configurations to increase, decrease, or produce no change in amplitude. According to some embodiments, the booster 1420 employs opposing boosters 1770, 1780 that produce an increased gain as a full-wave transmission line using vibration isolation boosters 1770, 1780 in a rotary application capable of withstanding substantial torque and normal force without having adverse effects on frequency and power draw. According to some embodiments, by placing the attachment points at the nodal point, which is radial displacement, the transducer see less load or opposition to vibration. This in turn requires less power to keep in resonance.

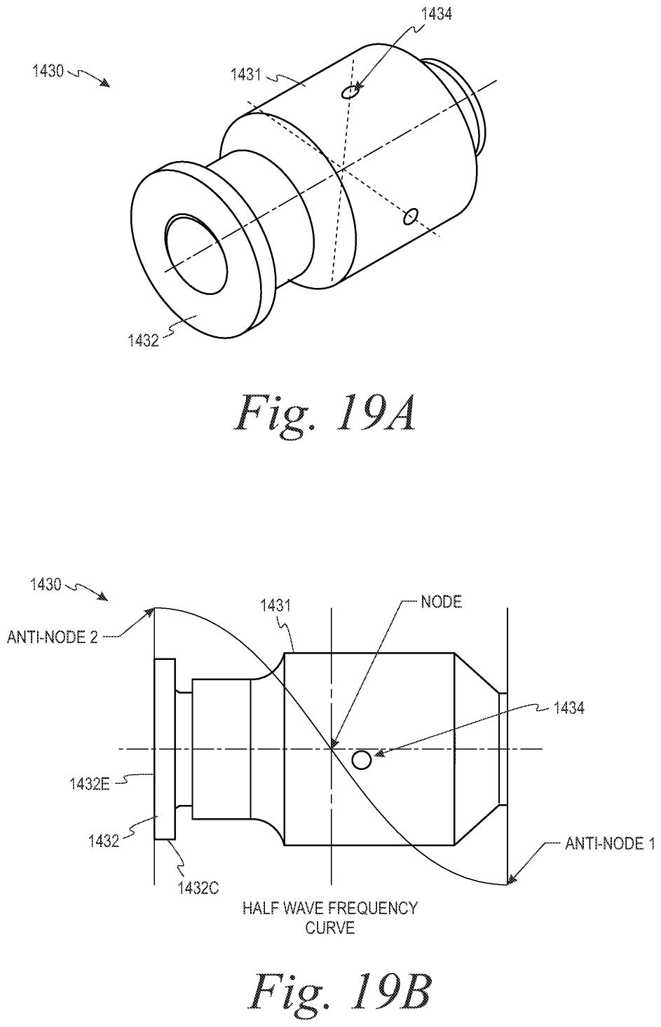

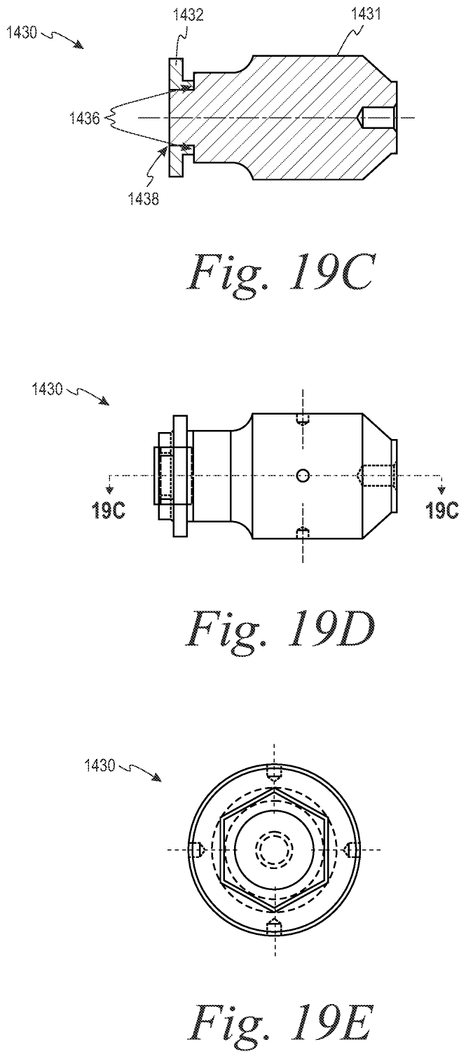

FIG. 19A is a perspective view, FIGS. 19B and 19D are side views, FIG. 19C is a side cross-sectional view taken along line 19C-19C in FIG. 19D, and FIG. 19E is an output or front end view of a sonotrode 1430 according to some embodiments of the present disclosure. The sonotrode 1430 comprises a primary sonotrode body 1431, a welding tip or replaceable seam welding tool 1432. Holes or apertures 1434 may be positioned within the sonotrode body 1431 to provide for means for attaching the sonotrode body 1431 to the booster 1420. According to some embodiments, the holes 1434 are spanner wrench holes for attaching the sonotrode body 1431 to the second vibration isolation booster 1780. According to some embodiments, the sonotrode body 1431 has a single coupling face 1436 against which the replaceable seam welding tool 1432 abuts when coupled to the sonotrode body 1431. According to some embodiments, the sonotrode body 1431 has threaded coupling end 1438 configured to permit replaceable seam welding tool 1432 having a threaded coupling aperture to be threadingly coupled to the sonotrode body 1431. According to some embodiments having a replaceable knurled face, the sonotrode 1430 has a male coupling aperture, whereas the knurled disk has a female thread for coupling to the tool. The current state of the art requires the use of a completely new tool. Conversely, according to some present embodiments, a new way of replacing the knurled tooling face when it is worn out is provided.

According to some embodiments, the ultrasonic sonotrode 1430 responsible for delivering intense vibrations to the materials being welded (workpieces) is coupled to the fourth anti-node AN4 of the second vibration isolation booster 1780 at the second end 1780b thereof. According to some embodiments, the sonotrode 1430 design is a common bell design. However, according to some embodiments, as explained above, the sonotrode 1430 has a replaceable seam welding tool 1432, unlike those used in common practice. According to some embodiments, the replaceable seam welding tool 1432 has a knurl face on an outer circumference 1432C of the welding tool 1432. The welding tool 1432 also has an end face or surface 1432E.

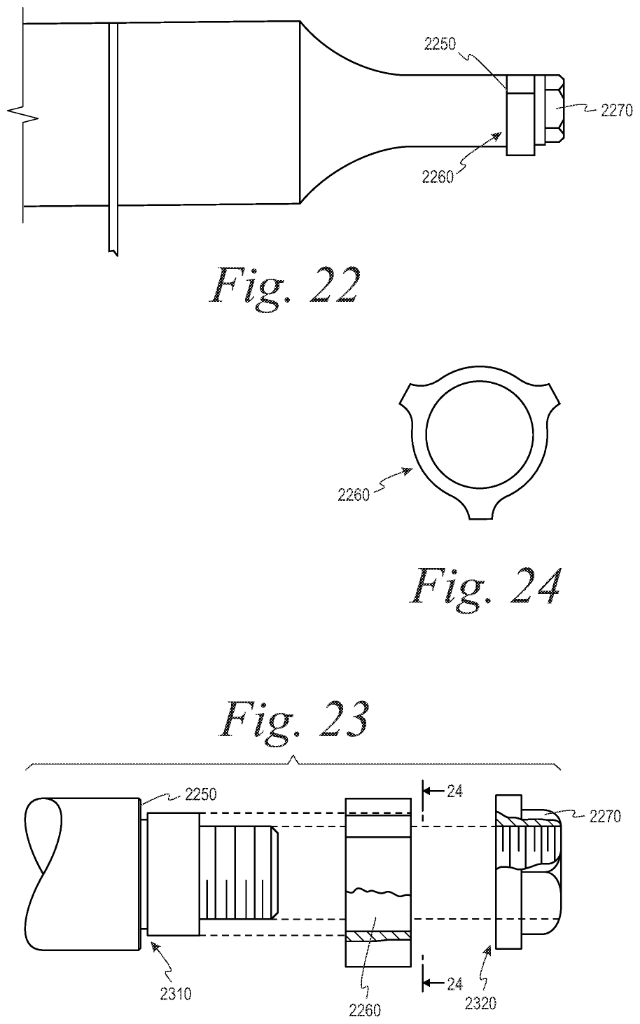

FIGS. 22-24 are reproductions of FIGS. 4-6 of U.S. Pat. No. 3,813,006 to Holze. More specifically FIG. 22 is a side view of a frontal portion of a resonator and welding tip 2260; FIG. 23 is an exploded view disclosing the welding tip 2260 and its attachment to the resonator; and FIG. 24 is a plan or end view of the welding tip 2260 along line 24-24 in FIG. 23. As illustrated in FIGS. 22-24, it is now an industry standard to have interchangeable spot-welding collars or tips 2260 that are retained by a nut 2270. There are several design issues with such prior replaceable tips 2260 that have been overcome according to some embodiments of the present disclosure. Firstly, prior replaceable tips were not actually located at the anti-node of the sonotrode. In prior welders, due to placement of a locating shaft on a primary body of a sonotrode, the threaded section, the welding surface is positioned further back from the anti-node. Therefore, maximum displacement of the tool occurs at the head of the nut 2270 as opposed to at the welding tip 2260. Secondly, additional interfaces are created with the introduction of a collar, with two mounting surfaces. One interface 2310 exists between the collar 2260 and a flat radially disposed annular surface 2250 of the primary sonotrode body, and a second interface 2320 exists between the collar 2260 with the opposing face of the collar 2260 being held under compression by the nut 2270. Lastly, additional interfaces exist between the threads in the connection of the nut 2270 to the sonotrode body. It is to be noted that in relatively small applications, such a design works well and is utilized throughout industry.

According to some embodiments, some or all of the aforementioned issues are overcome or mitigated by the use of an integral replaceable seam welding tool 1432. According to some embodiments, welding of materials or workpieces is performed using a knurl pattern machined onto the circumference of the replaceable tool 1432. According to some embodiments, the replaceable tool 1432 has a central aperture defined by an internal annular surface 1432a having a thread pattern thereon such as, for example, a female thread pattern. According to some embodiments, the sonotrode body 1431 has a complementary threaded end 1431a, such having male threads. The replaceable tool 1432 may be detachably coupled to the sonotrode body 1431 by screwing the tool 1432 directly onto the complementary threads of the sonotrode body 1431. Various geometry patterns can be added to assist with torqueing the replaceable tool 1432 to the sonotrode body 1431, such as spanner holes on the end face, flats, or hex patterns. According to some embodiments, the end face 1432E is positioned exactly at the second anti-node (as shown in FIG. 19B) so that so that reduced or minimal losses are obtained while delivering maximum amplitude in designed amplitude is encountered.

One of the significant factors that must be accounted for in ultrasonic seam welding is management of deflection that occurs across the weld face 1432C. According to some embodiments, substantial welding force, amplitude, and power are necessary to produce hermetic seals over a wide area. Deflection across the weld face 1432C results in more stress being generated at a point of contact of the stack closest to the next support region. If contact stress patterns do change, more energy per unit area results. Under such circumstances, an operator can observe over-welding, material transfer (tip-sticking), or shearing of the material (workpiece) along the weld seam.

According to some embodiments, a lateral support mechanism that is positioned between the node and anti-node is employed to mitigate or overcome these issues. FIG. 15A is a cross-sectional view and FIG. 15B is a first end view of a sonotrode area of the ultrasonic welder 1400 according to some embodiments. According to some embodiments, a lateral sonotrode support 1500 is coupled at a first end thereof 1500A to an output end 1421A of the transmission line housing 1421. The lateral sonotrode support 1500 extends longitudinally toward the output end of the stack. An output end 1500B of the sonotrode support 1500 is positioned adjacent the sonotrode body 1431. According to some embodiments, a low friction elastomeric pad 1510 is positioned between one or more inner surfaces of the output end 1500B of the sonotrode support 1500 and the sonotrode body 1431.

As illustrated in FIGS. 15A and 15B, not only does the lateral support 1500 reduce or eliminate deflection, it also houses the low friction elastomeric pad 1510. According to some embodiments, the elastomeric pad 1510 mitigates or prevents adverse effects to sonotrode resonance and/or rotation during welding. According to some embodiments, the elastomeric pad 1510 may be made of “Frelon”, PEEK, and/or PPS. According to some embodiments, the elastomeric pad 1510 is positioned between the node N and anti-node AN2 (see also FIG. 19B which illustrates the locations of the node and anti-nodes) of the sonotrode body 1431. The placement of the elastomeric pad 1510 between the node N and anti-node AN2 is contrary to that taught in U.S. Pat. No. 8,082,966 B2 to Short which teaches that the material needs to be positioned around the node. According to some embodiments, the placement of the elastomeric pad 1510 between the node N and anti-node AN2 achieves the desired result of mitigating or eliminating deflection and improves wear life of a bearing pad. According to some embodiments, the placement of the elastomeric pad 1510 between the node N and anti-node AN2 decreases loading on the sonotrodes nodal point, thereby decreasing total system power during welding by not restricting radial motion produced by Poisson effect.

FIG. 16 is a reproduction of FIG. 3 of U.S. Pat. No. 8,082,966 B2 to Short and is a cross-sectional side view of an exemplary embodiment of an ultrasonic welding assembly. If a bearing pad 1672, 1676 is located at the node, such as in FIG. 16, more power is needed because motion is restricted by load.

Some or all of the previously described features may be employed with a welder 1400 having a program-controlled motor 1404 which rotationally drives the stack. According to some embodiments, it is important that added or included supports not impede the operation and/or function of each other (e.g., by placing the supports at nodes).

According to some embodiments, producing hermetically sealed joints having sufficient strength to withstand vast thermal environments (such as seals 110 in PCM storage units, plates, or panels 100, 1100) requires welding operations that are consistent along the length of travel. It is for this reason that a program-controlled motor 1404 is used having the ability to adjust velocity based on real-time sensor feedback from the weld process according to some embodiments. According to some embodiments, the controller monitors heat generation and weld depth, or collapse distance. As described above, FIG. 18 is a schematic drawing illustrating the welder 1400 communicatively coupled to a controller 1800 and electrically coupled to an electronic ultrasonic generator or power supply 1820 according to some embodiments of the present disclosure. The controller 1800 controls the speed of the motor 1404 of the welder 1400.

Referring to FIG. 14D, according to some embodiments, the anvil 1440 is coupled to or is formed as an integral part of an anvil shaft 1440SH. According to some embodiments, both the anvil 1440 and the anvil shaft 1440SH are free-wheeling and are rotatably mounted within the welder housing or enclosure case 1401 so as to be able to rotate about the anvil rotational axis 1440a.

### Anvil Load Cell

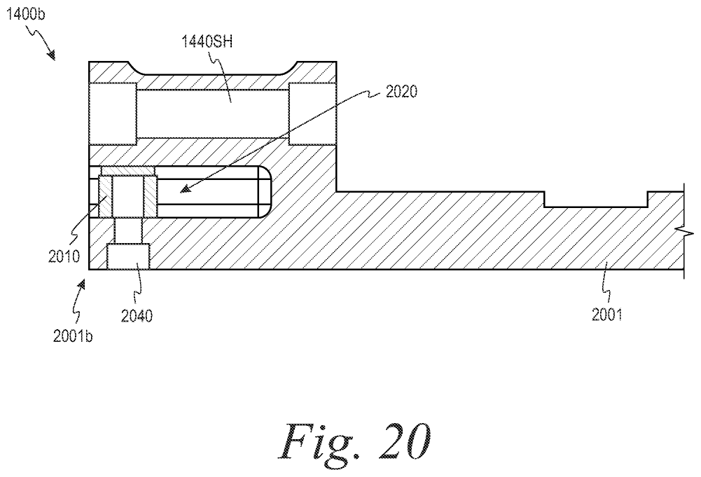

FIG. 20 is an enlarged view of lower, output end 1400b of a welder 1400 according to some embodiments of the present disclosure. According to some embodiments, monitoring weld force is accomplished with an anvil load cell 2010 placed directly underneath the free-spinning anvil shaft 1440SH adjacent the output end 1400b of the welder 1400. According to some embodiments, weld force is a critical component to producing consistent and repeatable welds. The load cell 2010 is sandwiched (or compressed between the anvil base) in a main anvil bearing mount structure 2001 thereby enabling the load cell 2010 to obtain anvil load readings as close to the welding location as physically possible such as directly underneath the weld location. The main anvil bearing mount structure 2001 has an output end 2001b. While the introduction of load cells within ultrasonic welding systems is not new, this is the first system to use a load cell within proximity to the weld such as directly underneath the weld location. For example, according to some embodiments, the load cell 1440 is positioned within a distance of about 2 inches (5 cm) or less from the center of the output end of the anvil 1440. Conventional systems employ the use of load cells several steps removed. In most cases, the anvil load is read at the connection between the end of a cylinder or calculation of amperage on a motor. According to the embodiment, illustrated in FIG. 20, the load cell 2010 is measuring applied force to the anvil housing 2001. As shown in FIG. 20, according to some embodiments, a large, relieved pocket 2020 is machined into the anvil housing 2001 thereby reducing the structural stiffness of the anvil housing 2001. Within this pocket 2020, the load cell 2010 resides directly under the free-spinning needle bearing 2030 that supports the anvil shaft 1440SH. According to some embodiments, a pre-load compression bolt 2040 retains and applies pre-load to the load cell 2010 when in place. This in turn supports the welding process but also provides closed loop feedback on the applied force from the weld head. The output of the load cell 2010 is communicatively coupled to the controller 1800. It is noted that the pocket 2020 illustrated in FIG. 20 is not present in the embodiment of welder 1400 shown in FIG. 14D.

### Material Presence Sensor

Referring again to FIG. 14A, according to some embodiments, a sensor such as a photo-optic material presence sensor 1450 may be incorporated into the primary anvil base 2001 to detect the end of a material or workpiece being run through the welder. The photo-optic material presence sensor 1450 generates a signal which is communicatively coupled to the controller 1800. To create a weld, the operator inserts the materials or workpieces to be welded between the anvil 1440 and the welding tip 1432 of the sonotrode 1430. Upon depressing a start button, the weld head closes. For example, the head closes by a pneumatic, hydraulic, or electro-mechanical actuator until a preset force is met. The controller 1800 receives one or more readings from the anvil load cell 2010. A pressure regulator associated with, for example, a pneumatic cylinder is then adjusted to a desired weld force. Once the desired weld force has been applied to the workpieces as determined by the readings from the anvil load cell 2010, the controller 1800 starts the motor 1404 which in turn starts the rotating of the stack including the rotation of the sonotrode 1430 and the welding tip 1432. The controller 1800 also starts the ultrasonic transducer 1402 and the welding tip 1432 begins traversing the materials to be welded while ultrasonic vibrations are applied to the stack thereby initiating the welding of the materials while the materials are advanced by the rotation of the knurl face of the welding tip 1432. The welding continues if the material presence sensor 1450 (such as a photo-optic sensor) detects that material is present. When the signal generated by the material presence sensor 1450 indicates that material to be welded is no longer present, the controller 1800 instructs transducer 1402 and motor 1404 to turn off at the appropriate time or times. A run-off time may be determined based on the distance the end of material to be welded needs to travel to reach the welding tip 1432, the diameter of the welding tool 1432, and/or the rotational speed of the stack. The use of the material presence sensor 1450 and automatic shutdown of the motor 1404 and transducer 1402 can assist in mitigating or eliminating operator mistakes that can lead to tool 1432 damage and/or or the presence of unwelded sections of the materials to be welded such as unwelded sections of seam 110 in PCM plates 100, 1100.

According to some embodiments, all these features are combined to create a robust, repeatable seam welding process producing hermetic seals such as hermetic seals of seams 110 in the PCM plates 100, 1100 described above. The field of ultrasonic metal welding is well established for joining a cadre of metal alloys being relatively thin, typically ranging in thickness between 0.001 inch to 0.015 inch. The welder 1400 and welding system 1802 detailed here within has demonstrated its ability to produce welds in aluminum alloys of 0.04 inch having a combined seam thickness of about 0.08 inches without reaching maximum capacity. According to some embodiments, other materials such as other metals or metal alloys comprising stainless steel, copper, palladium, titanium, molybdenum, gold, tantalum, and so on may be welded using the welder 1400 and system 1802. According to some embodiments, it is believed that the thickness range can now be placed with confidence at about 0.065 inch (1.6 mm) and under to produce cross-sectional thicknesses of about 0.13 inch (3.3 mm). According to some embodiments, the thickness range is about 0.010 inch (0.25 mm) and under to produce cross-sectional thicknesses of about 0.20 inch (0.51 mm).

According to some embodiments, the welder 1400 comprises an ultrasonic stack or transmission line, a high-power ultrasonic transducer 1402 capable of operating between 100 and 6,000 Watts at frequencies between 10 and 60 kHz, a series of ultrasonic boosters 1770, 1780, and a sonotrode 1430.

According to some embodiments, a series of acoustically isolated boosters 1770, 1780 are specifically tuned to the resonant frequency of a transducer 1402 as a full wavelength system and are capable of being subjected to substantial reactionary forces without deflection (up to about 1,000-lbf).

According to some embodiments, acoustically isolated full wavelength boosters 1770, 1780 facilitate a means for gain adjustments within the first quarter and fourth quarter wavelength of the resonant frequency of a transducer 1402.

According to some embodiments, an acoustically isolated full wavelength booster 1770, 1780 provides mounting surfaces adaptable to high load carrying roller bearing assemblies 1772, 1782.

According to some embodiments, an acoustically isolated full wavelength booster 1770, 1780 has a gear 1776 coupled thereto at the end of a first quarter wavelength of a resonant frequency.

According to some embodiments, a servo motor 1404 and/or electric, pneumatic, or hydraulic actuator engages a gear 1776 positioned at a first quarter wavelength of a resonant frequency for generating rotational motion of a stack comprising a transducer 1402, a booster 1420, and a sonotrode 1430.

According to some embodiments, an ultrasonic welding sonotrode 1430 is coupled to a fourth anti-node position of an acoustically isolated booster 1420, wherein the sonotrode 1430 is positioned to introduce ultrasonic energy into target materials to be welded.

According to some embodiments, a sonotrode 1430 comprises a detachable sonotrode face 1432C having a knurl geometry for driving vibrations into target materials to be welded when the face 1432C is biased under load against a surface of one of the target materials.

According to some embodiments, a sonotrode face 1432C for ultrasonic welding is detachably coupled to a sonotrode body 1431 using threaded fasteners, inherent thread mechanisms, and/or shrink-fit methods.

According to some embodiments, an ultrasonic sonotrode 1430 is designed to be capable of producing between 5 and 150 μm of Peak-to-Peak motion, when coupled with a varying gain acoustically isolated full wavelength booster 1420.

According to some embodiments, an ultrasonic sonotrode support 1500 utilizing low friction bearing material such as a low friction elastomeric pad 1510 positioned between a node and a second anti-node of a resonant frequency is employed in welder 1400.

According to some embodiments, a cylindrical, rotating anvil 1440 provides a reactionary force to an ultrasonic stack applied force.

According to some embodiments, a rotating anvil is rotationally mounted to an anvil bearing mount structure 2001 and a normal force load cell or cells 2010 is located within the anvil bearing mount structure 2001, wherein the load cell or cells 2010 are positioned to monitor force generation during welding in real-time.

According to some embodiments, a pneumatic, hydraulic, or servo drive actuation system capable of generating up to about 750 pound-force between a sonotrode detachable weld face 1432C and a rotatable anvil 1440 is provided.

According to some embodiments, an integrated displacement sensor measures weld head collapse distance and real-time changes in weld collapse depth during welding. For example, the integrated displacement sensor may be a photo-optic sensor that measures the difference between the static compression force and dynamic vertical movement during the welding process.

According to some embodiments, an integrated “end-of-travel” photo-optic sensor 1450 detects an aft edge of material to be welded and the output of the sensor 1450 is employed to automatically terminate a welding sequence to mitigate or prevent metal-to-metal knurl surface damage within a detachable sonotrode weld face 1432C or a rotating anvil 1440.

According to some embodiments, a welder comprising an ultrasonic stack, or transmission line, is comprised of a high-power ultrasonic transducer capable of operating between 100 and 6,000 Watts at frequencies between 10 and 60 kHz, a series of ultrasonic boosters, and a sonotrode.

According to some embodiments, a welder comprises a transducer and a series of acoustically isolated boosters specifically tuned to the resonant frequency of the transducer as a full wavelength system.

According to some embodiments, a welder comprises acoustically isolated full wavelength boosters which facilitate a means for gain adjustments within the first quarter and fourth quarter wavelength.

According to some embodiments, a welder comprises acoustically isolated full wavelength booster providing mounting surfaces adaptable to high load carrying roller bearings.

According to some embodiments, a welder comprises acoustically isolated full wavelength booster having gear drive geometry positioned at the end of first quarter wavelength.

According to some embodiments, a welder comprises a servo motor and/or electric, pneumatic, or hydraulic actuator capable of engaging gear drive geometry positioned at first quarter wavelength for generating rotational motion.

According to some embodiments, a welder comprises an ultrasonic welding sonotrode coupled to fourth anti-node position of acoustically isolated booster for introducing ultrasonic energy into target materials.

According to some embodiments, a welder comprises a detachable sonotrode face having appropriate knurl geometry for driving vibrations into target materials when under load.

According to some embodiments, a welder comprises an ultrasonic sonotrode design capable of producing between 5 and 150 μm of Peak-to-Peak motion, when coupled with varying gain acoustically isolated full wavelength booster.

According to some embodiments, a welder comprises detachable sonotrode face for ultrasonic welding designed to couple to the sonotrode body using threaded fasteners, inherent thread mechanisms, and/or shrink-fit methods.

According to some embodiments, a welder comprises an ultrasonic sonotrode support mechanism utilizing low friction bearing material positioned between the node and second anti-node, contrary to prior art of positioning support structures at the system's nodes.

According to some embodiments, a welder comprises a cylindrical, rotating anvil providing reactionary force to the ultrasonic stack applied force.

According to some embodiments, a welder comprises an integrated normal force load cell(s) within said rotating anvil support structure for monitoring real-time force generation during welding.

According to some embodiments, a welder comprises pneumatic, hydraulic, or servo drive actuation system capable of generating up to 750 pound-force between a sonotrode detachable weld face and a rotational anvil.

According to some embodiments, a welder comprises an integrated displacement sensor measuring weld head collapse distance and real-time changes in weld collapse depth during welding.

According to some embodiments, a welder comprises an integrated “end-of-travel” photo-optic sensor detecting aft edge of material automatically terminating welding sequence preventing metal-to-metal knurl surface damage withing the detachable sonotrode weld face or rotating anvil.

While the concepts disclosed herein are susceptible to various modifications and alternative forms, specific embodiments thereof have been shown by way of example in the drawings and herein described in detail. It should be understood, however, that it is not intended to limit the inventions to the particular forms disclosed, but on the contrary, the intention is to cover all modifications, equivalents, and alternatives falling within the spirit and scope of the inventions as defined by the appended claims.

1: A phase change material (PCM) storage unit comprising:
a first side and a second side, each side having a perimeter;
a perimeter seal joining the first and second sides together at the perimeters of the first and second side, whereby the first and second sides are at least partly spaced apart from each other to define at least one PCM storage area between the first and second sides; and
PCM contained in the least one PCM storage area;
wherein the first and second sides are made of a material comprising a metal or a metal alloy.

2: The PCM storage unit of claim 1, wherein the first and second sides are hermetically sealed by the perimeter seal.

3: The PCM storage unit of claim 1, wherein the PCM storage unit comprises a flammable PCM,
and optionally the flammable PCM when burned has a Smoke Developed Index great than about 50,
and optionally the flammable PCM when burned has a Smoke Developed Index great than about 450,
and optionally the flammable PCM when burned has a Flame Spread Index of great than about 10 or 25,
and optionally the PCM storage unit when burned has a Flame Spread Index of less than about 25 when subjected to an ASTM E 84 fire test,
and optionally the PCM storage unit when burned has a Smoke Developed Index less than about 450 when subjected to an ASTM E 84 fire test;
and optionally the PCM storage unit when burned has a Smoke Developed Index less than about 50 when subjected to an ASTM E 84 fire test.

4-6: (canceled)

8: The PCM storage unit of claim 1, wherein the first side and the second side are made of a material comprising aluminum or an aluminum alloy.

9-15: (canceled)

16: The PCM storage unit of claim 1, wherein the perimeter seal is sealed, and the first plate and the second plate are joined, using ultrasonic welding by use of an ultrasonic welder manufactured to comprise:
an ultrasonic stack or transmission line;
a high-power ultrasonic transducer capable of operating between 100 and 6,000 Watts at frequencies between 10 and 60 kHz;
a series of ultrasonic boosters; and
a sonotrode.

17: An ultrasonic welder comprising:
an ultrasonic stack or transmission line;
a high-power ultrasonic transducer capable of operating between 100 and 6,000 Watts at frequencies between 10 and 60 kHz;
a series of ultrasonic boosters; and
a sonotrode.

18: The ultrasonic welder of claim 17, further comprising a series of acoustically isolated boosters coupled to a transducer, wherein the boosters are tuned to the resonant frequency of the transducer as a full wavelength system.

19: The ultrasonic welder of claim 17, further comprising
a transducer generating vibrations at a resonant frequency;
an acoustically isolated full wavelength booster coupled to the transducer; and
a gear coupled to the booster at an end of a first quarter wavelength of the resonant frequency.

20: The ultrasonic welder of claim 17, further comprising
a transducer generating vibrations at a resonant frequency;
an acoustically isolated full wavelength booster coupled to the transducer; and
an ultrasonic welding sonotrode positioned to introduce ultrasonic energy into target materials to be welded, wherein the sonotrode is coupled to a fourth anti-node position of the booster.

21: A sonotrode for use in an ultrasonic welder, the sonotrode comprising:
a sonotrode body; and
a welding tool having a sonotrode face having a knurl geometry, wherein the welding tool is detachably coupled to the sonotrode body,
wherein the sonotrode face is operatively connected to the ultrasonic welder and is configured to drive vibrations into a plurality of target materials to be welded together when the face is biased under load against a surface of one of the plurality of target materials.

22: The sonotrode of claim 21, wherein the sonotrode body comprises a sonotrode output end having sonotrode threads thereon;
wherein the welding tool has an inner annular surface defining an aperture in the welding tool, wherein the inner annular surface has tool threads thereon that are complementary to the sonotrode threads;
wherein the welding tool and the sonotrode output end are sized to permit the welding tool to be detachably coupled the sonotrode by screwing the welding tool onto the sonotrode output end via the sonotrode threads and the tool threads.

23: An ultrasonic welder comprising the sonotrode of claim 21.

24: An ultrasonic welder comprising:
(a) a transducer capable of generating vibration at a resonant frequency;
a sonotrode operatively coupled to the transducer;
an ultrasonic sonotrode support positioned adjacent the sonotrode; and
a low friction bearing material positioned between the sonotrode and the sonotrode, wherein the low friction bearing material is positioned between a node and a second anti-node of the resonant frequency introduced in the sonotrode;
(b) the ultrasonic welder of (a), wherein the low friction bearing material comprises a low friction elastomeric pad;
(c) a transducer capable of generating vibration at a resonant frequency;
a sonotrode operatively coupled to the transducer; and
an anvil positioned adjacent to an output end of the sonotrode, wherein the anvil has a cylindrical shaped and is rotationally mounted within an anvil bearing mount structure;
(d) the ultrasonic welder of (c), wherein the rotationally mounted anvil is positioned to provide a reactionary force to a force generated when the sonotrode biases material to be welded positioned between the sonotrode and the anvil against the anvil;
(e) a transducer generating vibration at a resonant frequency;
a sonotrode operatively coupled to the transducer;
an anvil positioned adjacent to an output end of the sonotrode, wherein the anvil is coupled to an output end of an anvil bearing mount structure; and
a load cell positioned within the anvil bearing mount structure, wherein the load cell is positioned adjacent the output end of the anvil bearing mount structure;
(f) the ultrasonic welder of (e), wherein the load cell generates a signal used to monitor force generation during welding in real-time;
(q) a transducer generating vibration at a resonant frequency;
a controller communicatively coupled the transducer;
a sonotrode operatively coupled to the transducer;
an anvil positioned adjacent to an output end of the sonotrode, wherein the anvil is coupled to an output end of an anvil bearing mount structure; and
an end-of-material photo-optic sensor positioned adjacent to the anvil, wherein the sensor generates an output signal that varies depending on whether material to be welded being fed between the sonotrode and the anvil is detected by the sensor or is not detected by the sensor, wherein output signal is communicatively coupled to the controller;
wherein the controller automatically generates a signal instructing the transducer to stop operating in response to the output signal indicating that material to be welded is not detected by the end-of-material sensor; and
(h) the ultrasonic welder of any of (a) to (q), further comprising a load cell positioned within the anvil bearing mount structure, wherein the load cell is positioned adjacent the output end of the anvil bearing mount structure.

25-31: (canceled)
